(19) United States
(12) Patent Application Publication
(10) Pub. No.: US 2002/0082811 A1
(43) Pub. Date: Jun. 27, 2002

(54) Optimization apparatus, system, and method of use and doing business

(76) Inventors: William A. Honjas, Reno, NV (US); Satish K. Pullammanappallil, Reno, NV (US); Sushil J. Louis, Reno, NV (US)

Correspondence Address: Robert C. Ryan, P.O. Box 20038, Reno, NV, 89515-0038, US

(21) Appl. No.: 09/811,071

(22) Filed: Mar. 16, 2001

Related U.S. Application Data
(60) Provisional application No. 60/190,316, filed on Mar. 17, 2000.

(51) Int. Cl. G06F 17/10

(52) U.S. Cl. 703/2

(57) ABSTRACT

This specification discloses an optimization system that uses a plug-in optimizer, such as a Genetic Algorithm and Simulated Annealing optimization algorithm. The optimization system may be run from a GUI, including remotely from a centralized computing cluster or other server. The optimization can be Internet-based, and may include O-cubed processing and multiple model averaging, providing enhanced robustness. The optimization GUI also provides multiple views of data output files, such as Pickfiles, Hitfiles, and velocity model files in seismic applications. The optimization system also provides the ability to analyze and constrain particular areas of the optimization model as well as alter the location of date recording devices to analyze the impact of such alteration on date procurement or the optimization model. A fee-for-service-based optimization business model and others can be provided with the disclosed systems and methods.

### BACKGROUND OF THE INVENTION

Optimization systems have long been in use to varying degrees in certain industries such as is manufacturing, scheduling, and routing. They have also long been the subject of academic study and limited commercialization in the field of seismic modeling. The purpose of these optimization systems are to generate models of underground geographical or seismic characteristics based on measurements or data accumulated in the field. They have also been commercialized to a limited degree recently by the applicants for use in the geographical exploration for, oil, minerals and geothermal resource exploration and for geotechnical studies.

One common use of seismic optimization systems involves deploying a large number of vibration signal sources, such as geophones, and a set of mating receivers within a geographic area of interest. These signal sources and mating receivers are referred to as the seismic “array.” The array may be placed on the surface of the earth (or on any planet in the case of extraterrestrial studies), in the subsurface, or below liquid media, or in any combination of these locations.

The vibration signal sources are then activated, typically a number of times among varying subsets of the signal sources, to generate seismic waves, which then travel into the geographic area of interest, striking subsurface boundaries and objects, generating reflected seismic signals, and traveling through differing subsurface materials at differing velocities depending on the nature of the materials involved. The receivers record the arrival times of the seismic waves, including both the reflected and direct waves. If a seismic wave travels through a specific point or region within the media being sampled in the subsurface, that point will have been “sampled” and the sample is called a “hit.” The more waves that travel through a specific point in the subsurface, the more the point has been sampled, the greater the hit count, and therefore the more reliable the data for that point. This process therefore commonly involves collection of a very large amount of data (i.e., a large number of travel times based upon seismic wave generation times at a large number of seismic wave sources and the corresponding seismic wave arrival times at a large number of receivers); and the travel time data is then input into a computer, which in turns processes the data according to an optimization algorithm to generate a model of seismic characteristics, such as the velocity structure, of the subsurface of the geographic area of interest. The optimized model is then used to determine subsurface characteristics of interest, such as the location of minerals, hydrocarbons, water, rock structure, etc. Most commonly, the optimization algorithms used in seismic applications seeks a globally optimized result. This involves finding the best set of parameters that optimize (i.e., minimize or maximize) an objective function not just in particular sections of the subject matter of interest, but globally across the entire subject matter (e.g., seismic area) of interest.

Consequently, global optimization problems, particularly seismic problems, involve processing of very large amount of data, are computationally intense, and are quite difficult to solve exactly. Generally speaking, these optimization problems have the form:

Minimize F(x)

Subject to gᵢ(x)=0 for i=1, . . . , m1 where m1≧0 hⱼ(x)≧0 for j=m1+1, . . . , m wherein m≧0

where F is a function of a vector of reals x that is subject to equality and inequality constraints.

Some of the predominant classes of global optimization problems are differential convex optimization, complementary problems, minimax problems, bilinear and biconvex programming, continuous global optimization and quadratic programming. These types of optimization problems typically require use of one or more computers to solve them, and even then, the processing power and time required to complete an optimization model or series of models may be quite substantial.

Examples of relatively recent seismic optimization techniques include: U.S. Pat. No. 5,570,321, issued to Nikolaos on Oct. 29, 1996, entitled “Seismic Velocity Model Optimization Method Using Simulated Annealing to Determine PreStack Travel Times”; U.S. Pat. No. 5,991,695, issued to Wang et al. on Nov. 23, 1999, entitled “Method for Determining Seismic Data On A Massively Parallel Computer”; and Pullammanappallil (one of the present inventors) and Louie, A Generalized Simulated-Annealing Optimization for Inversion of First Arrival Times, Vol. 84, No. 5, pp. 1997-1409, Bulletin of the Seismological Society of America (October 1994).

Although these and other optimization techniques have been effective at generating optimized models provided the user has suitable computational power and resources, they have often required the user to have substantial a priori knowledge of subsurface characteristics of interest and to provide this a priori knowledge as input to the optimization algorithm. Examples of this type of prior art include the Nikolaos and Wang et al. patents cited above. This need for a priori input can present a significant and costly problem when, as is commonly the case, little is known about the needed subsurface characteristics prior to undertaking the seismic study of the geographic area of interest.

Although the 1994 Pullammannappallil and Louie reference discloses an optimization technique that requires little if any a priori data, the system disclosed in that reference was relatively cumbersome in that it utilized only a Simulated-Annealing algorithm and was not adapted to run on more than a single central processing unit. As a result, the 1994 Pullammanappallil and Louie technique required a relatively large amount of time to provide a real-world optimization model based on real-world data. In this regard, this prior art technique would commonly take many hours or even days to provide a real-world seismic optimization model utilizing a personal computer running a Pentium™ II 266 through Pentium™ III 800 MHz or an AMD™ 500 MHz processor. This long turn-around time, which has long been common in the seismic optimization prior art, obviously imposes significant delays and costs on the seismic survey process by, for example, limiting the ability of the seismic surveyor to quickly determine the sufficiency of the seismic survey and the adequacy of the array to determine the characteristics in the geographical area of interest or to return a reliable model in a reasonable and economical amount of time.

Although there are prior art optimization techniques that have utilized algorithms that reduce processing times by allowing parallel processing on multiple central processing units at the same time, these techniques typically have been inflexible and have required direct and localized access to an expensive array of computers interconnected on a local area network. This has long imposed a significant cost and delay on the optimization process, requiring the user to make a heavy and burdensome investment in powerful computing equipment to run the optimization, as well as making it impractical to use such software in the field—far from the location of the computing system required to run the actual optimization.

The prior art techniques also typically have been adapted to use only one particular type of optimization algorithm to optimize data sets input into algorithm. This has the limited ability to use differing optimization algorithms, with the same basic user interface and data-manipulation feature set, but in differing conditions and on differing types of computing systems, such as single processor and multiple processor systems. The costs imposed by this lack of flexibility in the prior art systems are substantial, since, in the case of parallel processor optimization system for example, users of such systems often do not have cost-efficient and easy access to powerful multiple processor systems often required to run a parallel optimizer. Conversely, in the case of single processor optimization systems, the user may require faster processing turn-around than can be provided by the single processor optimization algorithm. In either case, the prior art systems would require the user to learn multiple optimization system interfaces if the user sought to have the flexibility of using differing optimization algorithms for differing optimization tasks.

The prior art optimization systems have also typically been designed to run on particularized computers and related computing operating systems, such as DOS, Unix, etc. This has limited the ability of the users of such systems to run a given prior optimization system on a wide variety of computing systems and move the optimization systems from computing system to computing system as the user changes or upgrades its system over time. In addition, since prior art optimization computing systems are typically designed to run on the less prevalent but more powerful computers and their associated operating systems, the prior techniques have limited the ability to gather, input data into the optimization system, and manipulate, or display output from, the optimization system with the much more prevalent but less powerful personal computers such as laptops, desktops, PDAs, etc.

Thus, even the applicants' own prior art optimization system, Optim™ 1.0, was adapted to run only a single processor algorithm called a Simulated Annealing or SA algorithm. The applicant's prior art system was also DOS based; and like other prior systems, it was not adapted to allow a user to input data into the optimization system from a remote location or computer, much less manipulate the optimization system or view output from the optimization system remotely (such as out in the field) except in relatively small scale applications like small scale seismic surveys. As a result, prior art seismic optimization systems in particular (including the applicants' Optim 1.0 system) have often required that the user must not only have its own expensive, powerful computing system or direct access to such a system in order to conduct relatively larger scale optimizations in particular, but also be able to run such optimizations and work with the output of such optimizations locally at the site of the computing system.

Like the applicants'prior art Optim 1.0 system, prior art systems also have long provided little ability for the user to work with the data being input into the optimization system or relatively easily obtain iterative responses from the optimization system based on changes to the input the data. For example, prior art systems often (unlike the applicants' Optim 1.0 system) did not include the ability for the user to observe an optimization model in the field based on data input into the system, determine the adequacy of the model for the area or subject matter under investigation, and then alter input data (such as the location of the testing array in a seismic optimization) to determine if such an alteration is likely to adequately assess the area or subject matter under investigation. As another example, prior art systems typically have not allowed the user to easily input and constrain certain values of the optimization model, to conform for example to pre-known values, and then run or re-run the optimization subject to such constraints.

The user thus might often discover that a given subsurface region of interest was inadequately sampled only after having collected an initial set of data in the field, torn down the seismic array, and then later run an optimization on a sufficiently powerful computing system far from the field. In such an event, the user would often be forced to incur the substantial expense of going back into the field with the data collection team to re-deploy an entire seismic array and again gather the data believed to be necessary to acquire an adequate optimization of all the regions of interest. Even then, the user might find that the resulting re-deployment, array tear down, and re-optimization at a remote location still provides inadequate optimization results, requiring the user to repeat this expensive and time consuming process yet again.

In short, prior art optimization systems, and seismic optimization systems in particular, have long provided relatively cumbersome and inflexible interfaces and required localized access to expensive computing systems in order to run them and work with their optimization model output. They also have typically required a priori assumptions that are often difficult to make and can too often lead to unreliable results. In addition, they have provided the user with relatively little ability to readily work with the input or output of the system, much less the ability to do so quickly, economically, and remotely if desired. This has been so notwithstanding the widespread presence of (i) computer networking (LAN and WAN) techniques for decades, as well as (ii) the Internet computing network and many wireless communications systems for many years now.

Prior art optimization systems have long suffered from numerous other problems and deficiencies, ranging from limited feature sets (including cumbersome data output and file maintenance tools), to lack of robustness, to lack of any automated and readily accessible pre-optimization estimation of optimization running time for a given data set. The result has been correspondingly limited business models for use of such systems and correspondingly limited access to such systems. The applicants' present solutions for these types of problems and deficiencies as well as others, including the applicant's improvements to certain optimization algorithms themselves and the business models for accessing and providing optimization systems, services, and results, will become apparent to those skilled in the art as this patent specification proceeds.

### BRIEF SUMMARY OF THE INVENTION

The applicants' have invented an optimization system, method of use, and method of doing business. The system includes a data transfer interface or main interface system for automatic data transfer and optionally and/or alternatively data manipulation or viewing of optimized model output, and a separate optimizing system or subsytem for optimization and generation of optimized model output. The data transfer system may run on one computing system and the optimizing system may run on the same computing system or a separate and optionally remote computing system.

Preferably, the optimizing system may utilize any of a wide variety of differing optimization algorithms. In the preferred embodiment, the optimization system is therefore adapted to run at least either a GA or SA optimization algorithm plug-in.

Most preferably, the optimizing system may operate in a single or multiple processor environment. Thus, the optimizing subsystem may run on a LAN having a number of powerful workstations, most preferably a “cluster,” that process the optimization algorithm in parallel while the data transfer module may run on a remote computer, most preferably a laptop or smaller computing device, out in the field distant from but in communication with the optimizing subsystem. The communication link with between the data transfer system and optimization system may be a direct wired or wireless connection, or it may utilize a wired or wireless telephonic link or connection through the Internet.

Preferably, the optimizing system requires no a priori estimate or information about the outcome of the optimization. Most preferably, however, the optimization system includes a vehicle for, if desired by the user, constraining, and preferably interactively tune, aspects of the optimization model output in order to, for example, generate faster system run times or conform the model output to known or desired features of the subject matter being modeled by the optimization system.

The optimization system also preferably is uniquely robust, including; (i) convergence criterion such as that disclosed herein to provide more accurate modeling output, (ii) the ability to generate of multiple model outcomes and averaging the outcomes, most preferably according to an empirical number of outcomes determined by the number of iterations involved in generating the outcomes; (iii) the option to generate multiple model outcomes and, preferably automatically, choosing the best of them according to criteria, such as the outcome providing the most globally optimized result; and (iv) the ability to optimize data in sections or with to run the optimization algorithm a number of times but with different parameters in each run. In the preferred seismic application, the optimization system also provides faster and more accurate ray tracing.

Most preferably, the optimization system's data transfer module also provides graphical and windowing user interface, with convenient pull down menus providing a wide range of user features and options, such as: (i) a data output file generation and organization system; (ii) output model constraining or tuning features; (iii) a convenient data inputting or importing feature and a data input viewing screen (to, in the preferred seismic application for example, view the seismic array geometry or picks provided by that array); (iv) a screen for adjusting settings (such as the number of optimization iterations or other optimization options such as those described above) or optimization algorithm parameters to be passed to and utilized by the optimization subsystem; (v) optimization run time estimation and progress reporting; and (vi) multiple graphical views of optimization model output (such as, in the preferred seismic application disclosed herein, a model tuning view, an array design view, and an optimized model view).

The present invention also preferably includes use of the preferred optimization system to provide a variety of different optimization system accessing techniques, such as Internet-based and wireless accessing and optimization. Similarly, the present invention preferably includes use of the preferred system to provide an improved and optionally uniquely flexible business model, such as: (i) one providing more efficient optimization job bidding, and/or (ii) providing fee-based, remote access to a local or wide area network of powerful computers that run the optimization algorithm(s) utilizing data provided by the user to the computer network over communication or computer networks such as the Internet or direct wired or wireless connections.

There are other aspects of the present invention that will become apparent as the specification proceeds. In this regard, it is to be understood that the scope of the present invention is not to be determined by whether any particular embodiment includes all the features recited in this Brief Summary of the Invention.

### DESCRIPTION OF THE DRAWINGS

The applicants' invention is shown in the accompanying drawings wherein:

FIG. 1 is a schematic showing the multiple and alternative networks for running the applicant's preferred optimization algorithm system in a processing center remotely, if desired, from one or more data transfer, optimization interface systems running on other computer systems;

FIG. 2 is a schematic software flowchart for one embodiment (Version 2.0) of a preferred component of the applicant's preferred optimization system bearing the trademark SeisOpt®@2D;

FIG. 3 is a schematic software flowchart for an alternative embodiment (Version 2.5) of the applicant's preferred optimization system;

FIG. 4 is a schematic software flowchart for yet another embodiment of the applicant's preferred optimization system bearing the trademark SeisOpt®@Depth;

FIG. 5 is a schematic high level software flowchart for the graphical user interface (“GUI”) provided in SeisOpt®@2D and SeisOpt®@Depth;

FIG. 6 is a schematic software flowchart for the Interactive Velocity Graph (“IVG”) view accessible from the GUI of FIG. 5;

FIG. 7 is a schematic software flowchart for the Model Graph (“MG”) view accessible from the GUI of FIG. 5;

FIG. 8 is a schematic software flowchart for the Interactive Survey Design (“ISD”) view accessible from the GUI of FIG. 5;

FIG. 9 is a schematic of the input control file for Refractive Inversion and Optimization (“RIOTS”) of FIGS. 2-3 and Cross-Hole Inversion Optimization (“XIOTS”) optimization subsystem modules of FIGS. 4;

FIG. 10 is a schematic software flowchart for the RIOTS and XIOTS modules of FIGS. 2-4;

FIG. 11 is a schematic software flowchart for determining the annealing schedule in the preferred generalized Simulated Annealing (“SA”) optimization plug-in module utilized in the RIOTS and XIOTS modules of FIG. 10;

FIG. 12 is a schematic software flowchart for the SA optimization plug-in module utilized in the RIOTS and XIOTS modules of FIG. 10;

FIG. 13 is a schematic of the input file structure for the control file (“Risdinput”) for the Refractive Interactive Survey Design (“RISD”) modules of FIGS. 2-3 and for the Cross-Hole Interactive Survey Design (“XISD”) module of FIG. 4;

FIG. 14 is a schematic software flow chart for the RISD module of FIGS. 2-3;

FIG. 15 is a schematic flow chart of the Interactive Survey Design module accessible through the GUI shown in FIGS. 2-4;

FIG. 16 is a schematic software flow chart of the Automatic Survey Design module accessible through the GUI shown in FIGS. 2-4;

FIG. 17 is a schematic of the input file for the structure of the control file (“Plotinput”) for the MakeEPS module accessible through the GUI of FIGS. 2-4;

FIG. 18 is a schematic software flowchart for the MakeEPS module shown in FIGS. 2-4;

FIG. 19 is a schematic software flowchart for the SeisOpt® Tuner module shown in FIGS. 3-4;

FIG. 20 is a schematic software flowchart for the Forward Modeler submodule shown in FIG. 19;

FIG. 21 is a schematic of the process of the applicants' Internet-based optimization system embodiment, such as shown in FIG. 1;

FIG. 22 is a schematic of the automatic and manual processes of FIG. 21;

FIG. 23 is a schematic of the file upload process shown in FIG. 22;

FIG. 24 is a schematic showing the process of FIG. 21 in greater detail;

FIG. 25 is a schematic flow chart for use of an alternative plug-in serial GA optimizer module in the place of the SA optimizer module of FIG. 12;

FIG. 26 is a schematic flow chart for use an alternative plug-in parallel GA optimizer module in the place of the SA optimizer module of FIG. 12;

FIG. 27 is the first GUI screen provided the SeisOpt®@2D program shown in FIGS. 2-3;

FIG. 28 is the main screen provided by the RIOTS™ module of FIG. 10;

FIG. 29 is the progress window for the RIOTS™ module of FIG. 10;

FIG. 30 is the completion window for the RIOTS™ module of FIG. 10;

FIG. 31 is the pull-down menu provided by the main window of FIG. 30;

FIG. 32 is the “previous optimization” window through the RIOTS™ main window of FIG. 28;

FIG. 33 is a sample screen reporting files in an output subdirectory (demo3) created by a RIOTS run such as shown in FIG. 30;

FIG. 34 is a sample velocity (Velfile) model screen selected by clicking on the “GO” portion of the toggling (alternating) “Stop/GO” button on the screen of FIG. 33;

FIG. 35 is a sample layer density screen selected through a pull-down menu selection labeled “Layer Density” on the screen shown in FIG. 34;

FIG. 36 is a sample Hitfile screen selected through the pull-down menu selection on the screen shown in FIG. 31 and is displayed by clicking “Stop/Go”;

FIG. 37 is a sample Pickfile screen selected through the pull-down menu selection on the screen shown in FIG. 31 and is displayed by clicking “Stop/Go”;

FIG. 38 is a sample multiple source Pickfile screen also selected through the screen of FIG 31 and is displayed by clicking “Stop/Go” and then “View All Picks” (275);

FIG. 39 is a sample Surveyfile/interactive survey design display screen selected through the file identification pull down menu on the upper-center of the screen shown in FIG. 31;

FIG. 40 is a sample recalculation process completion screen generated after changing array geometry through the interactive/automatic survey display screen of FIG. 39;

FIG. 41 is a sample automatic recalculation process screen generated after selecting a subsurface region through the interactive/automatic survey display screen of FIG. 39;

FIG. 42 is a sample MakeEPS settings window selected through the MakeEPS button on the screen of FIG. 34 or FIG. 36;

FIG. 43 is a sample process completion screen generated after EPS output file has been generated through activation of the “OK” button in FIG. 42;

FIG. 44 is the sample opening GUI user interface screen for the preferred Internet-based optimization system;

FIG. 45 is the lowermost portion of the window shown in FIG. 46;

FIG. 46 is the login screen accessible through the screen shown in FIG. 45;

FIG. 47 is the default resolution settings screen provided to the user after logging in through the screen of FIG. 46;

FIG. 48 is a sample resolution settings screen provided to the user after selecting manual settings through the screen of FIG. 47;

FIG. 49 is the data file upload screen provided to the user by activating the next button in the screen of FIG. 48;

FIG. 50 is the file upload completion screen provided to the user after upload has completed through the upload process initiated by the screen in FIG. 49;

FIG. 51 is the job initiation screen provided to the user after the run link has been clicked through the screen in FIG. 50;

FIG. 52 is a progress applet window that automatically opens on the user's web browser screen when a job is activated through the screen of FIG. 51;

FIG. 53 is a job finished message that flashes in the progress applet window of the screen shown in FIG. 52 upon completion of the job activated through the screen of FIG. 51;

FIG. 54 is the progress screen provided to the user after check progress window has been clicked through the screen in FIG. 51;

FIG. 55 is the output file report screen provided to the user through the screen of FIG. 54;

FIG. 56 is a sample Velfile image screen selected through the screen of FIG. 55;

FIG. 57 is a sample Hitfile image screen selected through the screen of FIG. 55;

FIG. 58 is a sample Pickfile image screen selected through the screen of FIG. 55; and

FIG. 59 is sample download screen generated through activation of the download option of the screen in FIG. 55.

In this specification, capitalized software modules or segments, files, or system component terms have the same meaning throughout unless stated otherwise or is otherwise clear from the context of use of the terms.

### DETAILED DESCRIPTION OF THE PREFERRED EMBODIMENTS

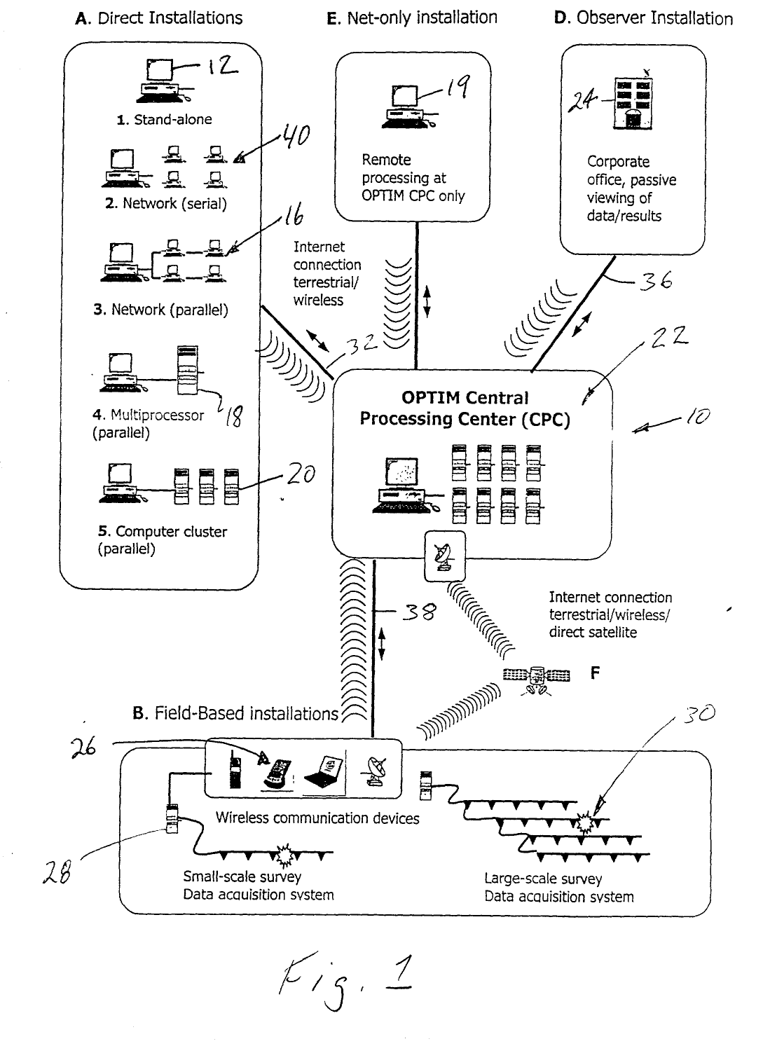

With reference to FIG. 1, the applicants' preferred optimization system can be flexibly arranged to work on a wide variety of stand-alone and computer network systems, generally 10, 12, 14, 16, 18, or 20. The preferred optimization system may thus run on a stand-alone computers 12, computer networks 14, 16, a multiprocessor computer 18, or a computer cluster 20. Alternatively, the applicants' preferred optimization system preferably may run the computationally intensive algorithm optimization task at a central computing center 22, which most preferably consists of a Beowulf cluster computer network. The preferred Beowulf network consists of a cluster of 21 PII 450 MHz PC's running Linux OS. Each node has 512 MB ram and 10/100 Ethernet boards. One of them is designated as the master node that communicates to the outside world. All 21 nodes communicate with each other by means of CISCO Catalyst 2924 X 10/100, 24 port switches. Our parallel algoithm uses MPI, a message-passing interface algorithm to distribute (parallelize) the computation on the cluster. This allows the master to communicate with the slave nodes and vice-versa.

The preferred optimization system software preferably is written in C and C++, but the GUI data transfer interface or system is preferably written in Java. The code itself s compiled with GNC C/C++ compiler. Java version 1.17B is used by the GUI to display and analyze the output results.

Data gathering, uploading, and manipulation tasks, and output viewing and editing, may be performed in varying degrees and in various combinations and permutations through the applicants' preferred GUI interface modules (not shown in FIG. 1) running on any of a variety of remote computing devices, including a remote PC 19, a remote terminal 24, and remote telephonic, laptop, or palmtop computing devices, 26. These remote devices 19, 24, 26 are preferably configured to gather data, such as, in seismic optimization applications, seismic data from one or more seismic arrays in the field 28, 30. The remote devices may communicate with the central computing center through both direct wired and wireless devices F and through conventional wired or wireless telecommunications lines, e.g., 32, 34, 36, 38, and most preferably including the Internet. The type of connection F could, of course, limit the data transfer rate between the central computing system 22 and remote device, e.g., 26. Thus, relatively more expensive cellular wireless or lower bandwidth terrestrial connections might be used for lower data rate transfers, and satellite or higher data-rate terrestrial connections might be used for the higher speed data rate transfers, such as when relatively fast transfers of large volumes of seismic data are involved.

The present optimization system thus represents an advance for users in terms of power, flexibility, economy, service, and convenience. Virtually any type of business can utilize the one or more of the disclosed system embodiments and methods of using them to optimize resources and relatively efficiently seek to increase efficiency, productivity, and sales. Users can either run their own optimization systems on their own computers or computing networks, or they can acquire remote and, if desired, portable computing platforms to, if desired to for example: (i) preserve capital, and (ii) pay (perhaps by credit card or standing account) only for access to and use of a third-party centralized optimization system or network 22 accessed by the user via the Internet or other wired or wireless connection F such as shown in FIG. 1.

The optimization results provided by the central optimization system or network 22 can be sent to any platform or instrument 19, 24, 26 that can access the Internet or other communication system F to which the central system or network 22 is connected. In this manner, the user could access the central optimization system 22 via a cell phone or other portable computing device 26, upload the seismic database information acquired from a local seismic array 28, 30, initiate optimization on the central computing system 22, and hang up. The central computing system 22 may be configured to then access the cell phone or portable computer 26 and download the optimization results to the cell phone or portable computer 26 or to any other device to which output is directed by the user over a network connection either between the central system 22 and the other device or between the cell phone or portable computer 26 and the other device. The optimization results can then be displayed on the portable computer 26 or other compatible computing or communication display device having access to the optimization results.

The preferred optimization engine and related systems disclosed herein can be used for many types of optimization applications in addition to seismic applications. One such additional application is planning and scheduling and design of resources for a consulting company.

For example, a sales person for a consulting company may desire to determine remotely while on a sales call how an additional substantial project might impact their existing work load and scheduling. Using the present optimization engine and optimization GUI described herein, the sale person could use a cell phone to access the GUI interface, upload proposed project information through the GUI, and start the disclosed optimization algorithm subsystem on a centralized computing system. This centralized system can operate at either a third-party central processing center or at the consulting company's home office. After the optimization is completed, the central system could call the sales person's remote cell phone and provide the sales person with real-time optimization information. The sales person then could in addition use the GUI to introduce possible constraints to (i.e., “tune”) the optimized model and determine the effects of the tuning remotely.

Other applications for the preferred optimization engine and related systems include optimization of production, transportation, retail, inventory, scientific (e.g., biotechnology), or engineering systems. Charges for the optimization service can be by single use, scaled use, account, or other appropriate means depending on the particular user, degree of use of the optimization systems, and degree of service, hardware, or systems provided to the user.

The present systems and methods of use thus provide a new business model in which one party may provide, for remuneration, optimization interface software and access to optimization systems to a remote user that need not expend the substantial capital and effort otherwise required to efficiently, flexibly, and more rapidly acquire, use, and maintain the relatively elaborate software and optimization systems typically required to run full optimizations, particularly optimizations of the large size often involved in the seismic optimization field as noted above. This presents the opportunity for a full optimization service provider to expand the potential number of user-customers and procure recurring service fees from those who would access the full optimization service remotely but without owning the system providing the full optimization service.

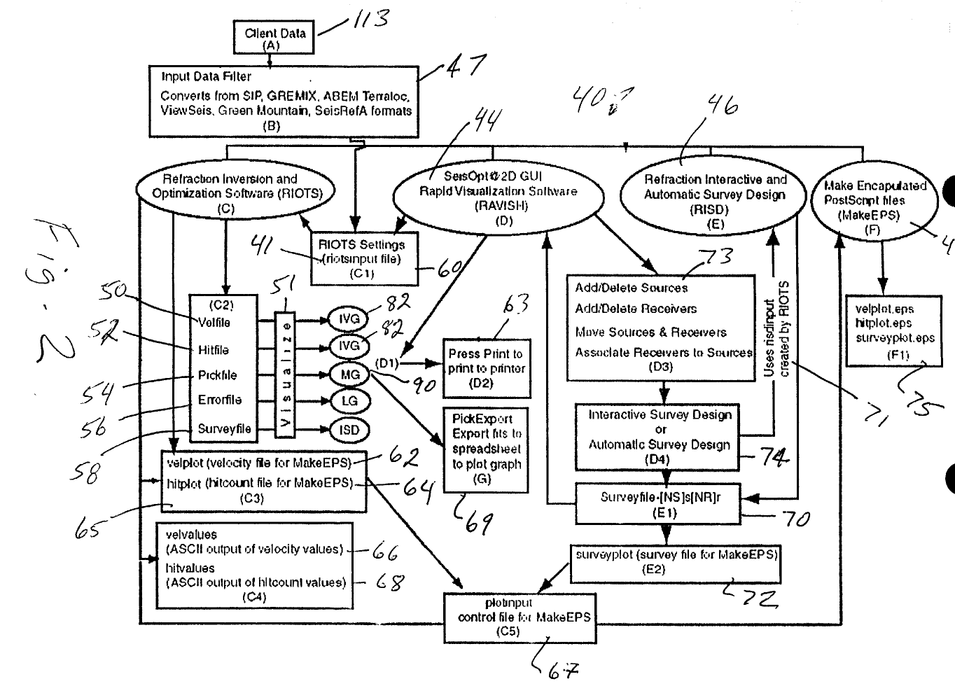

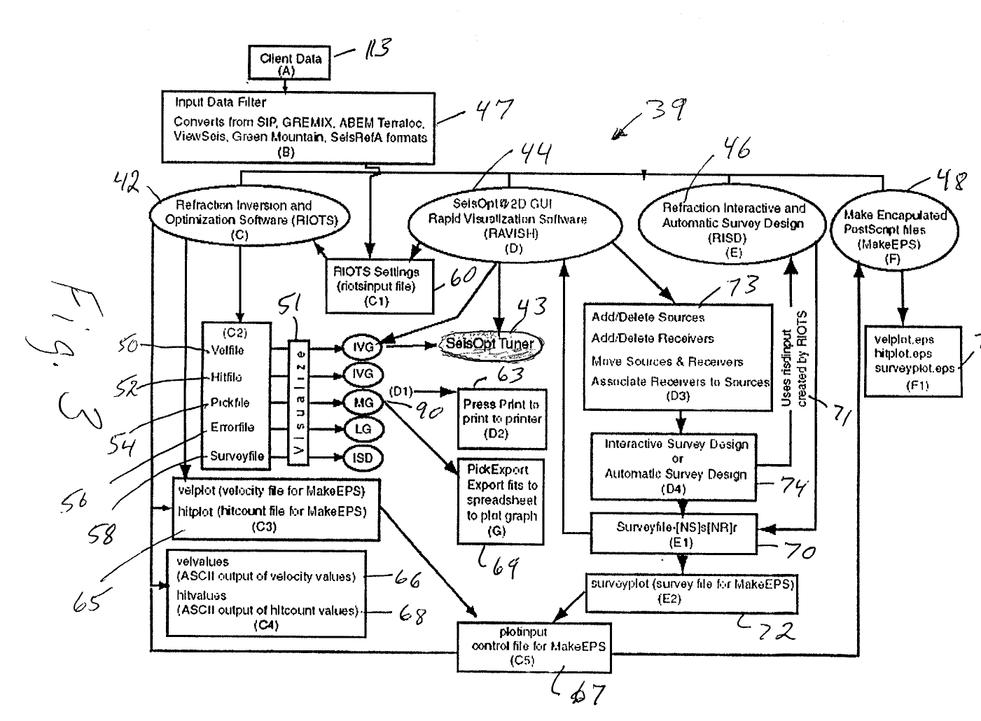

Turning now to FIG. 2, one embodiment of the applicants' preferred optimization system 40 (SeisOpt®@2D) provides refractive inversion and optimization via a GUI user interface 44. As shown in FIG. 3, a second embodiment of SeisOpt®@2D 39 uses the same GUI user interface 44 but adds an interactive optimization tuning module 43, which allows the user to fine tune the optimized velocity model as well as create new initial models for planning a seismic survey or performing a constrained optimization. As shown in FIG. 4, another embodiment of the applicants' preferred optimization system 45 (SeisOpt®@Depth) provides cross-hole inversion and optimization via the same GUI user interface 44 in addition to the features provided by the FIG. 3 embodiment of SeisOpt®@2D.

With reference to FIGS. 2-4, the main components of the SeisOpt integrated optimization systems (both @2D and @Depth) are:

The optimization module, Refraction Inversion and Optimization Software (RIOTS 42) or Cross-Hole Inversion and Optimization Software (XIOTS 49);

The survey design module, Refraction Interactive Survey Design (RISD 46) or Cross-Hole Interactive Survey Design Software (XISD 53);

The output printing module (MakeEPS 48); and

The main GUI, which functions as both the visualization tool and the interface for invoking all other modules, Rapid Visualization Software (RAVISH 44).

RIOTS 42 and XIOTS 49 provide essentially identical functions to the user through the RAVISH 44 interface and mating screens shown below, but XIOTS 49 provides the additional ability to receive data from below the surface of the earth, process such data in the optimization algorithm processed within XIOTS, and output a model based on the cross-hole data.

With continuing reference to FIGS. 2-4, conventional seismic survey client data (first arrival times recorded along the surface for SeisOpt®@2D and first arrival times recorded along bore-hole recorders for @Depth) passes through an input data filter 47, which converts the data from native format to the format required by SeisOpt®@2D and SeisOpt®@Depth. The input files parameter file, Riotsinput 41, can either be created either manually or by using the RIOTS Settings Button 60 for (SeisOpt®@2D), or alternatively the XIOTS Settings button 61 (for SeisOpt®@Depth) present on the RAVISH GUI 44.

The GUI 44 provides the user with the ability to select and execute separate modules including the RIOTS optimization subsystem 42, rapid visualization (RAVISH) 44; refraction interactive and automatic survey design (RISD) 46, and make encapsulated postscript files (with MakeEPS 48). Selection and execution of the RIOTS subsystem 42, through the GUI user interface, optionally generates an optimized velocity output file (Velfile) 50, and hit count output file (Hitfile) 2, a sample or pick output file (Pickfile) 54, an error output file (Errorfile) 56, a survey output file (Surveryfile) 58, and alternatively if selected by the user: a velocity plot file (Velplot) 62 to be used by MakeEPS 48, a Hitcount plot file (Hitplot) 64 to be used by Make EPS 48, an ASCII velocity value file (Velvalues) 66, and an ASCII Hitcount values file (Hitvalues) 68. The RIOTS subsystem 42 also allows the user to review and edit, through the separate GUI interface, input settings 60 used by the optimization algorithm.

The output files 50, 52, 54, 56, 58 produced by RIOTS 42 (or XIOTS 49 for SeisOpt@Depth) can be visualized 51 and the visualization window printed to a printer 63 using RAVISH 44. They 50, 52, 54, 56, 58 can also be made into report quality outputs using the MakeEPS module 62, 64. The PickExport module 69 converts the Pickfile 54 produced by RIOTS 42 or by XIOTS 49 into a format that can be imported into a spreadsheet for plotting and/or editing purposes. The Velvalues 66 and Hitvalues 68 output files produced by RIOTS 42 or XIOTS 49 contain ASCII values of the velocity and hit count respectively. These can be imported into third party contouring programs like Surfer.

The interactive survey design software, RISD 46 and XISD 53, uses the Surveyfile 70 or 58 (70 and 58 represent the same Surveyfile) and Risdinput 71 files created by RIOTS 42. The ISD 74 view of RAVISH GUI 44 enables the user to load the Surveyfile 70 and virtually add, delete and move surveying sources 73 and recalculate subsurface sampling (hit count). Thus, the user can uniquely and interactively determine where to deploy the sources and receivers to sample the target. RISD 46 creates a Surveyplot file 72 which is used by MakeEPS 48 to create a report quality output 75 of the virtual array geometry.

The basic architecture of the GUI, RAVISH 44, is based around an input stream reader and a graph displayer both of which are contained in a view-container. The main RAVISH object instantiates view-container objects for each view to be visualized. Each view-container object contains at least two objects: (1) A ViewLoader that associates input files or Universal Resource Locators (URLs) with input streams and reads line by line from the input stream into a storage array; and (2) a ViewGrapher that fetches data from the view loader and plots the data on a Java Canvas. The ViewLoader and Grapher assume that each line of data in the input stream specifies a complete plot to be graphed on the view's canvas by the ViewGrapher. A multi-line input source results in each line of input being graphed in sequence resulting in an animation. RAVISH 44 controls this animation through a set of view independent buttons. These are Go/Stop, <<, >>, Reset, Settings buttons. The Go/Stop buttons toggles between automated display of the next line and stopping the display at a particular line. The << button goes to the previous line, and the >> button goes to the next line. The Reset button reloads all views, that is, it kills all current view-container objects and re-instantiates new view-container objects for each view to be visualized. The Settings button brings up a Settings Dialog object in a new Java Frame. This allows users to input the files or URLs to be read in and their associated view types.

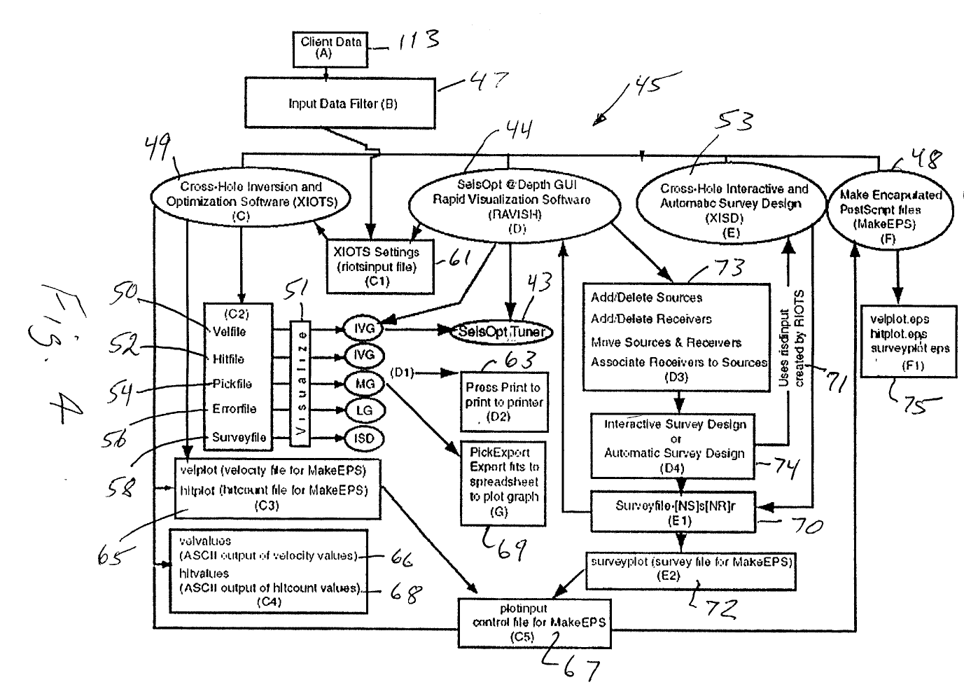

With reference now to FIG. 5, the GUI 44 first initializes 80 in the following fashion:

1. If RAVISH 44 is invoked as an applet (that is, the Ravish method gets called), set a flag to denote this fact and proceed with the start method. If invoked as an application, create a Java Frame to hold future window objects.

2. If RAVISH 44 is an applet, get parameters from the web page and parse them to see how many views there are, their corresponding view types, and corresponding locations. Put this information in a list.

3. Provide the CommonSettings object with the information on number of views, view types, and view locations. Allow RAVISH 44 to notice any changes in CommonSettings. RAVISH is an observer of CommonSettings.

4. Initialize the Settings Dialog Object with the same information as in item 3 above. The SettingsDialog object can change CommonSettings which will then force RAVISH 44 to respond to these changes.

5. Create a Java Panel JP to hold all window objects. Create a second panel, buttonPanel, to hold all view independent (common) buttons (Go/Stop, <<, >>, Settings, Reset, Print Quit). Create a pull down menu (PDM) with list of views from item 3 above.

6. Add the buttonPanel to JP. Then set up the views by associating input sources with view types and their implementations. Add the pull down menu (PDM) to JP. Prepare the first view in the list of views for display when the Go button is pressed. Next, show the display window 81. If RAVISH 44 is invoked as an applet, the browser provides the context frame, otherwise display the frame created in step 1 of initialization above. The user may then choose a view from the pull down menu of views available. Depending on the view, respond to user input and build a view. One example is the Line Graph View, LG 17.

In LG 17, the LineGraph Object is contained in the LineGraphContainer object:

public class LineGraphContainer extends ViewContainer {

All view-containers including the LineGraphContainer extend the ViewContainer Object. This abstract (in the Java meaning of abstract) ViewContainer object instantiates a ViewLoader object for this view and adds itself (the ViewContainer) as on observer of the ViewLoader. The ViewContainer also responds to the navigation buttons (Go/Stop,<<,>>) by setting/changing state variables in the ViewLoader object. The ViewLoader extends the Java Panel Class.

private LineGraph _lg;

private LineGraphZoomer _lgz;
public LineGraphContainer (int num, CommonSettings cs) {

super (num, cs);
_lg = new LineGraph (_vl);
_lgz = new LineGraphZoomer (_lg);
_vl.SetFileReadSleepParams (40, (float) (3.0));
_vl.SetLoaderSleepParams (200, 40);
setLayout (new BorderLayout());
add (“North”, _lgz);
add (“Center”, _lg);
validate ();

}

Next: (1) instantiate a LineGraph Object and a LineGraphZoomer Object; (2) set

viewloader (_vl) parameters that control how much time the viewloader sleeps
between reads from the input source, and (3) layout the two instantiated objects.
public void clear () {

_lg.repaint ();

}
public void update (Observable o, Object arg) {

if (o == _vl && arg == ViewLoader.MSG_READNEWVALUE) {

_lg.Respond (LineGraph.UPDATE);
validate ();

}

}

}

Whenever there is a “new-value-read” message from the viewloader, the LineGraph's respond method is invoked.

The code below is the Java constructor for the LineGraph object. In the absence of any data, the constructor simply sets the initial minimum and maximum values of its plot to default values.

public class LineGraph extends Graph {

. . .
. . .
. . .

public LineGraph (ViewLoader vl) {

super (vl);
_minXValue = 0;
_maxXValue = 1;
_minYValue = 0.0;
_maxYValue = 1.0;

}

The format of the data source for LG 17 is:

First line: Number of Columns (NC) of data to be read in subsequent rows

Second line: Names of all NC Columns

Third and subsequent lines for each column numbered:

1. Sequence number

2. x-coordinate value (X)

3. NC-2 columns of y-coordinate (Yᵢ) values. Each (X, Yᵢ) for i=0 through NC-2, represents the points of a line. Thus there are NC-2 lines to be displayed.

The Respond method sets current line number of data read from the input source. It also sets the plot or graph's ranges based on overall minimum and maximum values of the X and Y coordinates. If a zoom button has been pressed, update the min and max values appropriately. In the end, the Respond method calls the repaint ( ) method. This results in a call to the object's paint method. Because LineGraph inherits from the Graph object and Graph has a defined paint method, Graph's paint method is invoked.

public void Respond (int action) {

if (action == UPDATE) {

_tempCurrent = _vl.Current ();
// Set the graph ranges based on the overall max and mins
if (_tempCurrent <= 0) {

_minXValue = _maxXValue = _vl.X (_tempCurrent);
_minYValue = _maxYValue = vl.Data (1, 0);

}
if (_tempCurrent >= 0) {

if (_vl.X (tempCurrent) < _minXValue)

_minXValue = _vl.X (_tempCurrent);

if (_vl.X (_tempCurrent) > _maxXValue)

maxXValue = _vl.X (_tempCurrent);

for (int i = 1; i < _vl.Columns (); i++) {

if (_vl.Data (i, _tempCurrent) > _maxYValue)

maxYValue = _vl.Data (i, _tempCurrent);

if (_vl.Data (i, _tempCurrent) < _minYValue)

minYValue = _vl.Data (i, tempCurrent);

}
if (_zoomFact == 1) {

double border = 0.05 * (_maxYValue − _minYValue);
SetYMax (_maxYValue + border);
SetYMin (_minYValue − border);
SetXMax (_maxXValue);
SetXMin (_minXValue);

} else {

double border = 0.05 * (_zoomULC_y − _zoomLRC_y);
SetYMax (_zoomULC_y + border);
SetYMin (_zoomLRC_y − border);
SetXMax (_zoomLRC_x);
SetXMin (_zoomULC_x);

}

} else {

SetYMax (1);
SetYMin (0);
SetXMin (0);
SetXMax (1);

}
repaint ();

}
if (action == ZOOM_SET_X) {

_zoomSet = ZOOM_SET_X;

}
if (action == ZOOM_SET_XOUT) {

_zoomSet = ZOOM_SET_XOUT;

}
if (action == ZOOM_SET_STOP) {

_zoomSet = ZOOM_SET_NONE;

}
if (action == ZOOM_SET_BOX) {

_zoomSet = ZOOM_SET_BOX;

}
if (action == ZOOM_SET_1) {

_zoomFact = 1;
Respond (UPDATE);

}

∵

The Graph Object's paint method is invoked by Java for doing the actual drawing of the view. Graph's paint method takes care of setting minimum and maximum dimensions, double buffers the drawing, and calls the view's drawGraph Method. LG's 17 drawGraph method is as follows:

public void drawGraph (Graphics g, Rectangle r) {

if (tempCurrent <= 0) {

g.setColor (_textColor);
g.drawString (“No data”, r.x + r.width / 2, r.y + r.height

/ 2);

} else {

for (int n = 1; n <= tempCurrent; n++) {

for (int i = 1; i < _vl.Columns (); i++) {

g.setColor (ColorMap.MAP (i * (int) ColorMap.length ()

/ (_vl.Columns C) − 1) − 1));

drawLine (g, (double) (_vl.X (n−1)), _vl.Data (i, n−1),

(double) (_vl.X (n)), _vl.Data (i, n));

}

}

Thus, if no data has been read display the string “No Data” in the center of the Canvas. Otherwise, for each line-of-data that has been read, for each line to be drawn (for each of the NC-2 columns referred above) use the SeisOpt® ColorMap (see below) to set the line color. Then, draw the next point of the line and connect it to the previous point with a straight line. The rest of the LineGraph object responds to mouse clicks and writes coordinates of the clicked point on the screen, does zooming (by changing minimum and maximum plot dimensions). The LineGraphZoomer object sets up the zoom buttons and sends the LineGraph object's Respond method an appropriate message. Respond then sets the minimum and maximum ranges of the drawing and thus implements zooming. The zoom in button currently zooms in by zooming in by a factor of 1.4 and the zoom out button zooms out by a factor of 0.7.

It should be noted that a sequence of lines is viewed using any View as an animation. Pressing Go causes each line of data from an input source to be displayed (according the view's instructions) in turn in the sequence in which they were written to the input source. Also, with regard to view specific buttons in general, a state variable denoting which button has been pressed is set (for example: by invoking Respond with an appropriate argument). The view's drawGraph method then draws the view incorporating any changes brought about by user mouse clicks.

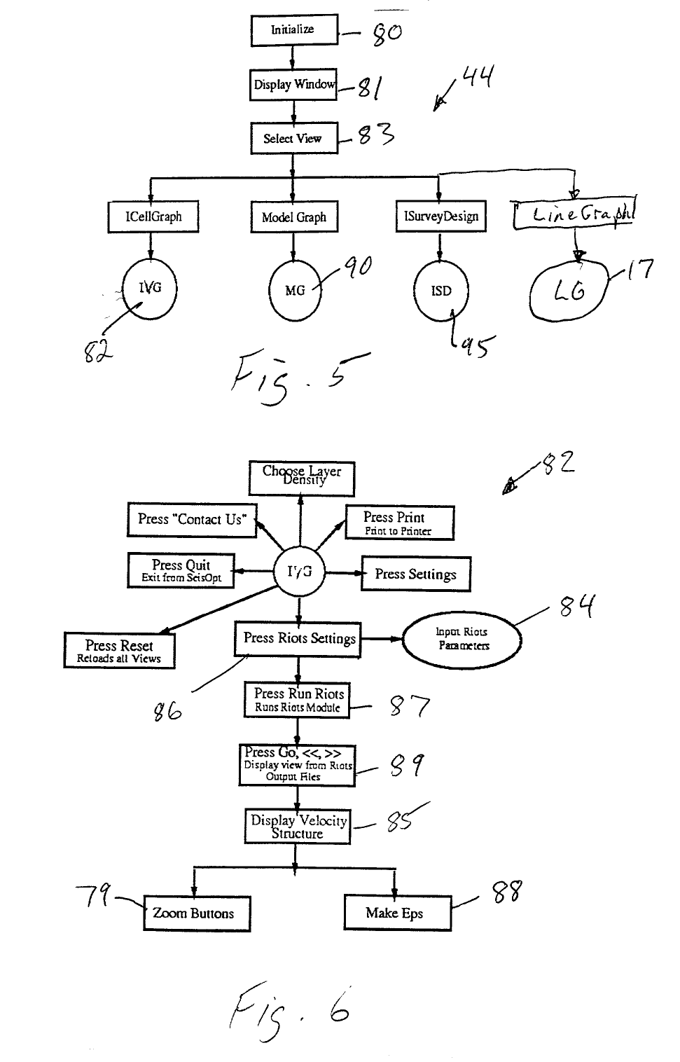

With reference now to FIGS. 5 and 6, Interactive Velocity Graph (IVG 82) may be selected through the Select View button 83 in the Initialization Step. The IVG view 82, which is also the default view in the Initialization step of FIG. 5, also provides the interface to input 84 (FIG. 6) the RIOTS executable's parameters and to run the RIOTS executable (see 42 in FIG. 2). Double buffering techniques are used to reduce window flicker. The IVG view 82 displays the velocity model file (Velfile 52 in FIGS. 2, 3, and 4) and the hit count (Hitfile 52 in FIGS. 2, 3, and 4).

As described below in connection with FIG. 6, the IVG view 82 is used to display velocities 85 on a cross section of the sampled subsurface. This rectangular cross-section is divided into a two dimensional grid and each (rectangular) cell of this grid has a velocity, that is mapped to a color and displayed as a filled rectangular cell. The objects making up these views are therefore prefixed with “CellGraph” as described below.

1. Instantiate a new CellGraphOptions object. This notifies the CellGraph about the resolution (number of colors to map the current velocity range to).

2. Instantiate a new CellGraph object and give it access to the viewloader and the CellGraphOptions object above. This object contains the drawGraph method which draws the view on the canvas.

3. Instantiate a CellGraphZoomer object and give this object access to the CellGraph Object instantiated above. This object contains the following buttons: Zoom in, Zoom Out, Zoom 1:1, and Zoom Box buttons 86 as shown in FIG. 6. The Zoom buttons 86 should preferably be independent of the particular view, e.g., IVG 82, being presented, but they alternatively can view dependent to present zooming only for the IVG view 82. For the IVG view 82, the following buttons are included with the CellGraphZoomer: RIOTS Settings 86, Run Riots 87, and MakeEps 88. In the event any of these buttons are pressed, a message is sent to the CellGraph object which will then respond to the message.

4. Instantiate a new CellGraphLegend Object to hold the legend for this view. This legend shows what color corresponds to what velocity.

5. Set this view's viewloader's parameters. These parameters determine how long the view loader sleeps between reads if there is no new data.

6. Add these objects to the View's Container Panel.

IVG 82 specific buttons are created and displayed by adding to the view's Panel. These include the Zoom 79, the Riots Settings button 86, the Run Riots button 87, and the MakeEps button 88. The view's 82 canvas is created through inheritance from the Graph Object (discussed below), which implements useful graphics primitives. In addition a pull down menu of resolution choices is created and placed in this view's panel.

The IVG 82 specific buttons include:

1. The Riots Settings button 86 (in XIOTS 49 of FIG. 4, this is labeled “Xiots Settings” 61) pops up a window to enter the parameters for the RIOTS executable (42 in FIG. 2). This is implemented by creating a Java Frame with a label for each parameter name, and a text or choice field for each parameter. If the parameter is a file name, an optional FileDialog window is made available to interactively choose a file on the client machine. Pressing the Ok button in this window, closes the window and saves the parameters to, as shown in FIG. 2, the Riotsinput file 41 needed by the RIOTS executable 42. With reference to FIG. 6, a Cancel button in the IVG window 82 removes the dialog.

2. The Run Riots button 87 (“Run XIOTS” for XIOTS 49 in FIG. 4) creates a Java thread in which to run, as shown in FIG. 2, the RIOTS 42 executable. It also creates pipes to pipe riots terminal output to a Java Text window. The Java Text window provides a text indication of progress by printing a “.” periodically after a set number of iterations. This eliminates the need for a DOS terminal window and offers substantial business advantage in ease of use.

3. When, as shown in FIG. 2, the RIOTS 42 executable finishes Press Go, <<, >> 89 to view the resulting velocity model 85.

This starts the ViewLoader thread:

The ViewLoader thread reads input line by line from the specified file or URL. Each line is converted to a numeric type and stored in a dynamically allocated array. This array grows in capacity if the current capacity is exceeded. The first two rows/lines of the file have the same meaning as for LineGraph (see discussion of LineGraph above). The format for the rest of the lines is:

Column 1: Iteration Number

Column 2: Number of Rows (R) in the velocity model

Column 3: Number of Columns (C) in the velocity model The next (R * C) columns contain the velocities in the model in row-major format

Last 4 columns: h, minx, -h, minY: These are transformation parameters to translate from row, column number to ground coordinates. This uses the following formula (formula (3)) for the x coordinate:

x*h+minX and for the y coordinate: y*−h+minY.

The ViewGrapher creates a Java Canvas through inheritance from the Graph object for drawing the two dimensional velocity structure and draws the structure as follows: For each cell in the velocity model (which is a two dimensional array), map the velocity to a color using the Seisopt ColorMap. By default the velocities in the model are mapped to 257 colors. Draw a filled rectangle (using drawRectangle) of the mapped color in the location corresponding to the array coordinates of the current cell.

4. Respond to user clicking on the IVG 82 canvas in different ways depending on the following context:

(a) If Zoom Control buttons 96 have been pressed, zoom appropriately.

(b) Else, display ground coordinates of the cell and its velocity by obtaining these from the ViewLoader, modifying them according to formula (3) and writing these values on the IVG 82 canvas.

5. Resolution of the displayed velocities may be changed by pulling down and choosing a new resolution. This changes the number of colors available for mapping to 3, 9, 17, . . . , 257 colors and redraws the IVG 82 canvas.

6. The MakeEps executable 88 may be run to create a color postscript file of the velocity model, ready for printing. Pressing the MakeEps button 88 pops up a Java Frame that contains a Dialog Window for MakeEPS (see 48 in FIG. 2) with a set of parameters labels and text or menu fields for these parameters that change the postscript output. With reference to FIG. 6, pressing the Ok button in the MakeEPS 88 window: (i) saves these to the input file for, as shown in FIG. 2, the MakeEps executable 48; and (ii) removes the dialog window from view and runs the MakeEps executable in a separate thread. The Cancel button removes the dialog window.

A tuner view, TuneGraph (not shown in FIG. 6), is an alternative preferred operation and view (SeisOpt Tuner 43 in FIGS. 3 and 4) that preferably can be accessed through the IVG view 82. This alternative operation and view creates and adds a panel of buttons on the left of the TuneGraph or SeisOpt Tuner view. These buttons can be separated into two groups and described below.

1. Group I

(a) Box: This operation toggles its corresponding state variable. When a mouse button is then pressed down, the location of this event (iloc) is stored. Dragging the mouse with the button pressed down then makes drawGraph draw a rectangle (in black) from the initial location of the button press (iloc) to the current location of the mouse. Releasing the mouse button leaves the last rectangle drawn on the view. This specifies the area (ChangeArea) within which the user would like to make changes to velocity values.

(b) SetVel: This operation pops up a Java Frame with a panel asking the user for an absolute velocity (abvel) to which to set the velocities of cells in the ChangeArea. Entering a value and clicking on the OK button of this panel causes the velocities in the ChangeArea to be set to the user entered value (abvel). This change is propagated to the ViewLoader object associated with this view.

(c) Gradient: This operation pops up a Java Frame with a panel that asks the user for a low velocity (lowVel) and a high velocity (highVel). Entering a value and clicking on the OK button of this panel causes the first row of cells in the current ChangeArea is set to lowVel and each subsequent row of cells in the current ChangeArea is set to: (highVel−lowVel) /(number of rows in ChangeArea−1). This change is propagated to the ViewLoader object associated with this view. Refer to Section 10 for the teaching of use.

2. Group II

(a) Area Select: This operation toggles its corresponding state variable. When a mouse button is then pressed down, the color at this location is stored and all other cells with the same color (icolor) are found and stored. This store operation specifies the group of cells (ChangeCells) in which the user may then change the associated velocity values. These cells are automatically marked by drawing a cell sized black rectangle outline around all cells in ChangeCells.

(b) MoveUp: This operation sets all cells that are in rows above the top row of cells in ChangeCells to the same velocities as the velocities in the top row of cells in ChangeCells. Such changes are only limited to cells in the current model.

(c) MoveDown: This operation sets all cells that are in rows below the bottom row of cells in ChangeCells to the same velocities as the velocities in the bottom row of cells in ChangeCells. Such changes are only limited to cells in the current model.

(d) ChangeVel: This operation pops up a Java Frame with a panel that asks the user for a velocity change (velChange). Entering a value and clicking on the OK button of this panel causes the velocities of all cells in ChangeCells to change by velChange. This change is propagated to the ViewLoader object associated with this view.

Referring now to FIG. 7, the Model Graph (MG 90) View uses double buffering techniques to reduce window flicker. This view displays the Pickfile 91.

View specific buttons are created and displayed by adding to this view's 90 Panel. These include the Zoom buttons 92 and the “View all picks” 93 check box. The view's 90 canvas is created through inheritance from the Graph Object that implements View-to-Java-Canvas and Java-Canvas-to-View coordinate system transformations and provides graphical primitives as described in greater detail in connection with both the LineGraph and Interactive Velocity Graph 82 of FIG. 6 described above.

1. Pressing Go 94 causes the view 90 to begin a ViewLoader thread and the ViewDisplay displays pairs of lines corresponding to the model's fit to observed picks 91. In the ViewLoader Thread, the input reader thread reads input line by line from the specified file or URL. Each line is converted to a numeric type and stored in a dynamically allocated array. This array grows in capacity, if the current capacity is exceeded, by reading the Pickfile (54 in FIG. 2, 3, 4. The format of such input is:

Column 1: Source Number

Column 2: Number of columns left to read (n)

Column 3 through n+2: X-coordinate of receiver, observed time, calculated time repeated n/3 times.

In ViewDisplay, the view displayer creates a Java Canvas for drawing. There are two drawing modes. If the user checks the “View all picks” 93 check box, ViewDisplay draws all pairs of lines for the Pickfile display (FIG. 38). Otherwise, the ViewDisplay draws the current pair of lines. This essentially corresponds to drawing a pair of lines for each observed pick and model using Java's drawLine method after translating seismic coordinates to Canvas coordinates. The points specifying the lines are denoted by triangles and circles (FIG. 37).

2. This MG view 90 responds to user clicking on the canvas in different ways depending on context as follows.

(a) If zoom control buttons 92 have been pressed, zoom appropriately.

(b) Else, display coordinates of the point clicked at by the user.

3. Clicking on the “View all picks” check box 93 displays all data lines together instead of sequentially in an animation (i.e., automatic adding data lines in sequence to the MG view 90, which is activated by clicking the GO button 94).

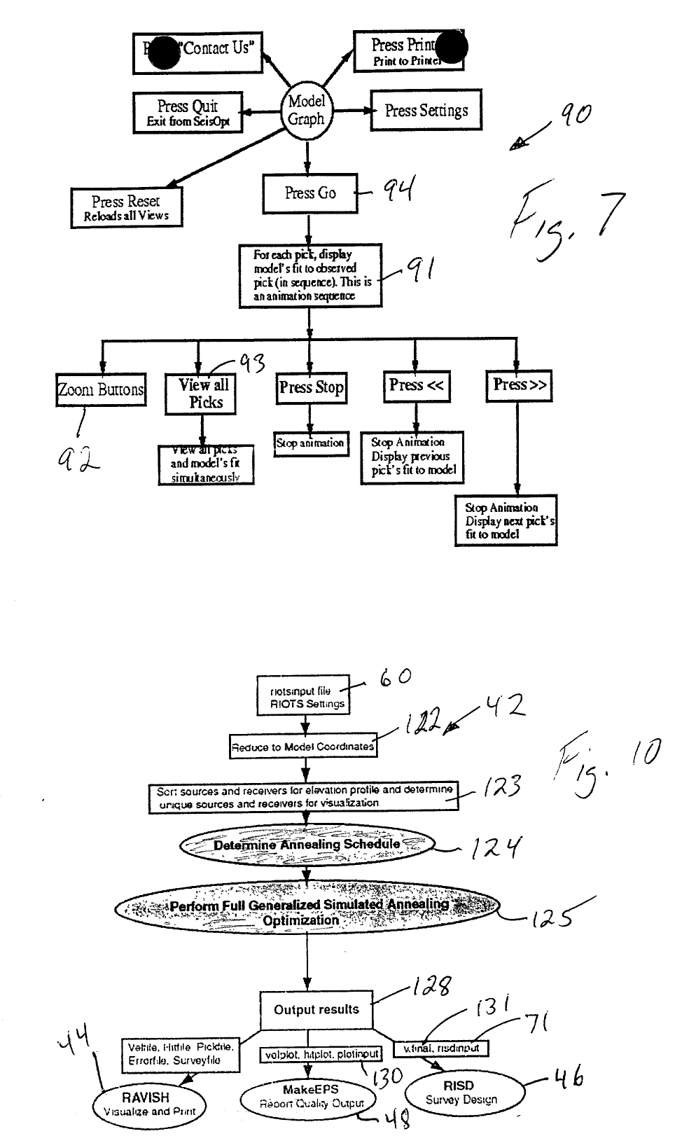

With reference now to FIG. 8, the ISD view 95 is similar to the Interactive Velocity Graph View 82 in FIG. 6. This ISD 95 view also provides the interface for the interactive survey design modules, RISD 46 in FIGS. 2 and 3 and XISD 53 in FIG. 4, which are used to optimize the location of sonic seismic sources and receivers to obtain the maximum ray coverage (hit count) in the desired area of the subsurface being studied by the user. The ISD view 95 utilizes double buffering techniques to reduce window flicker. When selected, ISD 95 operates as follows:

1. Instantiate an ISDOptions object. This notifies the ISD object to provide a pull down menu for selection of the resolution (the number of colors to which the current velocity range is mapped). This code is almost exactly the same as for the CellGraphOptions Object described above.

2. Instantiate a new ISD object and give it access to the ViewLoader and the ISDOptions object described above. This ISD object contains the DrawGraph method, which draws the view on the canvas.

3. Instantiate a ISDZoomer object and give this object access to the ISD Object instantiated above. This object contains the Zoom in, Zoom Out, Zoom 1:1, and Zoom Box buttons 96. For the ISD 95, the following buttons are added to the CelllGraphZoomer: Move 97, Associations 77, Add Source 98, Del Source 100, Add Receiver 99, Del Receiver 101, Assoc. All Recs 103, Make Box 104, Info 105, Auto 106, Interactive 107, Undo 108, and Redo 109 Buttons. In the event any of these buttons are pressed, an appropriate message is sent to the ISD object.

4. Instantiate a new ISDLegend object to hold the legend for this view 95. This Legend maps the number of rays passing through a cell and a corresponding color.

5. Set this view's ViewLoader's parameters. These parameters determine how long the view loader sleeps between reads if there is no new data.

6. Add these objects to the View's Container Panel.

The ISD 95 view's canvas is created through inheritance from the Graph object that implements View-to-Java-Canvas and Java-Canvas-to-View coordinate system transformations and provides graphical primitives as described in the Graph section. In addition a pull down Settings menu 110 of resolution choices is created and placed in this view's panel.

1. The Go, <<, >> 111 button provides a view of the current Surveyfile. This takes place by starting the ViewLoader thread:

The ViewLoader thread reads input line by line from the specified file or URL. Each line is converted to a numeric type and stored in a dynamically allocated array. This array grows in capacity if the current capacity is exceeded by reading. The first two lines follow the same format as the data source for LineGraph described above. The format for the rest of the lines is:

Column 1: Sequence/Iteration Number

Column 2: Number of Rows (R) in the velocity model

Column 3: Number of Columns (C) in the velocity model

The next (R * C) columns contain the velocities in the model in row-major format

The next two columns contain the number of sources (nSources) and the total number of receivers (count) for all sources.

(a) The next nSource * 2 columns contain the x and y coordinates of the sources

(b) The next count * 2 columns contain the coordinates of receivers associated with each of the nSource sources.

(c) For each source, i, there is then a column that lists the number of receivers associated with that source ( nRecPerSrc[i]). Then the next nRecPerSrc[i] columns contain the receiver identity of the receivers associated with source i.

(d) The last four columns are identical to the last four columns in Interactive Velocity Graph

The ViewDisplayer creates a Java canvas for drawing the two-dimensional hit count structure and draws a view of hits, source, and receiver locations 112. For each cell in the hit count model (which is a two dimensional array), map the velocity to a color using the Seisopt ColorMap.By default the hit counts in the model are mapped to 257 colors. Draw a filled rectangle of the mapped color in the location corresponding to the array coordinates of the current cell.

2. This view 112 then responds to a user clicking on the canvas in different ways depending on context.

(a) If zoom control buttons 96 have been pressed, zoom appropriately.

(b) Else, display ground coordinates of the cell and its hit count, obtaining these values from the ViewLoader and writing these values on the canvas.

3. The user can also change the resolution of the displayed hit counts by pulling down the Settings menu 110 and choosing a new resolution. This changes the number of colors available for mapping to 3, 9, 17, . . . , 257 colors and redraws the canvas.

4. The default color for all sources and receivers is gray.

5. Move 97: This operations sets a state variable to show that the move button 97 has been pressed. It then responds to mouse clicks on sources or receivers by moving the source or receiver, by redrawing source or receiver, at the current mouse location. Any move also results in a sort of all sources and receivers along the x-axis of the present screen view and subsequent drawing of a line linking all sources and receivers. The state variable is unset when the Info button 105 is pressed.

6. Add Source 98: This operation sets a state variable to show that Add Source was pressed. It the responds to mouse clicks by drawing a new source at mouse click location. This source is also added to the view's list of sources and all sources and receivers are sorted so that a line can be drawn on screen through all sources and receivers. Mouse clicking on receivers now toggles the set up of an association between that receiver and the newly added source. The state variable is unset when the Info button 105 is pressed.

7. Add Receiver 99: This operation sets a state variable to show that Add Receiver was pressed. It then responds to mouse clicks by drawing a new receiver at mouse click location. This receiver is also added to the view's list of receivers and all sources and receivers are sorted so that a line can be drawn on screen through all sources and receivers. The state variable is unset when the Info button 105 is pressed.

8. Del Source 100: This operation sets state variable to show that Del Source was pressed. If the user then clicks on a source on screen, it will be deleted from the list of current sources and from the view. The state variable is unset when the Info button 105 is pressed.

9. Del Receiver 101: This operation sets state variable to show that Del Receiver was pressed. If the user then clicks on a Receiver, it will be deleted from the list of current receivers and from the view. The state variable is unset when the Info button 105 is pressed.

10. Associations 77: This operation sets the Association's state variable. If the user then clicks on a source on the screen, all associated receivers will be highlighted (drawn in black color). Clicking next on a receiver on screen then toggles the association of that receiver with the current source. The state variable is unset when the Info button 105 is pressed.

11. Assoc. All Recs 103: This operation sets a corresponding state variable. Clicking on a source on screen then associates all receivers with the source that was clicked. The state variable is unset when the Info button 105 is pressed.

12. Info 105: This operation unsets state variables for other buttons and sets the screen view to display hit count information when the mouse is clicked on a cell in the screen view. When the user then clicks the mouse on the screen, this operation writes text to the screen providing the cell location (in view coordinates) and its hit count.

13. Make Box 104: This operation sets the state variable corresponding to this button. When a mouse button is pressed down next, the location of this event (iloc) is stored. Dragging the mouse with the button pressed down now makes DrawGraph draw a rectangle (in black) from the initial location of the button press (iloc) to the current location of the mouse. Releasing the mouse button leaves the last rectangle drawn on the view. The area bounded by the rectangle tells the ISD optimizer the area where the user wants to increase the hit count.

14. Undo 108: This operation undoes the last ONE action taken through selection of action on this display screen 112. In other words, a state change altered by pressing any of the above buttons, e.g., 98, will already have been stored by the procedure associated with that state change. Pressing Undo 108 causes this prior state to be restored. Pressing the Undo button 108 a second time immediately after pressing it a first such time does nothing. There is thus also a state variable associated with the Undo button 108 that is used to remember whether a stored state is valid. In the alternative, the system could be altered so that the user can do a multi-step undo by storing state in a Java Vector.

15. Redo 109: This operation re-does the last ONE action caused by pressing the UNDO button 108. Pressing the redo button 109 a second time immediately thereafter does nothing. There is thus also a state variable associated with the Redo button 109 that is used to remember whether the to-be-restored state is valid. In the alternative, the system can be altered to allow the user to do multi-step undo by storing state in a Java Vector.

16. Interactive 107: This operation causes the current numbers and locations of sources and receivers on screen to be written to input files. The interactive mode of the survey design software, RISD 46 in FIGS. 2 and 3 (or XISD 53 in FIG. 4), is then executed in a separate thread to compute the new hit counts.

17. Auto 106: This operation causes the current numbers and locations of sources and receivers on screen to be written to input files. The automatic mode of the survey design software, RISD 46 in FIGS. 2 and 3 (or XISD 53 in FIG. 4), is then executed in a separate thread to optimize the locations of sources and receivers to maximize hit count in the area specified when using the Make Box command or button 104. The default is to maximize the hit count in the entire model.

The Graph Object, called by all views RAVISH 44, implements double buffering, translation of coordinates, and drawing primitives for RAVISH 44. This method extends the Java Canvas object. Since all view displayers inherit from Graph, they inherit from the Java Canvas. This Graph object's paint method is usually invoked in response to a change of state in the current view. This paint method displays rudimentary coordinates and invokes the view's drawGraph method. The view's drawGraph method plots/implements the view.

This Graph object provides the following utilities:

1. Translate: translates to Java Canvas coordinates (Screen coordinates);

2. unTranslate: translates back to view's coordinates (some loss of accuracy is possible here);

3. drawpoint: translates to screen coordinates and draws a point;

4. drawLine: translates to screen coordinates and draws a line;

5. drawRectangle: translates to screen coordinates and draws a filled rectangle;

6. drawPolygon: translates to screen coordinates and draws a polygon; and

18. drawFilledPolygon: translates to screen coordinates and draws a filled polygon.

The SeisOpt® ColorMap routine is as follows:

public class ColorMap {

public static final long length () {

return 1276;

}
public static final Color MAP (int i) {

if (i <= 255)

return new Color (255 − i, 0, 255);

else if (i <= 510)

return new Color (0, (i+1) % 256, 255);

else if (i <= 765)

return new Color (0, 255, 255 − ((i+2) % 256));

else if (i <= 1020)

return new Color ((i+3) % 256, 255, 0);

else if (i < 1276)

return new Color (255, 255 − ((i+4) % 256), 0);

else return new Color (0, 0, 0);

}
public static final Color ShadeMap (int i, double shade) {

if (i <= 255)

return new Color ((int) ((255−i) *shade), 0,

(int) (255*shade));

else if (i <= 510)

return new Color (0, (int) (((i+1) %256) *shade),

(int) (255*shade));

else if (i <= 765)

return new Color (0, (int) (255*shade),

(int) (((255− ((i+2) %256))) *shade)),

else if (i <= 1020)

return new Color ((int) (((i+3) %256) *shade),

(int) (255*shade) , 0);

else if (i < 1276)

return new Color ((int) (255*shade), (int) ((255−

((i+4) %256)) *shade),

0);

else return new Color (0, 0, 0);

}

}

With reference back to FIGS. 2-4, RIOTS 42 and XIOTS 49, as implemented through RAVISH 44, operate in exactly the same manner except as noted above. The following descriptions of RIOTS 42 therefore also apply to XIOTS 49 unless otherwise stated.

With reference now to FIGS. 2, 3, and 4, the client data 113 can be any seismic data. In particular, SeisOpt@2D and SeisOpt@Depth use first arrival travel times picked off shot-gathers recorded in the field. The Data Filter 476 reads in pick files written out by various commercially available software (like SIP, GREMIX, Terraloc, Green Mountain, ViewSeis, SeisRefA) and creates three files, namely, the pick times file, the source information file, and the receiver information file. These files can have any name, but must comply with the following format:

The source information file has three columns separated by white space:

Column 1: Distance of each source in the X (horizontal) direction, along the survey, in physical units (ft, m, km).

Column 2: Elevation (z) of each source in physical units. Note that elevation decreases with depth. The top of the model has to have the maximum elevation.

Column 3: Number of picks (or number of recording receivers) associated with each source.

The receiver information file has two columns that should be separated by white space:

Column 1: Distance of each receiver in the X (horizontal) direction, along the survey, in physical units ft., m., or km.

Column 2: Elevation of receivers (geophones) in the same units as above. Note that elevation decreases with depth. The top of the model has the maximum elevation.

The number of entries in this file should equal the sum of the entries in the 3^{rd} column of the source information file. That is, for each source, the user enters the co-ordinates of all the recording receivers (there is a pick associated with each such receiver), even if receivers repeat from one source to the next.

The pick times (observations) file consists of one column, with one pick on each line. These times should be in seconds. The number of entries in this file should be the same as the number of entries in the receiver information file.

The units and order of the information in each file should be consistent between all files. That is, the order of the pick times should follow the order of the receiver locations in the receiver file; and these, in turn, should follow the order of the sources in the source file. For the input to be consistent, the sum of the numbers of picks (or recording receivers) per source (the 3^{rd} column of the source file) should be the same as the total number of receivers in the receiver file and the total number of picks in the pick file.

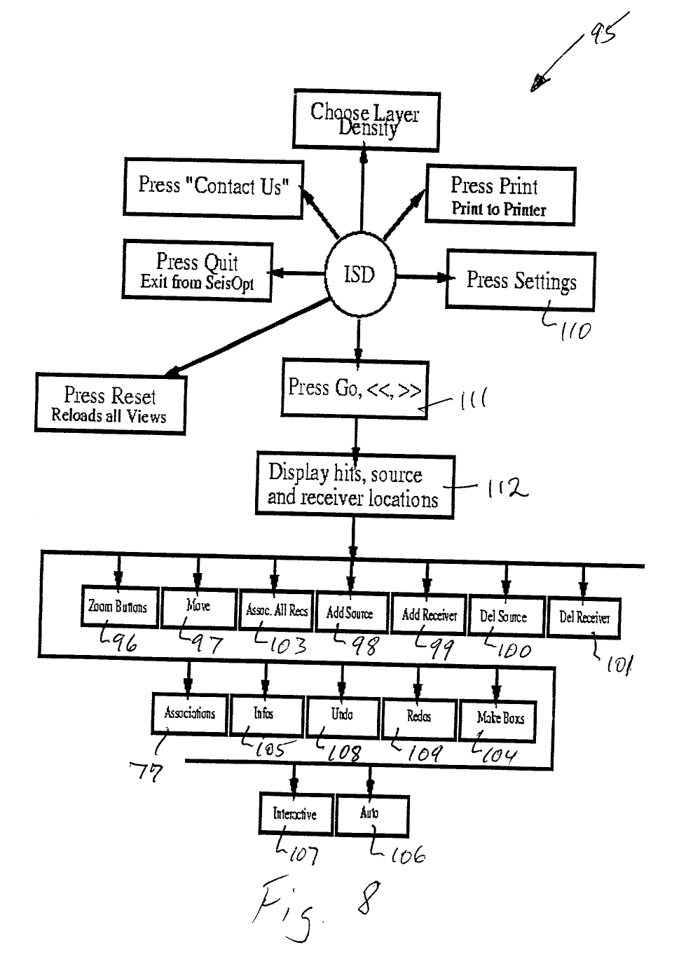

With reference now to FIG. 9, the input file structure of Riotsinput 41 contains the following parameters:

flag 117 to specify the data units (feet, km, or meters);

flag 118 to run the optimization with default or manual settings;

number of picks 119;

number of sources 120;

the source and receiver information (or coordinates) files 114, 115 respectively;

the pick times file 116;

the output file extension (default is the time stamp) 121; and

the pathname of the directory to write out the output files 122.

With reference again to FIGS. 2-4, the Riotsinput file 41 can be created either manually or using the RIOTS Settings button 60 in the IVG view 82 of RAVISH 44. One significant advance in version 2.0 (shown in FIG. 2) and version 2.5 (shown in FIG. 3) over the applicants' prior art version 1.0 is that RIOTS 42 and RAVISH 44 have been modified to enable the user to specify an extension and an output directory to write out the output files. This reduces the likelihood of undesired over-writing of output files and makes book keeping of output results much easier and more efficient.

With reference now to FIG. 10, RIOTS 42 operates by first reading in Riotsinput 60 and then reducing the source and receiver coordinates to model coordinates 122. This reduction step 122 involves finding the minimum horizontal (x) coordinate and the maximum elevation (z coordinate) of the input data. The minimum x-coordinate is then subtracted from the x-coordinates of all the sources and receivers. Similarly, the elevations of all the sources and receivers are subtracted from the maximum elevation.

Within SeisOpt®@2D (or SeisOpt®@Depth), the velocity models are represented as discrete square cells. The number of such cells in the horizontal (x) direction is given by the nx parameter; and the number of cells in the vertical (z) direction is (nz). The physical size of these cells is given by the parameter (h,) called the grid spacing. The term resolution is used to refer to the relative number of cells used to represent a given model. A low-resolution model would have a relatively low number of large cells, compared to a high-resolution model which would be comprised of a large number of small cells.

In SeisOpt®@2D, the resolution can be adjusted. In general, the factors that determine the appropriate resolution are the receiver spacing and the size of the target subsurface features. SeisOpt®@2D provides several preset resolutions that are based on the receiver spacing of the current data set. Optionally, SeisOpt®@2D or @Depth can be run with any resolution by adjusting the values of nx, nz, and h.

If SeisOpt®@2D or SeisOpt®@Depth are run with default resolution settings (autocal=0 in Riotsinput 41 in FIG. 9), the next part of the reduction step 122 is to determine nx, nz and h. The grid spacing is determined by first calculating the average source spacing and the average receiver spacing from the input source and receiver coordinates. The grid spacing is then a function of either the source or receiver spacing which ever is the smaller. Depending on the chosen resolution (lowest to highest) the h is determined by using the following formulae:

Highest=0.375 * m (source or receiver) spacing

High=0.5 * min (source or receiver) spacing

Med=1.0 * min (source or receiver) spacing

Low=2.5 * min (source or receiver) spacing

Lowest=4.0 * min (source or receiver) spacing

Next the maximum distance traversed by the array (from one end to the other) and the maximum source-receiver offset is calculated. Then, nx is:

nx=(integer)(maximum_distance/h)+4

and nz is:

nz=(integer)((maximum offset/h)*).33

The maximum z-coordinate (maxzRec) after reduction is then determined. This will be the receiver or source with the lowest elevation. This value is added on to the nz parameter determined above.

The nz is now, nz=nz+(integer)(maxzRec/h). nz is preset to be no lower than 8. If the user runs the optimization with manual settings (autocal=1), RIOTS reads in the specified values of nx, nz, and h.

The next part of the reduction step 122 is to shift the sources and receivers in the horizontal direction by a factor of h, the grid spacing. During this stage, the maximum number of receivers per each source is also determined. This is used when writing out, as shown in FIGS. 2, 3 and 7, the Pickfile 54 for visualization using the MG 90 (FIG. 7) view of RAVISH 44.

The next step 123 is to determine the unique sources and receivers and sort them in increasing order of horizontal (x) distance. The number of unique sources and receivers are used for Surveyfile 70 file, which, in turn, is used by, as also shown in FIGS. 2 and 3, RISD 46. The sorting is done using an indexing and ranking algorithm disclosed at page 338 of Press W. H., Teukolsky, S. A., Vetterling, W. T., Flannery, B. P., Numerical Recipes in C, The art of scientific computing, Cambridge University Press, Cambridge (2d ed.1992). After sorting, an interpolation finds the elevation at each grid point using a cubic spline interpolation algorithm as disclosed at page 113 of the same reference: Numerical Recipes in C. The interpolated elevations are then used to plot the elevation profile on, as also shown in FIGS. 2-3, both the encapsulated PostScript (EPS) images created using MakeEPS 48 and during the visualization of models using RAVISH GUI 44.

The next step is to run the optimization algorithm, shown in FIG. 10 as the determination of an annealing schedule 124 followed by performing the optimization 125. An improvement in the applicants version 2.0 over prior art version 1.0, is the modification of RIOTS 42 to estimate the run time of the optimization during the optimization step 125 and report the estimation on the RAVISH GUI 44. This is done by taking the difference between the time (obtained by using the time command in C libraries #include <time.h>) at the start of RIOTS 42 and the time after 30 algorithm iterations.

A typical optimization loop (iteration) consists of the following steps:

1. Choose initial model

2. Create new model

3. Evaluate the Objective function

4. Accept or reject the new model based on the optimization method

5. Repeat steps 2 to 4 until the convergence criterion is satisfied.

In RIOTS 42 and XIOTS 49, the starting model is a homogeneous velocity field and an iteration step involves perturbing the initial homogeneous model, smoothing it by averaging the four adjacent side-on cells, computing travel times through the model, and evaluating the objective function. This starting model is created by randomly choosing a rectangular area in the velocity model and assigning it a random uniform velocity between the following values, depending on the units:

If (units=feet)->maxvel=25000 ft/s, minvel=200 ft/s

If (units=meters)->maxvel=7900 m/s, minvel=100 m/s

If (untis=km)->maxvel=7.9 km/s, minvel=0.1 km/s

The above-noted prior art Pullammanappallil and Louie reference describes this process in detail.

The perturbed model is then smoothed using an averaging method as follows:

1. The four corner cells are the average of the 2 side-on adjacent cells.

2. The cells along the four sides are the average of the 3 side-on adjacent cells.

3. The cells in the interior of the model are the average of the 4 side-on adjacent cells.

4. The averaging a filter scans the model and makes sure that the velocity contrast is not greater than 250% anywhere within the velocity model.

RIOTS and XIOTS use a finite-difference solution to the eikonal equation to compute travel times at each point the subsurface. See Vidale, J. E., Finite difference calculation of travel times, Bulletin of the Seismological Society of America, 78, 2062-2076 (1988); Vidale, J. E., Finite difference calculation of traveltmes in three dimensions, Geophysics, 55, 521-526 (1990). Any desired means to compute these times can be employed, however. The finite difference code can be replaced with any non regular grid based ray tracing method (see, e.g., Zelt, C. A., and Ellis, R. A., Practical and efficient ray tracing in two-dimensional media for rapid traveltime and amplitdue forward modelling, Canadian Journal of Exploration Geophysics, 24, 16-31 (1988) or any other grid based method that computes first arrivals through a velocity model (e.g., Qin, F., Luo, Y., Olsen, K. B., Cai, W., Schuster, G. T., Finite-difference solution of the eikonal equation along expanding wavefronts, Geophysics, 57, 478-487 (1992); Podvin, P. and Lecomte, I., Finite difference computation of traveltimes in very contrasted velocity models: a massively parallel approach and its associated tools, Geophysical Journal International, 105, 271-284).

The finite difference scheme involves the following steps (Vidale, supra):

Initialize all points in the velocity model.

Time points near the source with straight rays. The distance (number of cells) for the straight calculation can be set by the user; it is pre-determined in the code.

Set pointers (in C) to next concentric box (cells) and count boxes.

Extrapolate travel times to the next row or column.

Perform recursive correction back into the interior of the model to improve the accuracy the computed travel times, if necessary. Recursion stops if change in times is less than 10% of grid-spacing multiplied by the slowness (inverse velocity).

Expand the travel time computation box.

Continue until travel times to all points in the model have been calculated.

The SA optimization 125 next uses a plane-wave extrapolation method to compute the values of times at receivers not on the grid points. This allows computing times in models that have topography. This extrapolation algorithm is as follows:

Determine the grid location closest to the receiver coordinate:

ix0=(integer)(x-coord/h); iz0=(integer)(z-coord/h);

Get the time at the adjacent nodes:

it0=iz0*nx+ix0; it1=it0+1; it2=it0+nx;it3=it2+1;

t0=times[it0]; t1=times[it1]; t2=times[it2]; t3=times[it3];

Calculate the distance from the receiver coordinate to the closest grid point:

dx=(x−ixO*h); dz=(z−iz0*h);

Calculate the time to the receiver based on the direction of the wave:

If upper-left:
if(t0 < t1 && t0 < t2 && t0 < t3)
{
p = (t1 − t0) / h;
eta =(t2 − t0) / h;
*ex_time = t0 + p*dx + eta*dz;
}
If upper-right:
if(t1 < t0 && t1 < t2 && t1 < t3)
{
p = (t0 − t1) / h;
eta = (t3 − t1) / h;
*ex_time = t1 + p* (h−dx) + eta*dz;
}
If lower-left:
if(t2 < t1 && t2 < t0 && t2 < t3)
{
p = (t3 − t2) / h;
eta = (t0 − t2) / h;
*ex_time = t2 + p*dx + eta* (h − dz);
}
If lower-right:
if(t3 < t1 && t3 < t2 && t3 < t0)
{
p = (t2 − t3) / h;
eta = (t1 − t3) / h;
*ex_time = t3 + p* (h − dx) + eta* (h − dz);
}

Then, the optimization algorithm 125 of RIOTS 42 (or XIOTS 49) strips the time at each receiver coordinate, and this will be the calculated first arrival time.

The objective function is the RMS error between the calculated data and the input data (see the above-noted prior art Pullammanappallil and Louie reference), as follows.

Error=(Σ(calculated picks−observed picks))/(number of picks)

Depending on the optimization scheme employed new models are accepted and/or rejected based on the RMS error.

The optimization algorithm 125 of RIOTS 42 and XIOTS 49 preferably uses a nonlinear optimization technique to determine the subsurface velocity structure from the input seismic data. Most preferably, this optimization algorithm 125 is a generalized simulated annealing (SA) algorithm for predicting the subsurface velocity structure. Any optimization scheme (for example, one based on a genetic algorithm as described within or a hybrid SA and GA, or a combined linear and SA or GA) can be used instead. The optimization algorithm 125 is essentially a plug-in feature, that is, any optimization or any hybrid-optimization scheme can be used instead of SA within RIOTS 42 and XIOTS 49.

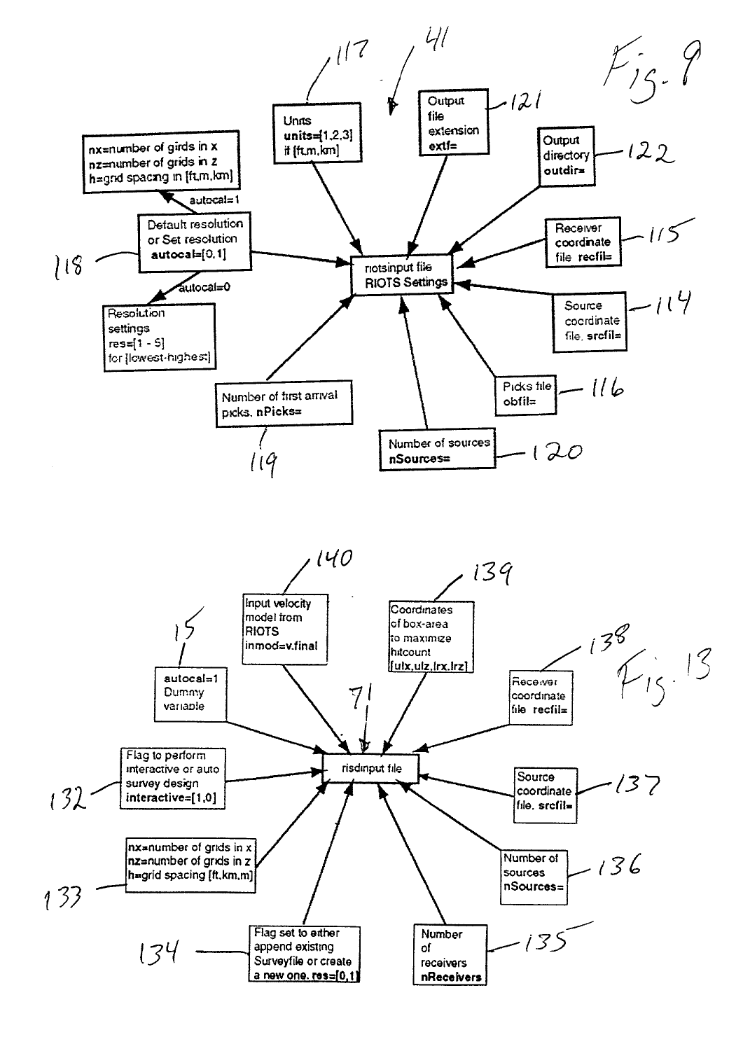

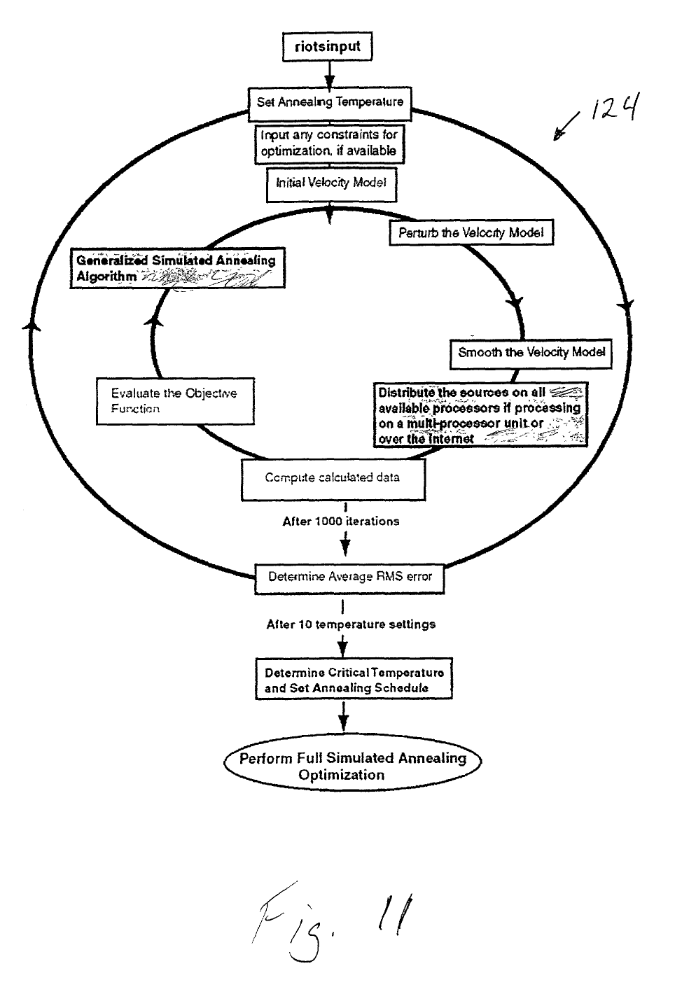

As noted above, the preferred SA optimization 124, 125 is based on the method described in the above-noted 1994 Pullammanappallil and Louie reference. This method, 124, 125 has two stages: first, the determination of the “annealing schedule” 124 (shown in greater detail in FIG. 11); and second, performance of the full optimization 125 (shown in greater detail in FIG. 12).

With reference to FIGS. 11 and 12, the shaded boxes indicate the optimizer plug-in feature. Any nonlinear optimization method or a combined nonlinear-linear optimization method can be substituted for SA in these boxes. Both the annealing procedure 124 and the full optimization method 125 are described in detail in the 1994 Pullammanappallil and Louie prior art reference, which is incorporated herein by reference.

As explained in the 1994 Pullammanappallil and Louie reference, in the generalized SA, if the RMS error is less than for the model in the previous iteration, the perturbed model is accepted. If it is more, the velocity model is conditionally accepted based on a probability criterion. It is this feature of the optimization scheme that allows the method to find the global minimum (true solution) by avoiding local minimums (incorrect solutions).

With reference to FIG. 12, if no new models are accepted after 30,000 iterations the optimization stops.

As noted above, one significant advantage of using SeisOpt@2D version 2.0 and SeisOpt @Depth version 1.0 is the robust model run time estimator. This technique culls models with RMS error very close to the global minimum and averages them to produce the final optimized model. The number of models used in the averaging is dependent on the number of iterations taken for the full optimization to converge.

If (number of iterations <= 15000)

{ number of averaged models = 2}

else if (number of iterations<= 50000)

{ number of averaged models = 3}

else if (number of iterations <= 110000)

{ number of averaged models = 5;

}else if (number of iterations <= 150000)

{ number of averaged models = 10;
}else if (number of iterations > 150000)

{ number of averaged models = 15; }

In the event that another nonlinear optimization schemes is substituted for the SA optimization 124, 125 of FIGS. 11 and 12, the can, if suitable, be run on multiple processors, either cluster computers or networked machines. In the disclosed SA 124, 125, this can be achieved by distributing the calculation of times from each source, using the finite difference scheme, to different machines (or nodes). Since a GA can lend itself to being parallelized as noted below, the optimization itself can be parallelized, leading to a faster run time.

Another novel feature of SeisOpt@2D and @Depth is the implementation of constrained optimization. This allows the user to enter a priori constraints like well data or prior knowledge of velocities and thus run the optimization faster (limiting the model space to be searched). This also provides more robust results since the model space is better constrained. As shown in FIGS. 3 and 4, the TuneGraph or SeisOpt Tuner 43 view of the RAVISH GUI 44 will be used to input these constraints.

In addition to constraining the velocities, the optimization can be constrained by modifying the objective function to optimize more information contained in the seismic data. For example, the user can include reflection travel time picks (see Pullammanappallil and Louie, Inversion of seismic reflection traveltimes using a nonlinear optimization scheme, Geophysics, 58, 1607-1620 (1993)) and/or use the coherency measure of the reflection phases as a constraint (see Pullammanappallil, S. K., and Louie, J. N., A combined first-arrival travel time and reflection coherency optimization approach to velocity estimation, Geophysical Research Letters, 24, 511-514 (1997), incorporated herein by reference).

With reference now to FIG. 12, to increase the accuracy of the optimized solutions, the optimization preferably runs multiple (most preferably, two to four) times, each time with different model parameter settings. In this novel fashion 126, bearing the “O³” processing trademark, the optimization process 125 provides a better model with the click of a button on the RAVISH GUI 44 as shown in FIGS. 2, 3 and 4.

The “hit count” 127 refers to the number of times a cell in the velocity is sampled by a seismic ray traveling from the source to the receiver. Versions 2.0 (shown in FIG. 2), 2.5 (FIG. 3), and the XIOTS implementation (FIG. 4) implement a novel hit count computation technique 127 which is much faster and much more accurate than the method used to calculate hit count in version 1.0. The version 1.0 prior art embodiment used the concept of Fermat's principle to calculate the hit counts (see the prior art 1994 Pullammanappallil and Louie reference). In the FIG. 2-4 embodiments, however, ray paths are found by following the gradient of the travel-time field from the receiver back to the source. The gradient is evaluated using times in adjacent cells to ensure that refraction paths are followed as they are defined by discontinuities in the travel-time field. This gradient evaluation method tends to correct initial direction errors (that are maximum at large time gradient discontinuities) more quickly than more local schemes. When refractions are encountered, the velocity array is checked so that the refracted paths are assigned to the faster cells along the interface. Each time a cell is sampled, a hit count is assigned to it. The cumulative hit count is thus calculated for each source-receiver pair and for all the sources and receivers. Finally, the hit-count technique 127 zero's out all velocities in the model that are below the envelope of the hit count image (i.e., the deepest penetrating ray path).

With reference back to FIG. 10, after the optimization step, RIOTS 42 (or XIOTS 49) outputs the results 128. As shown in FIGS. 2-4, the files with the root name Velfile 50, Hitfile 52, Pickfile 54, Errorfile 56, and Surveyfile 58 can be visualized using the IVG 82, MG 90, LG 17, and ISD 95 views of the RAVISH GUI of FIGS. 2-5. Also, as shown in FIGS. 2-4, the ASCII files containing the velocity and hit count values (Velvalues 66 and Hitvalues 68 files) can be output and then imported into a contouring program like Surfer and printed out. As shown in FIG. 10, the files Velplot and Hitplot and the control file, Plotinput, 130 are output for use by the MakeEPS module 48 to create report quality EPS images. The output file v.final 131 contains the full velocity model (before zeroing out of velocities). This file, along with Risdinput 71, is used by RISD 46 (FIGS. 2-4) during the virtual survey design. This v.final file 130 is also used by SeisOpt Tuner (FIGS. 3-4) to fine-tune or create velocity models.

Also, with reference to FIGS. 2-4, a novel module called PickExport 69 accesses and converts the Pickfiles produced by RIOTS into an 3-column ASCII file that can be imported into spreadsheet programs like Excel for further view, editing, and plotting. All output files can have an extension specified by the user (the default extension is a time stamp) and can be written to a specified output directory.

As noted above with reference to FIGS. 2-4, the RISD 46 or the XISD 53 modules allow the user to virtually manipulate the seismic array and visualize how the manipulation affects the subsurface sampling. Thus, the user can determine if and how well the desired target in the subsurface is being sampled by the deployed array. RISD 46 uses the risdinput file 71 and v.final file 131 produced by RIOTS 42, as shown in FIG. 10, and the ISD view of the RAVISH GUI 95 (FIG. 5) to perform the survey design.

With reference now to FIG. 13, the format of the Risdinput file 71 includes, first, two flags, one a dummy 15 and another 132 to distinguish between manual and interactive mode. The next 3 lines 133 are the model dimensions and cell size, nx, nz, and h. Following this is a flag 134 for determining whether of not to use an existing Surveyfile, or create a new one. Next are the receiver coordinates 138, the number of receivers 135, the number of sources 136, and the name of the source coordinate file 137 containing the source coordinates. (The srcfil named in 137 and recfil named in 138 also used by RIOTS (42 in FIGS. 2-3.) Next are four lines containing the coordinates 139 of the rectangular region in the model selected for coverage optimization, if any (automatic mode only). Last is the file name 140, v.final, of the velocity model to be used for the ray tracing. This file is produced by RIOTS 42 and is usually one from a previous run of RIOTS 42.

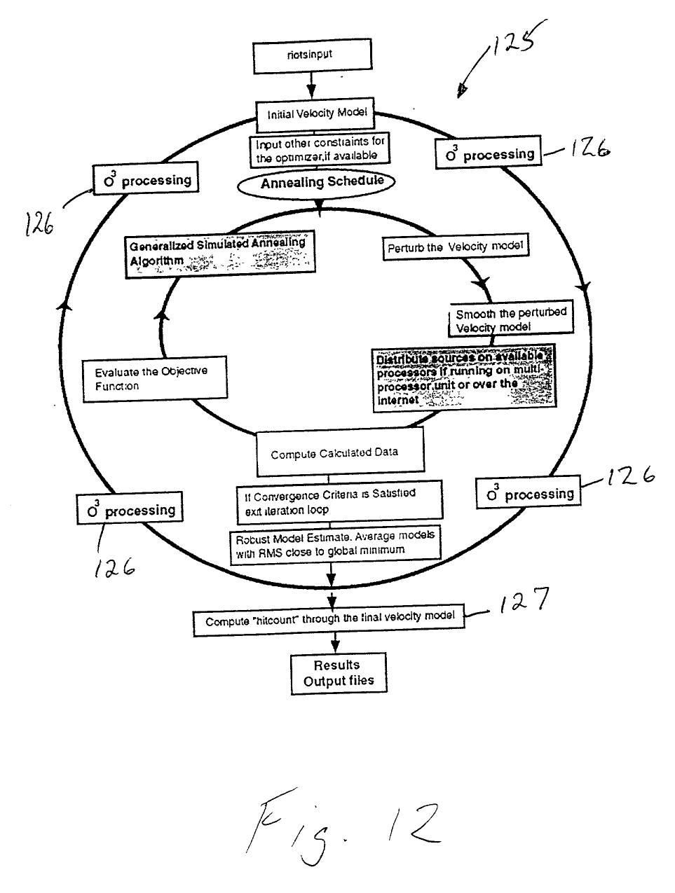

With reference now to FIG. 14, the RISD process 46 (see FIGS. 2-3; and the XISD process 53 of FIG. 4) is as follows:

1. read 141 in Risdinput 71;

2. convert coordinates to model coordinates 142 (see 122 in FIG. 10);

3. analyze and sort receivers and sources 143 (see 123 in FIG. 10);

4. perform the survey design operation manually 144 or automatically 145; and

5. output the results 146, and visualize or print results.

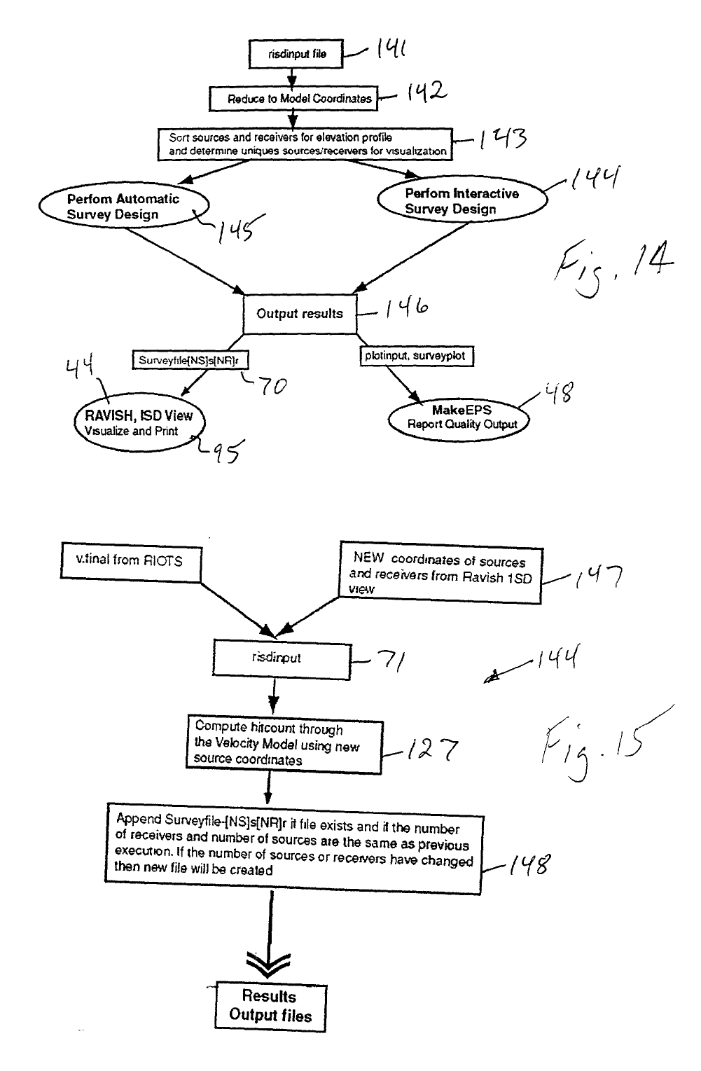

In the output results step 146, a visualization file is created named Surveyfile-[Ns]s[Nr]r 70 (see also FIGS. 2-3), where the [Ns] and [Nr] are the number of sources and receivers respectively. Optionally, the displayed file can be printed by clicking, as shown in FIGS. 2-4, the “Print” button 63 on the RAVISH GUI 44 or its ISD view 95 and the EPS image files 75 can be generated using the MakeEPS module 48. Two modes of survey design operations (step 4 above) are thus provided by RISD 46: interactive 144 and automatic 145 (see FIGS. 15 and 16 respectively).

With reference now to FIG. 15, the interactive mode 144 (interactive=1 in Risdinput 71), the seismic survey geometry (locations of sources and receivers) is manually altered 147 by the user with the, as shown in FIG. 5, ISD view 95 of the RAVISH GUI buttons and/or the mouse, for the purpose of visualizing the ray coverage (hit count image) of the current survey settings. No optimization is done and only the subsurface ray coverage is calculated by invoking the “calculate hit count” function of RIOTS (see 127 in FIG. 12). The output file generated 148 by the interactive mode 144 is Surveyfile-[Ns]s[Nr]r 70 (see FIGS. 2-4) where [Ns] is the number of sources and [Nr] is the number of receivers. A new such file 70 is created if the number of sources and receivers is altered, compared to the previous run of RISD (46 in FIGS. 2-3). If the number of sources and receivers remain the same, the existing Surveyfile 70 is appended.

With reference now to FIG. 16, in the automatic mode 145 of FIG. 14, regions of the subsurface are selected by drawing a box using the mouse, and the survey geometry is optimized to provide the highest amount of ray coverage in the selected regions. The optimization uses a generalized simulated annealing optimization method to maximize the hit count as disclosed in the prior art 1997 Pullammanappallil and Louie reference, incorporated herein by reference. The optimization sequence in this automatic mode 145 is similar to that used in RIOTS for the velocity optimization 124, 125 in FIGS. 11 and 12. The first step is to calculate the annealing schedule 149. Next is the optimization loop 150, which is repeated until the solution converges. Within this loop 150, the source coordinates are perturbed 151, then the hit count is computed 152 for the whole model and then for the selected region of the model, and finally the hit count maximized using SA 153. Once the algorithm has converged 154, the final hit count is output 155 to Surveyfile 70.

With reference now to FIG. 24, the MakeEPS module 48 enables the user to generate report quality output files in encapsulated PostScript files. The images created by MakeEPS are in text format, which lends them to be easily manipulated. They can be imported into commercially available drawing programs like Adobe Illustratorm and CorelDraw^{SM} for further manipulation. Users can also download a free public-domain software called ghostview, available at www.cs.wisc.edu/˜ghost/.

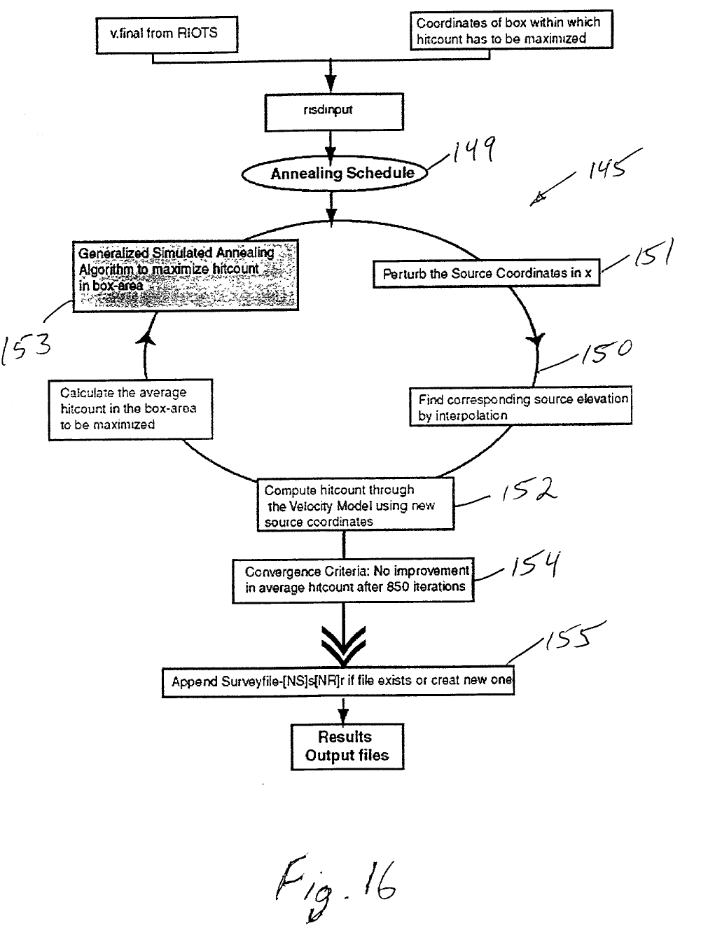

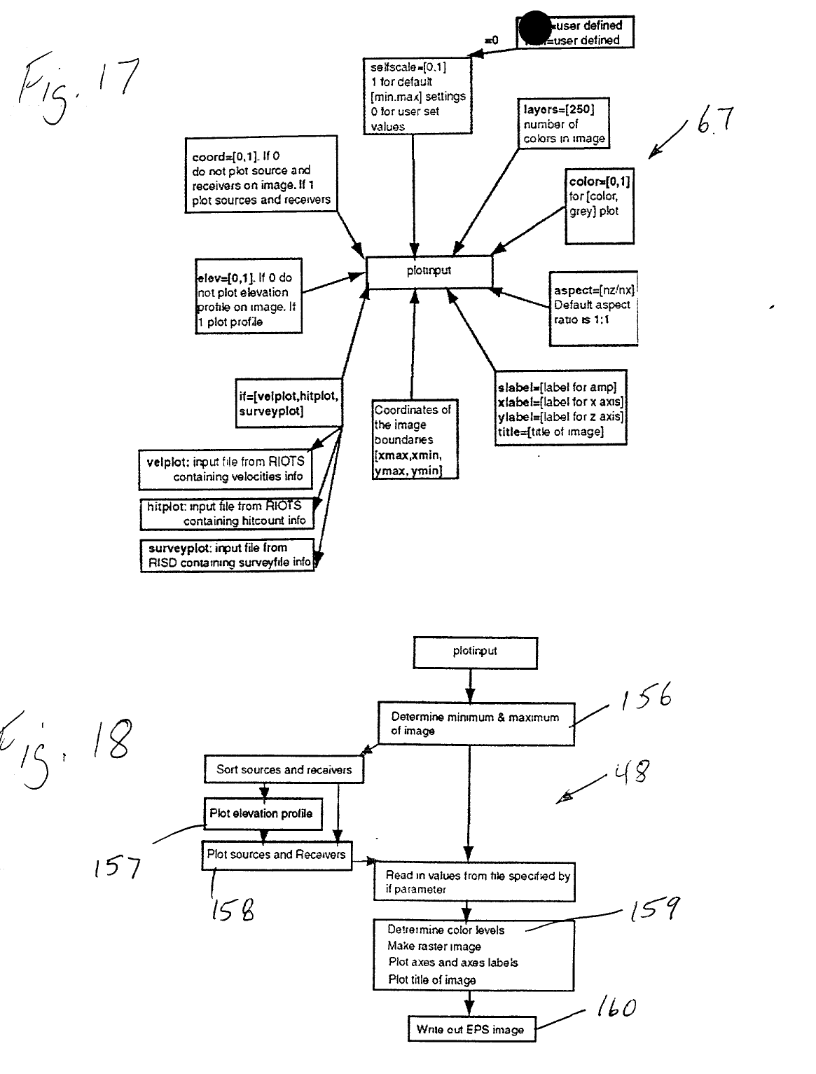

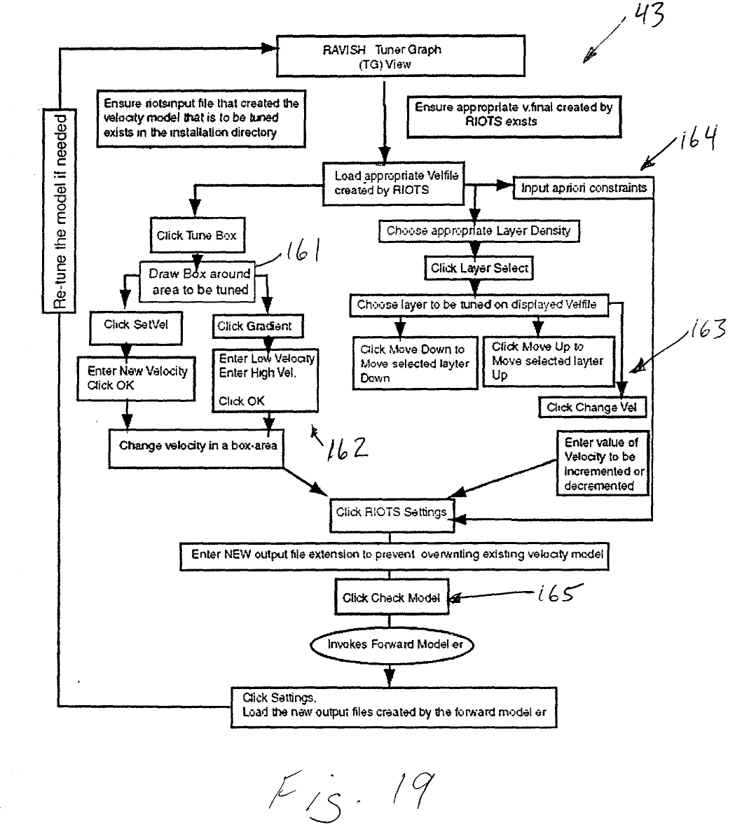

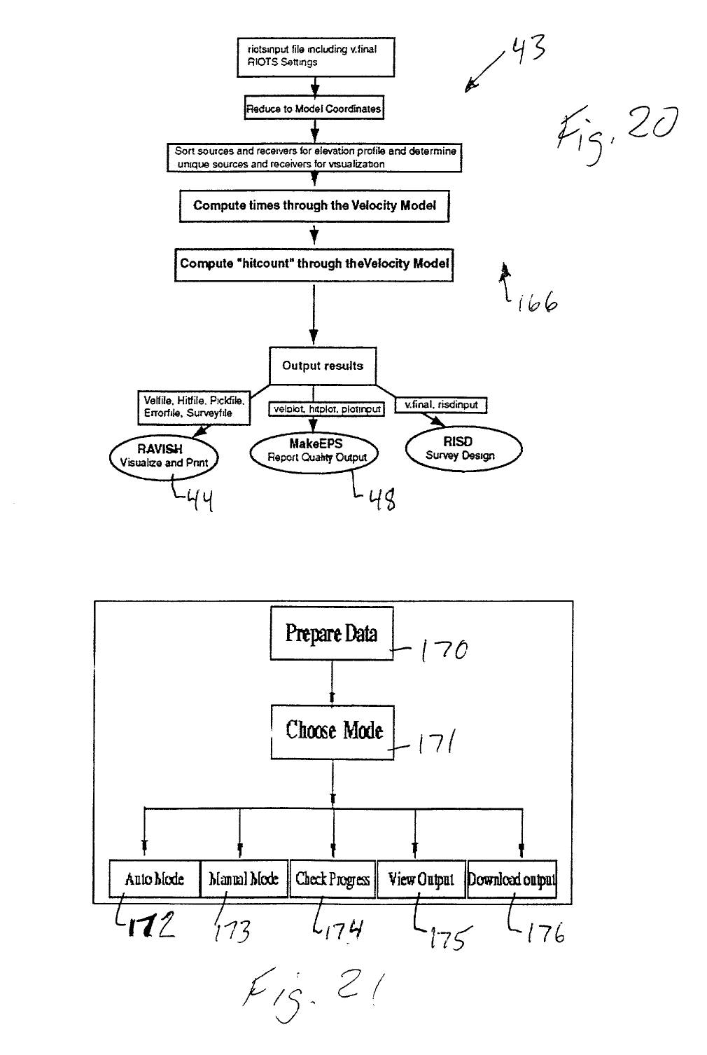

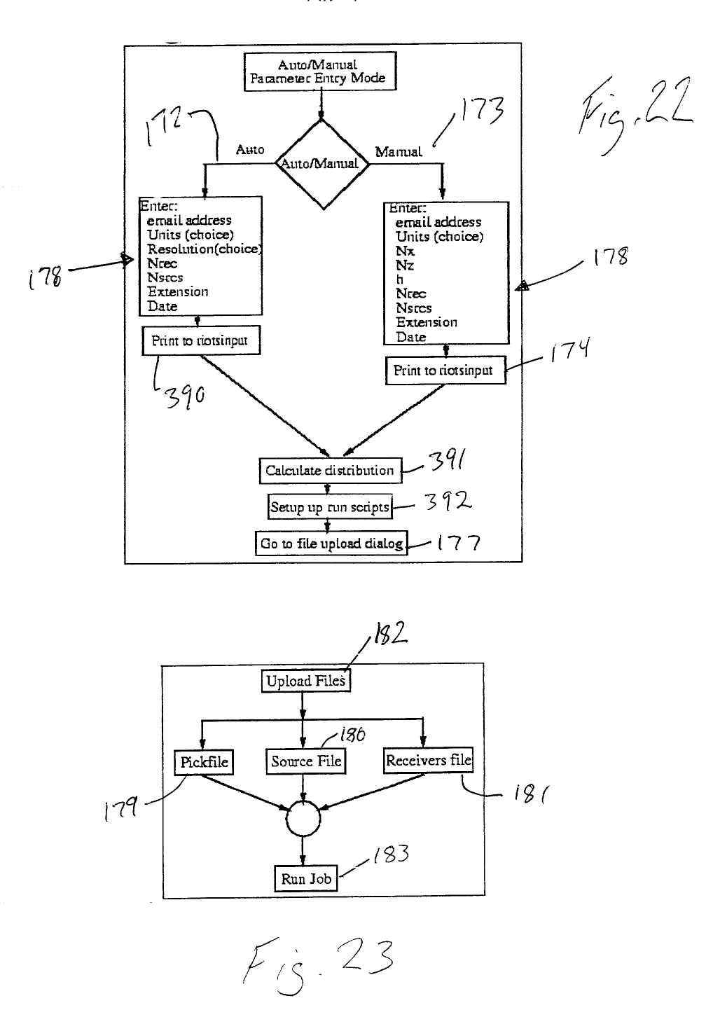

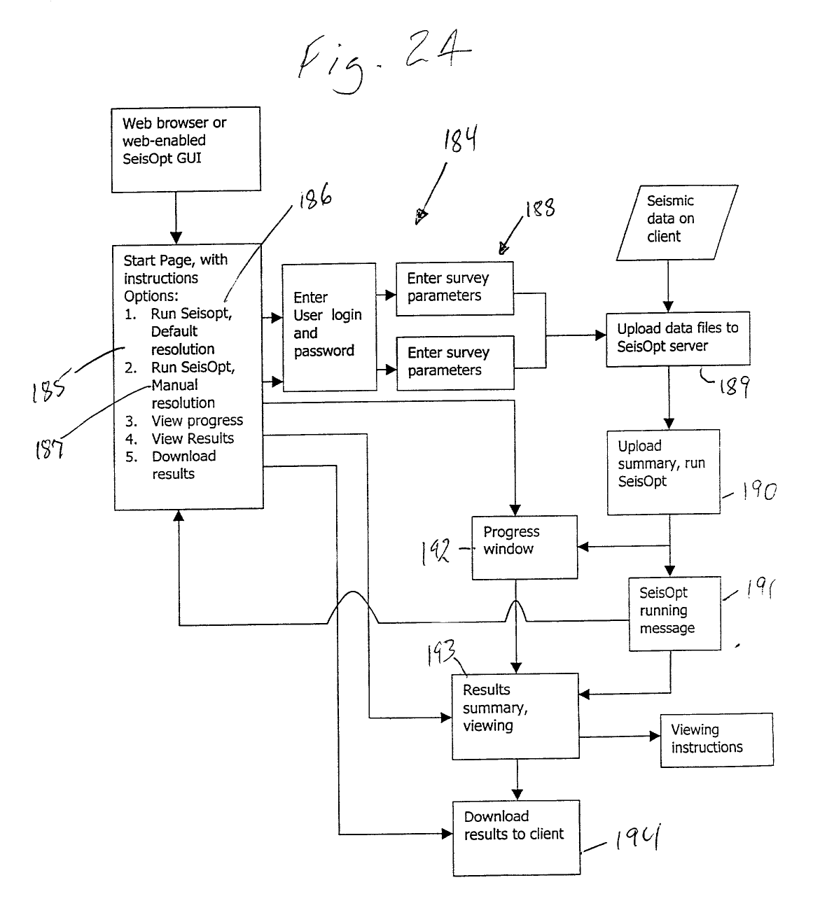

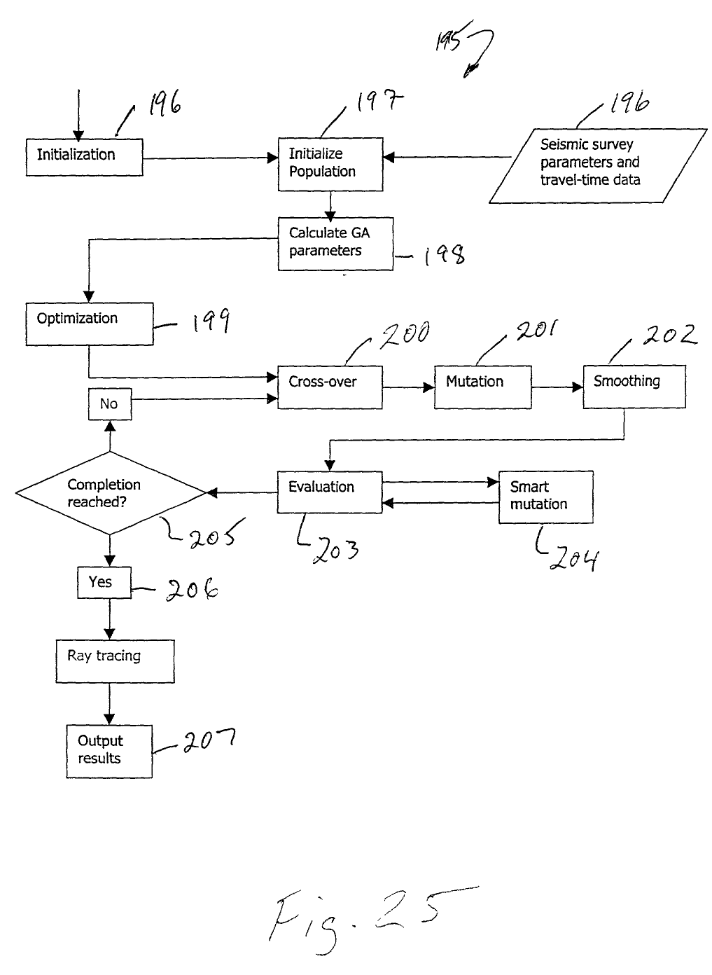

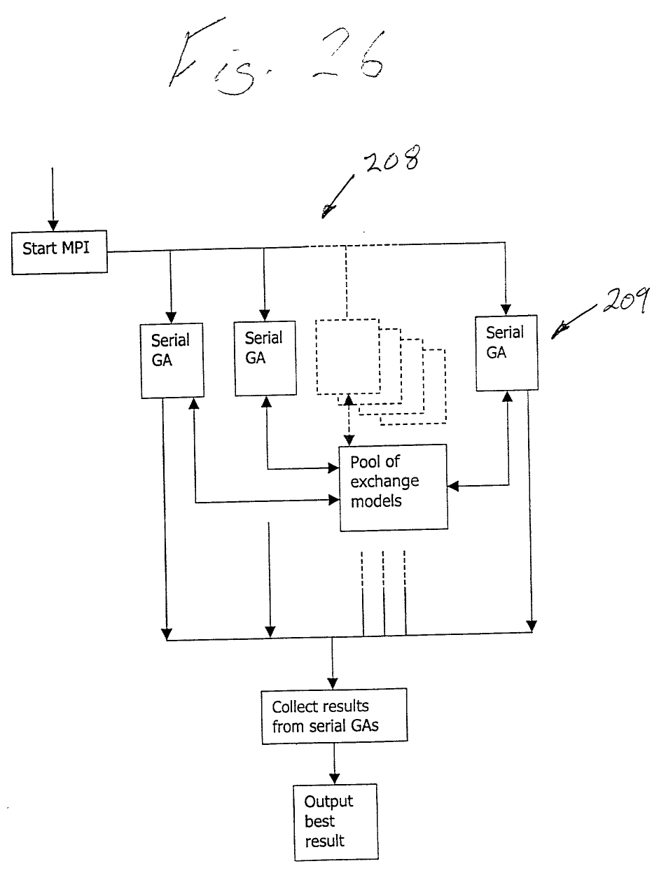

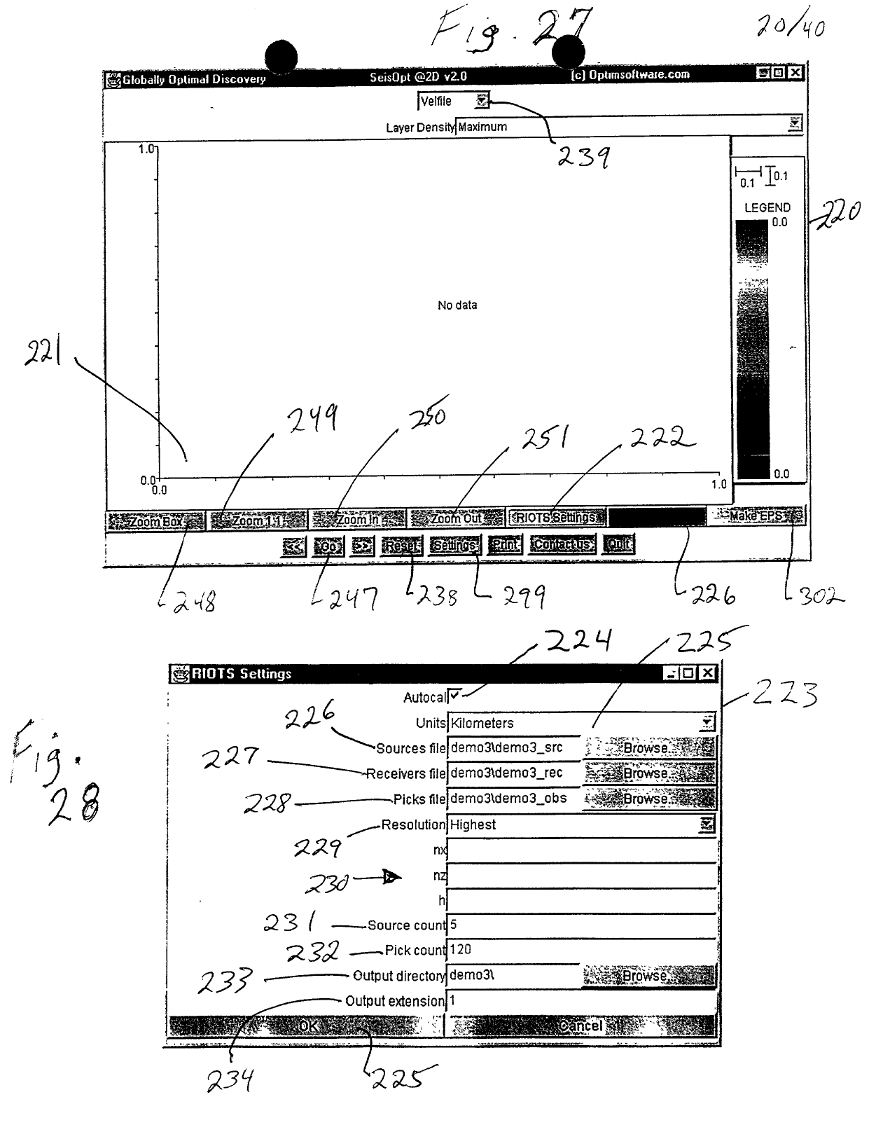

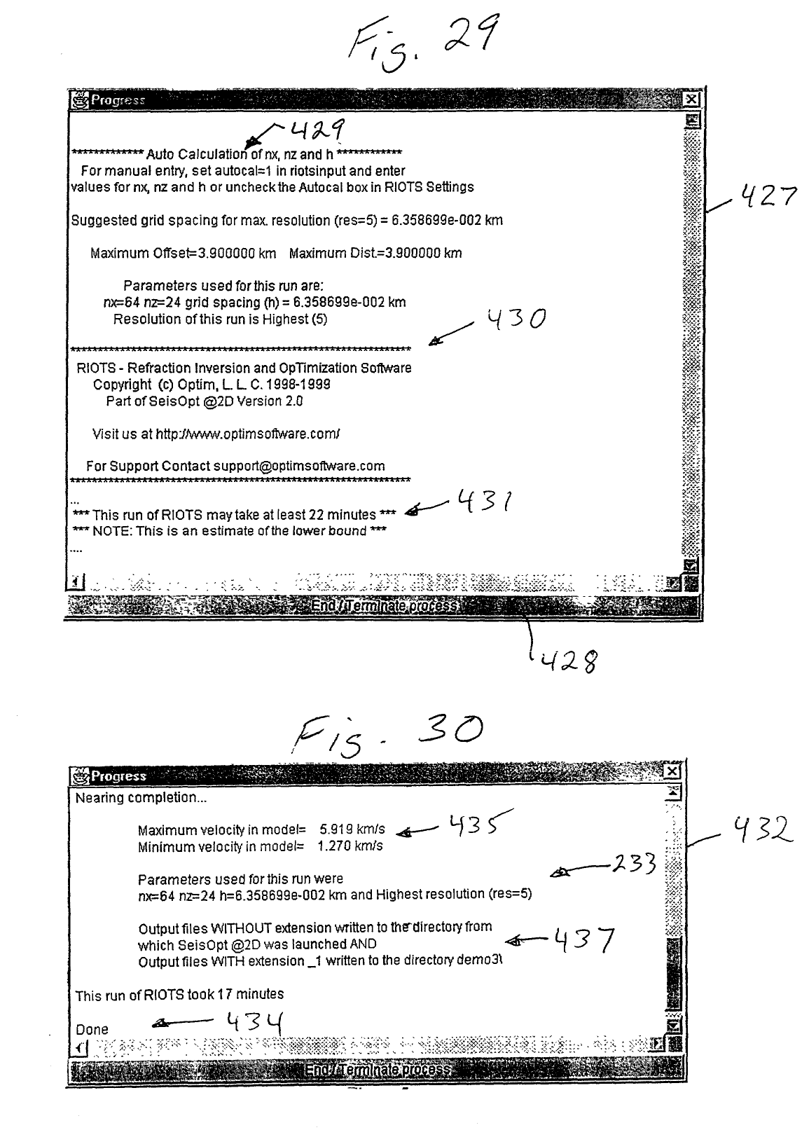

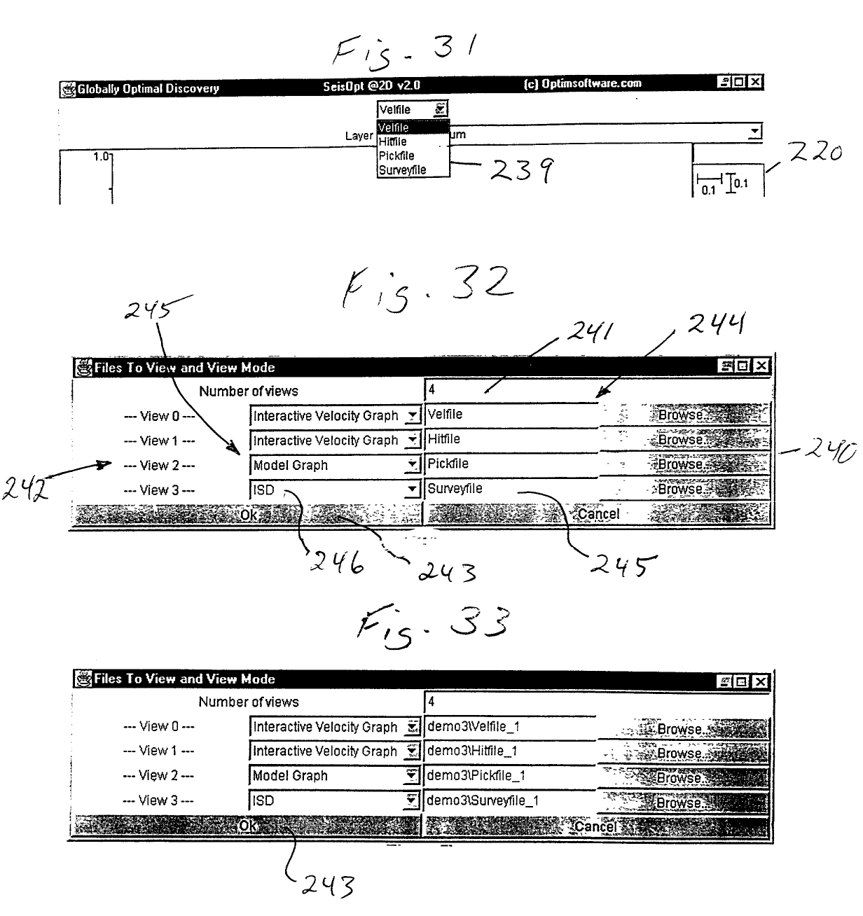

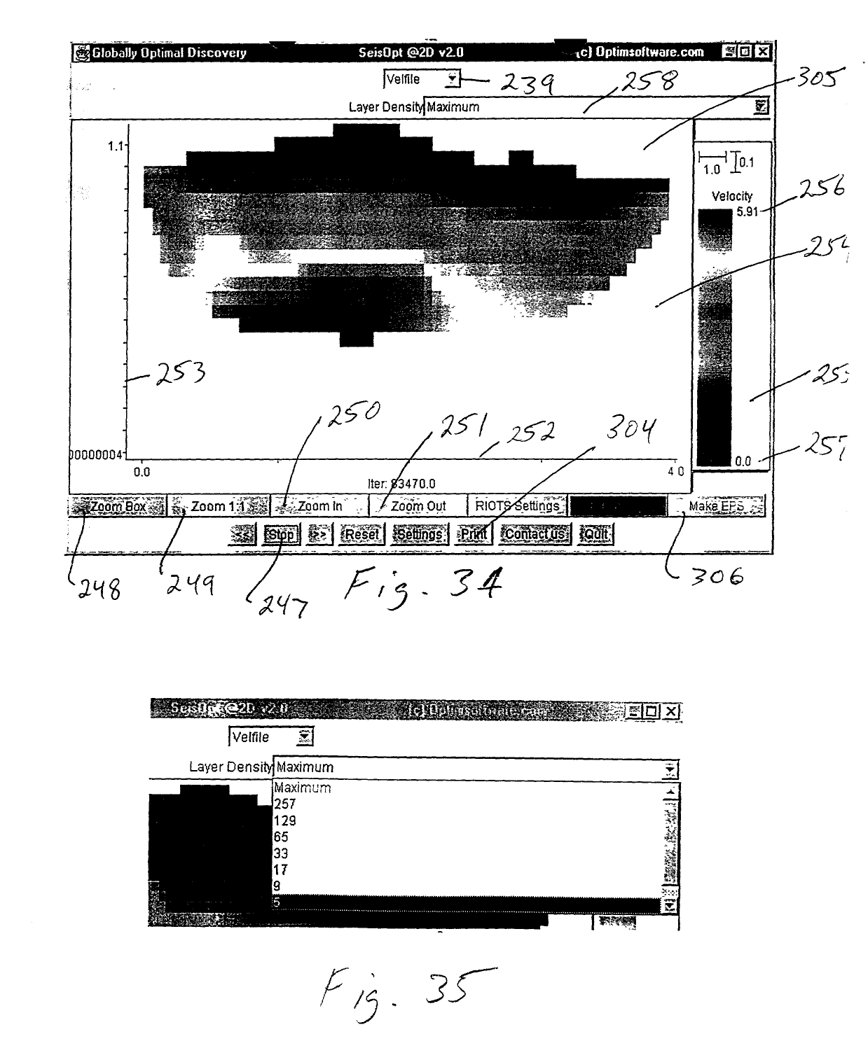

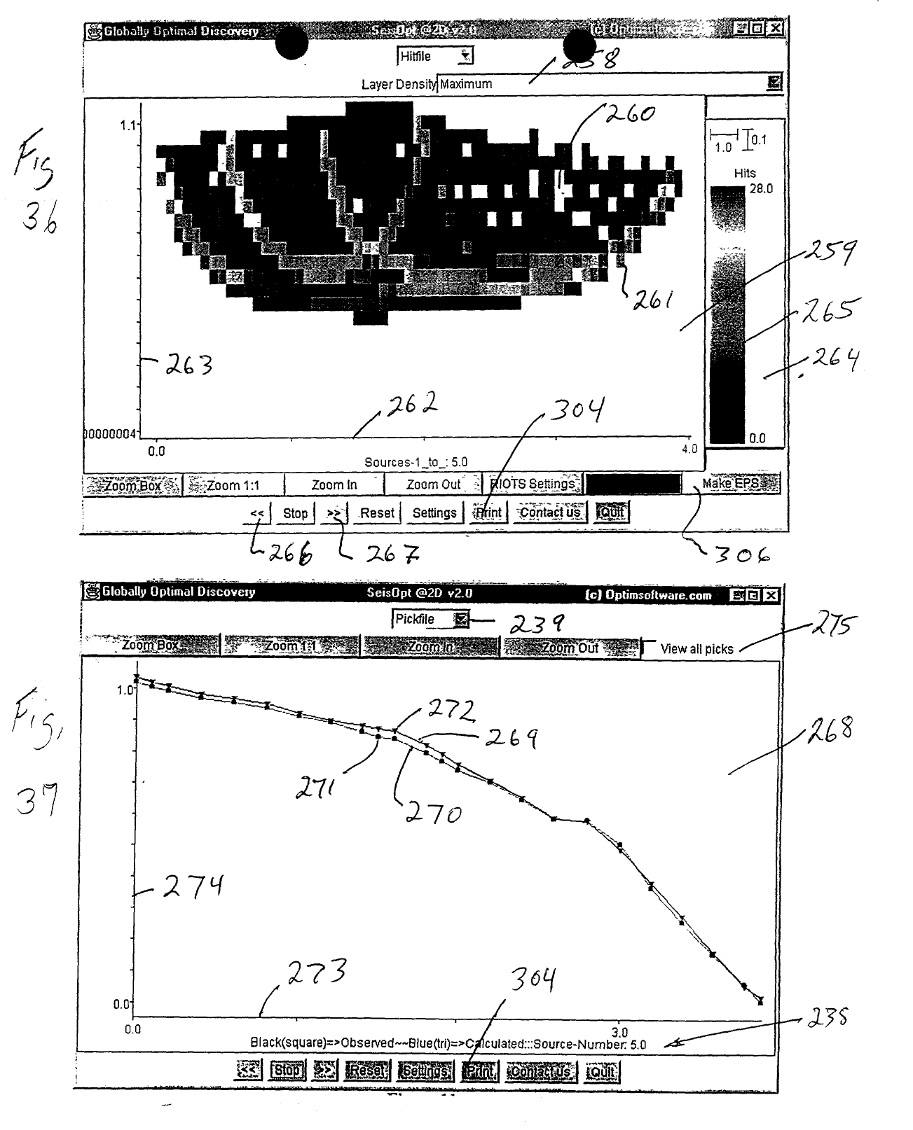

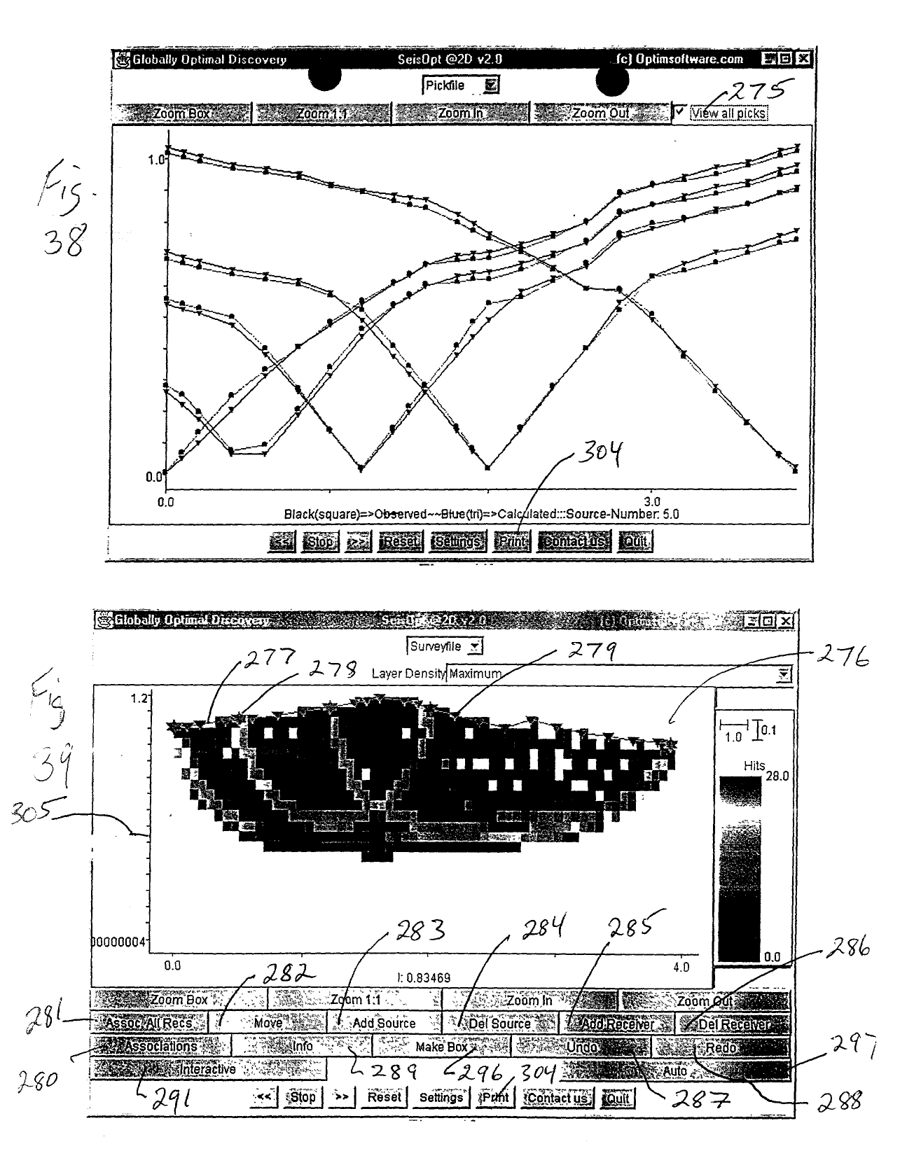

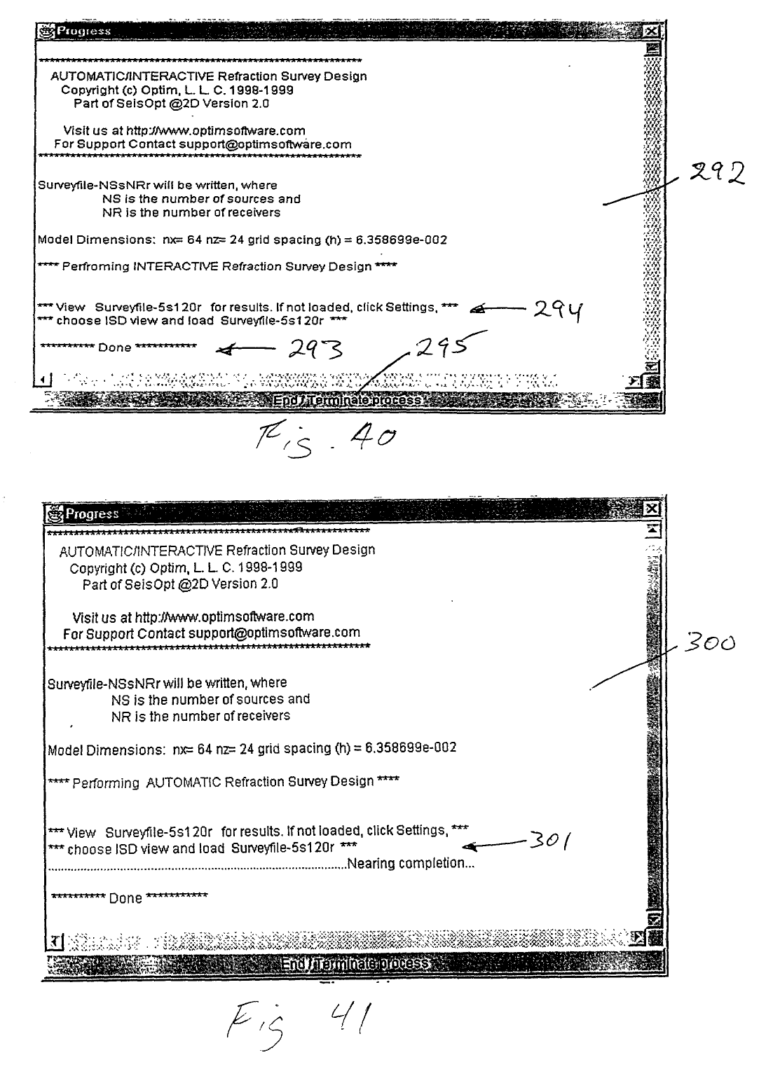

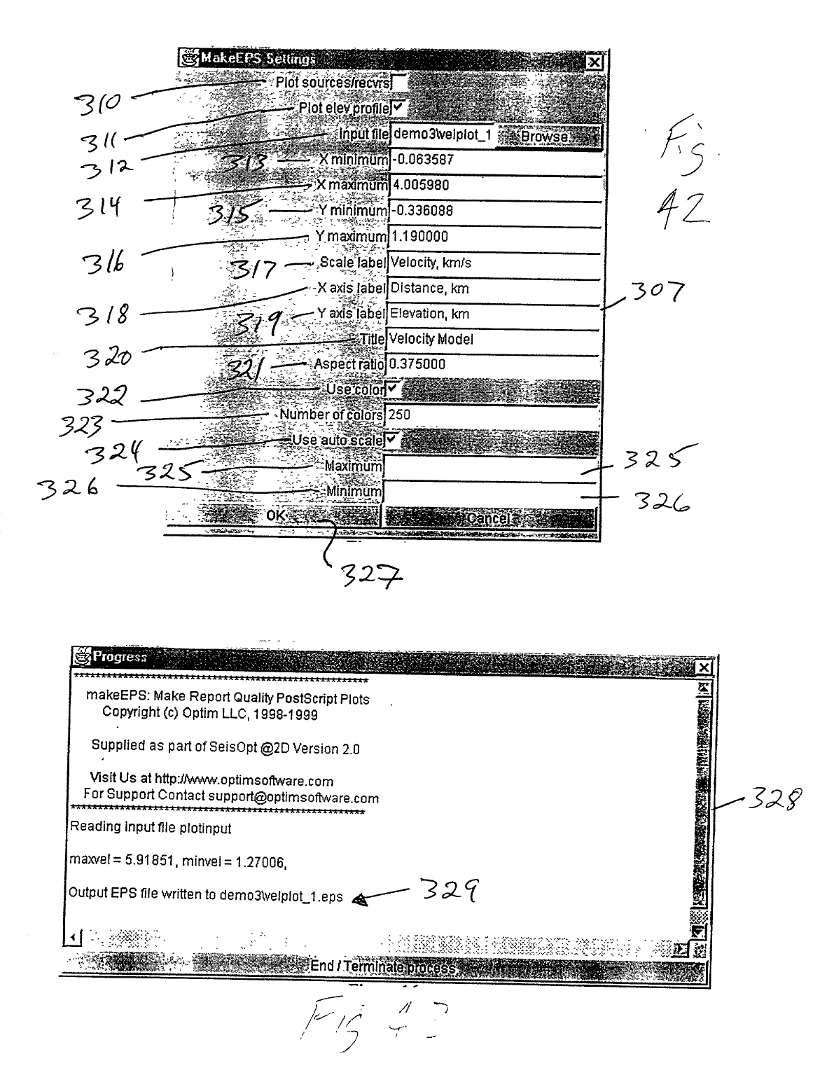

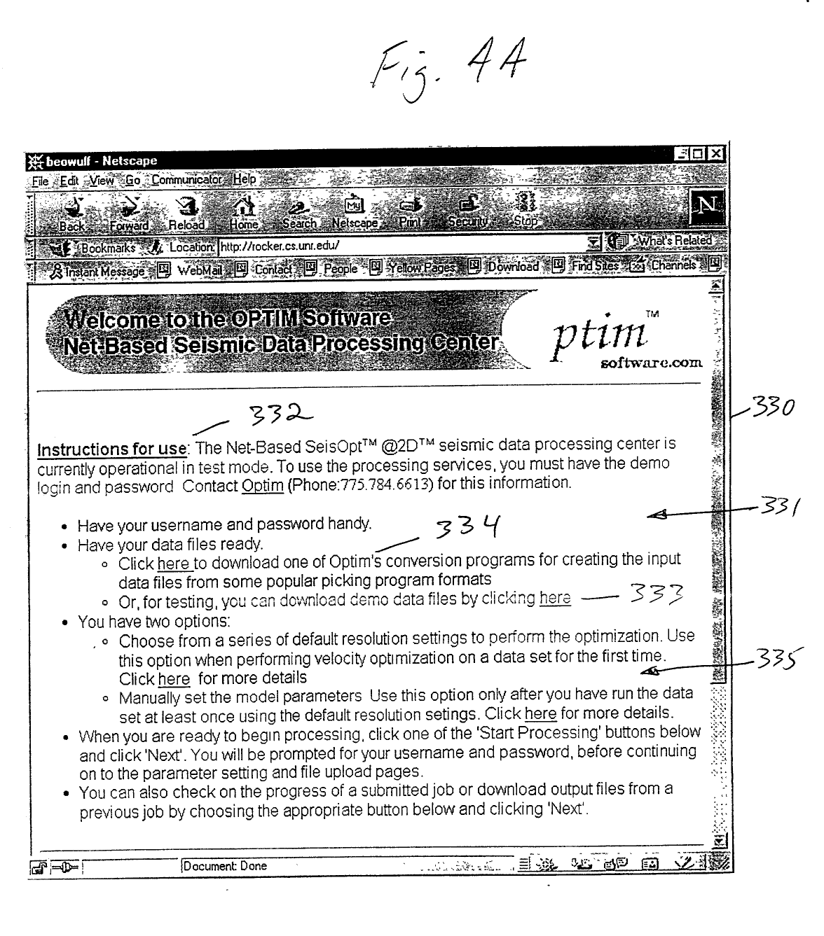

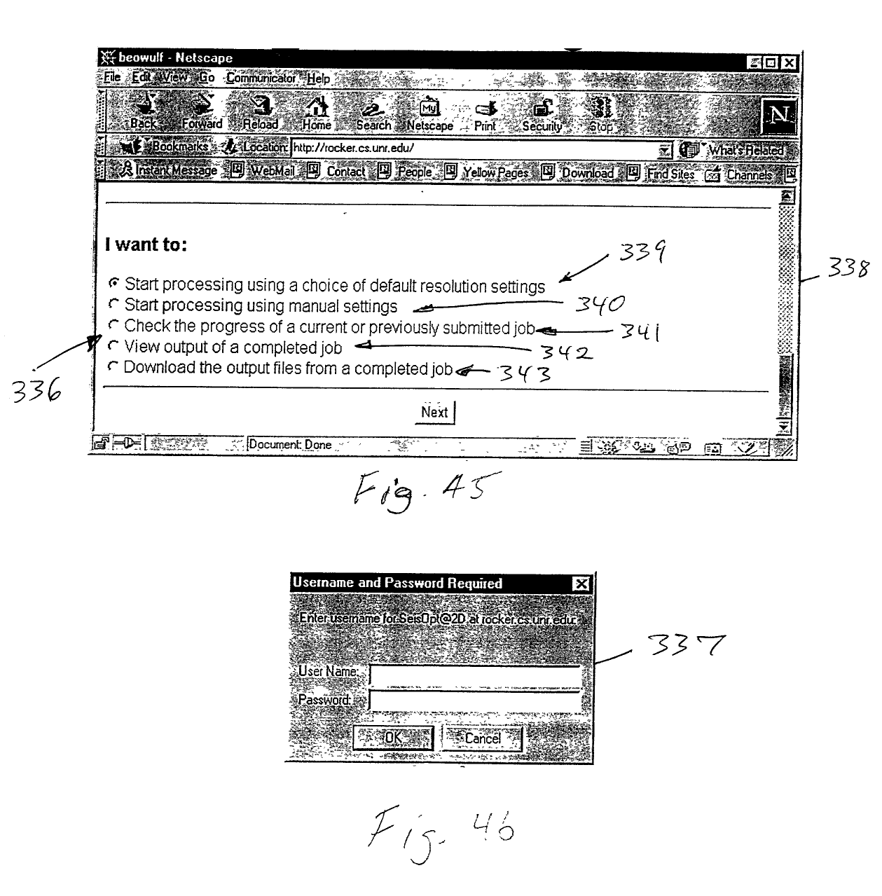

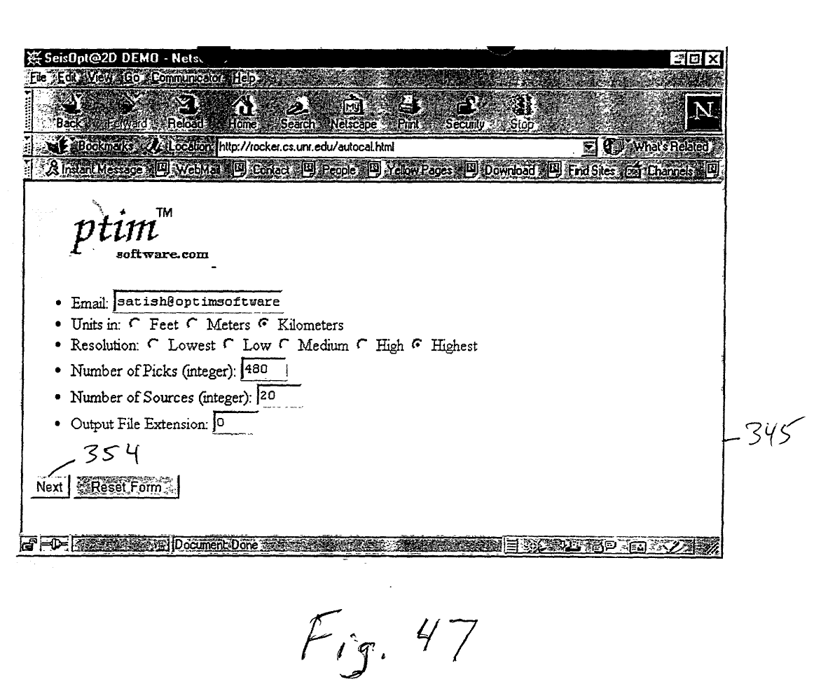

With reference now to FIG. 17, the input parameter file, Plotinput 67, for, as shown in FIGS. 2-4, MakeEPS 48 can either by created manually or by clicking “OK” on the MakeEPS settings window that comes up when the user clicks on the MakeEPS 48 button on the RAVISH GUI 44. MakeEPS 48 reads in files produced by RIOTS 42 and RISD 46 to produce report quality output of the velocity and hit count images. The files produced for this purpose are: (i) Velplot 62 and Hitplot 64 by RIOTS 42; and (ii) Surveyfile 70 by RISD 46.

The structure of these files (Velplot 62 and Hitplot 64 of FIGS. 2-4 ) is as below:

nx nz h minx maxz
ns nr
vel [1]
.
.
.
.
vel [nx*nz]
sx [1] sz [1]
.
.
sx [ns] sz [ns]
rx [1] rz [1]
.
.
rx [nr] rz [nr]

where nx is the number of grids in the horizontal direction, nz is the number of grids in the vertical direction, h is the grid spacing, ns is the number of sources, nr is the number of receivers, vel[1] to vel[nx*nz] are the velocity values (or hit count values if Hitplot or Surveyplot file), sx[ ] and sz[ ] are the x and z coordinates of the sources, and rx[ ] and rz[ ] are the x and z coordinates of the receivers. The structure of Plotinput file 67 is shown in FIG. 17.

With reference now to FIG. 18, the MakeEPS module 48 the ability to crop the image based on the user-specified limits of the x and y axes 156, the ability to draw an elevation profile 157, plot sources and receivers 158, and control the color levels in the image 159. The integration of MakeEPS 48 with, as shown in FIGS. 2-3, RIOTS 42 and RISD 46 is unique to SeisOpt@2D and SeisOpt2@Depth. The MakeEPS module 48 writes out files 160 with extension “.eps” containing the image and the extension “c.eps” if the user chooses to plot the sources and receivers on the image.

With reference now to FIGS. 19 and 20, the SeisOpt Tuner (43 In FIGS. 3 and 4) allows the user to interactively fine-tune an optimized velocity to obtain a tighter fit between the observed times (data) and the calculated travel times through the velocity model. The user can:

1. choose 161 a rectangular area and change its velocity either by a constant value or by specifying a gradient 162;

2. choose a “layer” in the model and move it up, down, increment or decrement its velocity 163;

3. Specify which part of the model is to be constrained (perhaps with a priori knowledge from geophysical information) and mark them 164. This feature enables the user to perform a constrained optimization.

The tuning is done using the TuneGraph (TG) view of the RAVISH GUI 44. After tuning the velocity model, the user can click “Check Model” 165, which will invoke the forward modeler 166 of FIG. 20. The Forward Modeler 166, shown in detail in FIG. 20, outputs files (the same as those produced by RIOTS/XIOTS) which can be visualized using RAVISH 44 and printed using MakeEPS 48.

In addition to fine-tuning the model, the above features can also be used to build new velocity models. Thus, the Tuner 43 can function as a “bid-module” wherein the user can build an approximated velocity model of the area to be surveyed, virtually deploy virtual sources and receivers, and analyze how the rays (hit count image) behave in the subsurface and if the sample adequately surveys the desired target zone.

With reference now to FIG. 1 and FIG. 21, the applicants'“net-based” seismic data processing system allows users to submit, process, analyze and visualize seismic data remotely over the Internet. The remote user can submit data over the web and view results and perform interactive analyses using their browser, or, receive the use's results and view them on the user's desktop. This capability provides users access to a fast remote computer with a simple and convenient browser-based graphical interface.

The basic configuration of the system is as follows. A fast computer or one node of a cluster of computers has a web server running on it. Users access this server from their local computers using a conventional web browser such as Microsoft Explorer™. Interaction with the remote computer cluster is accomplished with this browser. Specialized programs running on the remote server, provide the data upload and results display capabilities. This system uses a regular web server, which provides access through the conventional web browser on the client side.

An alternate method of providing this service is with a special SeisOpt server designed specifically for the seismic data processing system. Access on the client side is then provided by a web-enabled version of the SeisOpt desktop GUI, which replaces the standard browser as the client software. In this case, the desktop SeisOpt GUI is capable of running processing jobs either locally or remotely, via the SeisOpt server running on a fast remote computer LAN cluster 22.

In the net-based embodiment, the RIOTS 42 and XIOTS 49 modules of FIGS. 2-4 are modified so that they run on the cluster computer separate from the client SeisOpt GUI. These modified modules are called Parallel Refraction Inversion and Optimization Software (PRIOTS) and Parallel Cross-Hole Inversion and Optimization Software (PXIOTS) respectively. The difference between the parallel and serial versions, for the SA optimizers referenced in connection with FIGS. 2-4 above, is that the calculation of travel times from each source is now distributed among the nodes of the cluster computer LAN 22. The cluster LAN 22 uses the parallel-computing environment MPI. See Bums, G., and Daoud, R., LAM/MPI Parallel Computing Robust Message Delivery with Guaranteed Resources (1995), available at:

http://www.mpi.nd.edu/lam/mpi/delivery.paper.php3

Optionally, the PVM parallel computing enviromnent, well known to those skilled in the art, can also to be used to achieve the same objective.

In the net-based embodiment, the flow process is identical for the serial version described above. In the parallel version, the distribution of computing resources occurs when the optimization reaches the steps shown as shaded boxes in FIGS. 7 and 8. If another optimizer instead of a SA is used (see FIG. 25), the parallelization is achieved in a different manner. For example, in a GA optimizer, the algorithm, rather than the forward modeling step, is parallelized.

With more particularized reference now to FIG. 21, Common Gateway Interface (CGI) scripts written in PERL are used for user interaction with the remote client's web browser, after remote client-user log-in, in order to:

1. prepare and preprocess data for inversion optimization on the cluster LAN 22 of FIG. 1;

2. allow the remote client user to choose 171 among the following five options:

process with choice of model resolutions (Auto) 172;

process with manual input of model resolution (Manual) 173;

check the progress of a currently of previously submitted job 174;

view output of a completed job 175; and

download the output files from a completed job 176.

With reference now to FIG. 22, if the user selects auto 172 or manual 173 mode, a number of parameters specifying properties of the data to be processed are entered and collected 178 by the cluster LAN 22 server of FIG. 1. The data values, meanings, and types depend on the optimization being performed. For seismic inversion optimization, the parameters preferably collected from the client-user are:

1. the user's email address (text);

2. distance units (choice of meters, kilometers, feet);

3. if manual mode 173, then:

nx: number of rows in model (integer);

nz: number of columns in model (integer); and

h: grid size calculation helper (float);

4. if auto mode 172, then resolution choice (one of lowest, low, medium, high, highest);

5. number of picks (integer);

6. number of sources (integer); and

7. filename extension (text);

When the client-user presses the “Next” button after the collection step 178, these values are written 390 to the Riotsinput file 41 (in FIG. 2) by the cluster LAN server (or alternatively by a stand alone server, depending on the type of serving system provided by the server operator; see FIG. 2). Next, this server calculates 391 how many nodes will be required for processing this data based on the number of sources. The server then creates a script file 392 to run the job based on number of nodes and writes this file to the appropriate location. Finally, the server directs the client user to proceed to the file upload page 177.

Turning now to FIG. 23, the server provides the client-user with a CGI file upload script written in PERL, which is distributed under the GNU general public license found at http://www.fsf.org/copyleft/gpl.html. Once the client-user has chosen the files to be uploaded, and presses the “Go!” button, the chosen Pick 179, Source 180, and Receiver 181 files are copied (uploaded or transferred) 182 to the server (also shown as 22 on FIG. 1) and filtered for appropriate content during this copying process 182.

Completion of the upload process 182 brings up a new run screen from the server for the client-user. The run screen 183 allows the client-user to commence running the parallel optimizer on the cluster or LAN system by clicking on a run link which starts the server or LAN optimizer as applicable. A Java applet shows a progress bar on a separate window on the client-user's browser. This progress bar tracks progress and indicates percentage of job completed. The client-user may also then navigate the web without disturbing the progress bar window. When the job finishes running on the server, the client-user is notified by email (to the address specified in the data collection process of FIG. 22, and the progress indicator changes to indicate job completion through the client-user's browser. When the progress bar window is closed a new browser window pops up to show the results of the optimization. This browser window uses the RAVISH GUI 44 (see FIGS. 2-4 ) modified to run as an applet on the client-user's browser interface.

With reference now to FIG. 24, the applicants' preferred net-based server operates by starting a web page containing instructions 185 for using the net-based system, and option links for each of the processing options. This start web page 185 presents two options for starting a processing job, one for using a default resolution setting 186 and another for manually specifying the resolution 187. In each case, the start page provides a link that connects the client-user to a parameter settings entry page for entering the seismic survey parameters 188. The next link connects to the data file upload page 189. Here, the names of the data files located on the client-user's local computer are listed, for optional upload to the server. The next link completes and verifies the file upload 190. From the upload verification page 190, the seismic processing job is then queued to start on the server system when ready. This link goes to a page displaying the ‘SeisOpt running’ message 191, and spawns a separate small progress window that displays the approximate percentage of time remaining to compete the processing. The progress window 192 announces the completion of the client-user's optimization job, and provides a link to the results summary and visualization page 193. From here 193, results can be viewed by the applet version of the RAVISH GUI 44 (FIGS. 2-4 ) running through the client-user's browser, or can be downloaded 194 to the user's local computer for viewing locally.

Other options on the main start page 185 of the net-based processing system are relevant to the client-user's jobs already started and/or completed during a previous session. For example, if a client-user's optimization job is left in progress by closing the browser while running on the client-user's computer, the same progress window can be reopened later by a link from the start page 185. Similarly, the main page 185 contains links to the results summary and visualization page 193 and the results download page 194, for accessing the results of the client-user's previously completed jobs.

Recent advances in parallel computing have made it possible to easily take advantage of networks of workstations (clusters) and treat them as a parallel computer or supercomputer. Our parallel Beowulf is an extreme example, where the nodes (workstations) are dedicated to the cluster and are not used for anything else as opposed to a more conventional LAN in which a set interconnected workstations (perhaps on a departmental or company LAN) are used by users for various tasks. Although the latter LAN is not a dedicated Cluster Of Workstations (COW), this Local Area Network Of Workstations (“NOW”) with: (i) PVM (see Geist, A., Beguelin, A., Dongarra, J., Jiang, W., Manchek, R., and Sunderam, V., PVM: Parallel Virtual Machine A Users'Guide and Tutorial for Networked Parallel Computing, MIT Press, (1994) see: http://www.netlib.org/pvm3/book/pvm-book.html; or (ii) MPI (see Gropp, W., Lusk, E., and Skjellum, A., Using MPI: Portable Parallel Programming with the Message-Passing Interface, MIT Press (1999), see: http://www-unix.mcs.anl.gov/mpi/index.html.) can be considered a parallel computer/supercomputer and used to significantly speed up processing. The applicants' preferred net-based system uses such a NOW or COW for speeding up seismic inversion optimization and for other optimization tasks such as planning, scheduling, logistics, assignment, matching, design, and decision support applications.

PVM and MPI are available for Linux and Windows NT as well as other operating systems and platforms. With workstations connected over a network in this fashion, a parallelized PRIOTS (or XIOTS) optimizer runs over this network just as for the most preferred Beowulf COW described above. Since the underlying parallel software libraries are the same for the parallelized optimizer when run in either this COW or NOW fashion, no changes need be made to the parallelized PRIOTS or XIOTS code or interface.

In this regard, the above-referenced forward modeler can be parallelized by distributing the computations for a non-intersecting set of sources to each of the workstations on the network. Also, the optimization algorithm is preferably a GA. Thus, operation of the forward modeler and GA can be configured in one of the following four ways:

1. parallelize the GA; do not parallelize the forward modeler;

2. parallelize the GA; parallelize the forward modeler;

3. do not parallelize the GA; parallelize the forward modeler; and

4. do not parallelize the GA; do not parallelize the forward modeler.

With reference now to FIG. 25, the term Genetic Algorithm (GA) refers to a class of search algorithms that are based on the mechanics of natural selection. See D. E. Goldberg, Genetic Algorithms in Search, Optimization and Machine Learning Reading MA: Addison-Wesley (1989). In general, GA's are well suited to non-linear, multi-parameter problems, for which direct inversions are not feasible. They operate by repeatedly modifying and testing a group of possible solutions, where the modifications and tests are modeled on the principles of natural selection. One of the advantages of GAs over other search algorithms is that they lend themselves well to parallelization. When an algorithm is parallelized, it can run simultaneously on several CPUs at once to reduce the running time. For computationally intensive problems, such as seismic data processing, this can be quite useful.

The main features of GA's are that they provide:

trial solutions encoded in ID strings, called chromosomes;

a population of chromosomes, existing at each step of the algorithm;

a probabilistic method for randomly combining pieces of different chromosomes (crossover);

a probabilistic method for randomly altering chromosomes (mutation);

An objective function for measuring the quality, or fitness of each chromosome; and

repeated iteration over the crossover and evaluation steps (generations).

The applicants preferred GA has been adapted to find subsurface velocity models from the first-arrival times produced by seismic surveys. This adaptation required finding settings for the critical GA parameters, and also some modifications to the standard GA itself. The optimizer can be plugged into, as shown in FIGS. 2-4, the velocity optimization scheme, RIOTS 42 or XIOTS 53 and their associated SA as shown in FIG. 10. The input parameters and the objective function are the same as for the SA of FIG. 10. The only difference is in the optimization scheme used.

In preferred GA 195 shown in FIG. 25, the parameters of the seismic survey are read in (from the Riotsinput file) in the initialization step 196, and an initial population of velocity models is generated 197. The GA 195 utilizes 2D velocity models represented by a grid of velocity cells, which are encoded in ID chromosomes as strings of real numbers. The initial population is comprised of randomized and constant velocity models 197, where the constant velocity models are derived from fixed increments between preset minimum and maximum velocity bounds. From the size of the data set and the number if cells in the velocity model, the maximum number of generations to run is calculated from an equation of the form: maxgen=x+y*(model size/# data points).

The next step is the optimization loop 199. Chromosomes are chosen for crossover based on their fitness. A high fitness corresponds to a model that yields first-arrival travel times close to the observed data. Because the GA optimization chromosomes represent 2D velocity models, a special crossover operator is used that crosses over rectangular regions of each 2D velocity model, which correspond to discontinuous fragments of the 1D chromosomes. This implementation uses the CHC generational strategy with lambda=2, where crossover temporarily doubles the population size, and only the highest fitness half is kept for the next generation. (See Eshelman, L. J., The CHC Adaptive Search Algorithm: How to Have Safe Search When Engaging in Nontraditional Genetic Recombination, San Mateo, Calif. (1990), the disclosure of which is incorporated herein by reference.) Mutation 201 operates similar to crossover 200, by randomly altering rectangular regions of chosen models.

The next operation, smoothing 202, is a conditioning of each model before travel times are calculated through it. This operation does a 4-point smoothing, and also reduces velocity contrasts in adjacent cells to 2.5. After crossover, mutation, and smoothing, the fitness of each model is evaluated 203. This is the forward modeling step in the GA optimization algorithm, where a finite-difference travel-time code is used to compute the travel times of seismic waves through the velocity model. These computed times are compared with the observed times from the seismic survey. Models with a low error between the calculated and observed travel times have a high fitness, where fitness is calculated from the error using: fitness=[large #]−error.

One new feature of this seismic data processing implementation of the GA is a smart, or guided mutation operator 204, used during the evaluation step. In this step, a high error data point is selected and the region of the velocity model most likely to be controlling that point is determined based on the turning point of the seismic ray path. The velocities in this region of the model are shifted up or down corresponding to the sign of the travel-time error, for the selected data point. The advantage of this operation is a faster rate of fitness improvement, which translates to shorter GA optimization run times to reach a given level of error.

The optimization loop 205 is repeated until the number of generations reaches the maximum number determined in the initialization step 196. At this point 206, the GA 195 writes out the best model 207, and including the travel times and the ray coverage. The output results 207 can either be visualized using, as shown in FIGS. 2-4, the RAVISH GUI 44 or made into report quality output images using the MakeEPS module 48.

Because model spaces for seismic velocity problems can be very, very large, the run time required to reach an acceptable solution can be very large for search-based optimization algorithms. The applicants'believe that the most economical way to speed up run times is through parallelization such as shown in FIG. 26. In this parallelized GA implementation 208, separate copies of the serial GA 209 periodically exchange members of their populations. An alternative method of parallelizing the GA optimization process is at, as shown in FIG. 25, the evaluation step 203 of the serial GA. In the latter process, only one copy of the GA 195 runs, but the evaluation step 203 runs in parallel on many CPUs on the COW.

Most preferably, the parallel-computing environment MPI is used to implement this type of GA parallelization shown in FIGS. 25 and 26. The LAM implementation of MPI allows parallelized programs to run on both homogenous and heterogeneous collections of networked computers as well as intrinsically parallel computers. A Beowulf computer system, comprised of completely connected identical Beowulf PCs is an example of a homogenous parallel computer, which is most preferably used for this MPI implementation.

In other words, there are two ways to parallelize the GA: 1. the island parallel model; and 2. evaluation parallel model. In the island parallel model (shown in FIG. 26), the population is divided into subpopulations with each subpopulation is distributed across available workstations on the network. Let the number of subpopulations be indicated by the subscript i. For each subpopulation i, every Gi generations Si percentage of each subpopulation is exchanged with another subpopulation. Each subpopulation acts as a serial genetic algorithm except for the exchange of individuals with other subpopulations.

In the alternative evaluation parallel model such as described above, the population of candidate models is distributed for evaluation by the forward modeler across available workstations on the COW network. Thus if the population size is P and the number of available workstations is N, P/N members of the population are distributed to each available workstation on the network. One of the workstations receives P/N+P%N members of the population where P%N is the remainder left over when dividing P by N.

The present SeisOpt®@2D and SeisOptg®@Depth system can also provide three dimensional functionality. The main difference between the 3D and 2D implementation is the use of an alternative forward modeler in the 3D implementation—that is, a grid or non-grid based method to compute travel times in three dimensions. See Vidale, J. E., Finite difference calculation of traveltmes in three dimensions, Geophysics, 55, 521-526 (1990); Hole, J. A., Nonlinear high-resolution three-dimensional seismic travel time tomography, Journal of Geophysical Research, 97, 6553-6562 (1992).

Referring now to FIG. 27, the first Microsoft Windows™ GUI screen 220 provided to the user of the SeisOpt®@2D system of FIG. 3 pops up upon commencement of the SeisOpt®@2D program by, e.g., clicking on a corresponding icon (not shown) on the user's desktop. The main display window 221 is generally blank, showing the phrase “no data.” The main display window 221 remains this way until files from a velocity optimization are read-in and displayed as described below.

In order to run a velocity model optimization, the first step is for the user to click on the Riots Settings button 222. This action brings up the Riots Settings window 223 of FIG. 28. When using a data input conversion program, preferably provided with the SiesOpt®@D system, the conversion program should provide the values for the Riots Settings automatically. The Riots Settings include:

Autocal 224: This check box toggles between manual and automatic selection of the resolution parameter. When this box is checked, the autocal is on and there are five preset levels of resolution 229. When autocal is blank, the autocal is off and nx, nz, and h must be set automatically.

Units 225: In this pulldown menu selection box, the user chooses between feet, meters, or kilometers to match the units of the data input files.

Source file 226: In this data entry box, the user enters the name of the data input file, including the path. The user may click “Browse” to find and insert the data input file name.

Receivers file 227: In this data entry box, the user enters the name of the receivers information file, including the path.

Picks file 228: In this data entry box, the user enters the name of the first arrival time picks file, including the path.

Resolution 229: This pull down menu is active when autocal is on as described above, and in that event the user may select between five preset resolutions:

1. Highest=0.375 * receiver spacing;

2. High=0.5 * receiver spacing;

3. Med=1.0 * receiver spacing;

4. Low=2.5 * receiver spacing; and

5. Lowest=4.0 * receiver spacing.

nx, nz, and h 230: These values are used for manually selecting the model resolution when autocal is off as described above. “nx” is the number of cells in the horizontal direction; “nz” is the number of cells in the vertical or depth direction; and “h” is the number of dimensional units for grid spacing, according to the type of units specified in the Units box 225. Preferably, the user should first run RIOTS at least once with autocal on in order to determine the approximate range of appropriate values for these values 230.

Source count 231: The user enters into this box the total number of sources in the source input file.

Pick count 232: The user enters into this box the total number of first arrival time picks.

Output directory 233: The user enters into this box the path where output files from the optimization should be written.

Output extension 234: This value (or character string) is appended to the end of the optimization output file names. The purpose of this extension is to distinguish between the results from different runs. The default extension is a timestamp, but it can be set by the user to anything acceptable to the computer operating system (in this case, Windows 98). If this field is blank (i.e., intentionally blanked out by the user), 0 is automatically provided for the extension. Note that the extensions will be of the form ‘_[extension]’.

Clicking the ‘OK’ box 225 in the ‘RIOTS Settings’ window 223 saves the current settings of these parameters 224-234 to the Riotsinput file (see also FIG. 9), which can be manually edited if desired. The following list shows the contents of this file, for the ‘RIOTS settings’ window shown in FIG. 28:

units=3

autocal=0

res=5

nPicks=120

nSources=5

obfil=demo3\demo3_obs

srcfil=demo3\demo3_src

recfil=demo3\demo3_rec

outdir=demo3\

ext=1

For the purposes of editing this file manually (instead of using ‘RIOTS Settings’ to do it), use the following user guide:

units: 1=ft, 2=meters, 3=km

autocal: 0=use presets, 1=set manually

res: 1 to 5, where 1=lowest, 5=highest resolution [if autocal=1, replace res with nx,nz,h, each on a separate line; see above for details]

nPicks: total number of time picks

nSources: number of sources

obfil: path and filename of pick times input file

srcfil: path and filename of source location input file

recfil: path and filename of receiver location input file

outdir: path of directory in which output from the optimization is to be written

ext: extension to append to output filenames. The extension will be of the form “_[ext]”

After the input parameters have been set in the ‘RIOTS settings’ window 223 and the ‘OK’ box 225 has been clicked, the window 223 closes, with the first view 220 of FIG. 27 remaining on the user's screen. If the user then clicks on the red ‘Run RIOTS’ button 226, the RIOTS velocity optimization (see 42 in FIG. 2) commences and a progress window 427 (shown in FIG. 29) pops up on the user's screen. Clicking on the ‘End/Terminate Process’ button 428 in FIG. 29 will stop the RIOTS optimization. (Note that XIOTS 49 of FIG. 4 is operated similarly in SeisOpt@Depth.)

As RIOTS begins the optimization, it prints information regarding the resolution to the progress window 427 in FIG. 29. In the example shown in FIG. 29, autocal is reported 429 to be on, and the resolution is set to the highest value. This information can be used to help determine appropriate values for manually setting the resolution. As the optimization progresses, dots 430 slowly appear across the screen to indicate that the RIOTS program is running properly. After about 30 seconds, an estimate 431 of the total time running time of the optimization is displayed.

The total time to complete an optimization run can vary widely depending on several factors. These factors include the number of cells in the model, the number of sources (and to a lesser extent the number of receivers), the number of iterations needed to converge on a solution, and the speed of the computer being used. The number of cells in the model is controlled by the resolution (229 in FIG. 28), but since the resolution is based on the receiver spacing (unless manually chosen), the relationship between the receiver spacing and the overall extent of the survey will affect the total number of cells in the model. The resolution is the only factor affecting the running time under the user's control. The number of sources is obviously determined by the survey specifications, and not subject to change after the survey is completed. The number of iterations of the optimization process is dependent on the behavior of the travel-time errors for a particular model and cannot be controlled by the user (the dots that display during the optimization are related to the number of iterations). How fast a given computer will perform a certain optimization, with all other variables fixed, depends mainly on the clock speed of the processor (a number expressed in MHz). Therefore a 500 MHz Pentium II will complete the optimization approximately twice as fast as a 266 MHz Pentium II. The applicants preferred system utilizes a at least a 266 Pentium II, but the only real drawback of using a slower processor is the increase in running time.

With reference to FIG. 29, the estimate of the running time 431 is an estimate in fact because the number of RIOTS optimization iterations required to converge is different for every model. If this time is very large, and only a preliminary result is needed, the user can stop the optimization via the End/Terminate button 428 and re-start the RIOTS optimization with a lower resolution entered through the RIOTS Settings window 223 of FIG. 28. As an example of actual running times, low resolution models with less than 100 time picks might take only a few minutes, while high resolution models with more than 500 picks could take several hours on a dedicated Pentium II 266 MHz computer.

With reference now to FIG. 30, when the optimization has completed successfully, the progress window (screen 432; lower portion of 427, FIG. 29) provides information 233 regarding the results of the optimization run, followed by the word ‘Done’ 434. The reported information includes the minimum and maximum velocities present in the final velocity model 435, the resolution parameters 436, and the location of the output files 437.

Upon completion of the optimization, RIOTS writes out 15 separate files to, as shown in FIG. 28, the output directory 234 specified in RIOTS Settings window 223. The file output extension 234 chosen in RIOTS Settings 223 is appended to the 15 output files, whose names are listed below. From the list below the first six files are used by, as shown in FIG. 2, the RAVISH GUI 44 for displaying the results of the optimization. The remaining 9 files are either ASCII text versions of the optimization output or used internally SeisOpt@2D of FIG. 2.

Velfile: Contains final velocity model.

Hitfile: Ray coverage of the final velocity model. It is similar to the Velfile, but instead of velocity values for each cell, it contains the number of times each cell was sampled. Areas that are not sampled at all are unconstrained and zeroed out in the velocity model.

Pickfile: Contains the observed picks and the picks calculated from the final velocity model, for visually inspecting the quality of the fit.

Surveyfile: Contains the Hitfile information, as well as the source and receiver geometry for use with the interactive survey design feature of SeisOpt@2D.

VelSurveyfile: The same as Velfile, but with source and receiver location information as well.

Errorfile: Contains the L2 (least squares) error as a function of the iterations of the optimization process.

Riotsinput: Created by RIOTS Settings window (223 in FIG. 28) and contains all the parameters used in the optimization.

riotsmsg: Contains the messages displayed in the progress window during the optimization process. This file is written out with the specified extension only to the output directory 233 specified in ‘RIOTS Settings’ window 223 in FIG. 28.

Velvalues: An ASCII (text) version of the final velocity model in 3-column format. (x, z, velocity). This file can be imported into contouring programs, like Surfer™, for rendering the results in a different format.

Hitvalues: An ASCII (text) version of the final hit count model in 3-column format. (x, z, hits). This can be imported into contouring programs, like Surfer™, for rendering the results in a different format.

Velplot & Hitplot: Velocity and hit files, respectively used by the encapsulated PostScript output feature of, as shown in FIG. 2, the MakeEPS module 48.

v.final & Risdinput: Files used by SeisOpt@2D during the interactive survey design process.

Plotinput: The EPS plotting module, MakeEPS 48 uses this file to create and output encapsulated PostScript files as shown in FIG. 2.

In addition to the output directory, copies of some of these files are also written by RIOTS to the SeisOpt®@2D directory, without extensions. This allows SeisOpt®@2D immediate access to them for display purposes by, as shown in FIG. 2, the RAVISH GUI 44.

As a general rule, the applicants prefer to run RIOTS at least 5 times on the same data input set. During each such run, the velocities in the regions not constrained by the rays (zero hit counts) will vary from one run to the next. Repeating the runs gives a user a handle on these velocities. Preferably, the user should first, run RIOTS at the ‘Highest’ preset resolution 229 in, as shown in FIG. 28, the RIOTS Settings window 223 and then carefully note the parameters that appear on the “Progress” window 427 of FIG. 29. If the model parameters, nx and nz, are large (say, nx * nz>50,000) and if the estimated time to complete the run is very long, the user should reconsider running RIOTS at the ‘High’ resolution setting. That is, if the model parameters are large and the estimated completion time seems too long for a given optimization, then the user can terminate the optimization and rerun it at the next lower resolution setting and subsequently at yet again an even lower setting such as ‘Med’ resolution. The user should then review the Velfile, Hitfile, Pickfile, and the final error of the model (look at the last value in Errorfile) from these two runs and choose the model that best fits the data and known geology.

For a third optimization run as an example, the user can set RIOTS to run with manual settings 230 (see FIG. 28). The user should consider retaining nx and h without change from the best of the prior preset runs but change the nz parameter. If, in the best of the preset runs, the Velfile shows non-zero velocity values close to the bottom of the model, the user should set the nz parameter to a slightly higher value. If, on the other hand, there are several rows with zero velocity values between the bottom of the model and the constrained (non-zero) region, the user should set nz to a lower value. Most preferably, the user should attempt to complete two such additional runs, each with its own manually set but unique manually entered value for nz. Another option is to perform an optimization run with a different value of h (e.g., rounded to the nearest integer).

The more optimization runs the user performs, the more likely the user will procure the best possible velocity model and be certain of the “robustness” of the features in the optimized model. For convenience, this multiple optimization run process can be automated by use of a ‘.BAT’ file that can, for example, perform three or more RIOTS optimization runs on input data, with a different set of resolution settings for each such run. This ‘.BAT’ file can then be run by double clicking on the file from Windows Explorer™.

With reference now to FIG. 31, SeisOpt®@2D automatically loads four of the display files output from the most recent optimization upon startup, if four such files are present in the SeisOpt®@D2D directory. Additionally, results from subsequent optimizations are automatically loaded as they finish, by pressing, as shown in FIG. 27, the ‘Reset’ button. The four displayed files, Velfile, Hitfile, Pickfile, and Surveyfile, can be selected one at a time from the pull-down menu 239 on the top center of the SeisOpt®@2D opening window. FIG. 6 shows this pull-down menu.

With reference again to FIG. 27, to select the results of a previous optimization, the user clicks on the ‘Settings’ button 299. This opens the previous optimization window 240 of FIG. 32. The ‘Number of views’ field 241 is for entering the number of files to be read. The default is 4, corresponding to Velfile, Hitfile, Pickfile and Surveyfile, but this can be any number. The next lines, labeled ‘View 0’, ‘View 1’, etc., 242 are for entering the names of the files to be read. Pressing ‘Ok’ 243 after entering the number of views 241 adjusts the number of view fields 244 (which are then blank) to correspond to the ‘Number of views’ parameter. The user may either enter into the view fields 244 the full path and file name or browse for the file using the ‘Browse . . . ’ button. To the left of each file name window, e.g., 245, is a pull-down menu 246 for selecting the type of display that will use the file name 245. These fields 244, 245 are preset for the default file names of FIG. 32, but the user may alter them 244, 245 if different files are selected. Use the following guide to choose the appropriate display type:

| File type | Display type |
|---|---|
| Velfile: | Interactive velocity graph |
| Hitfile: | Interactive velocity graph |
| Surveyfile: | ISD (Interactive Survey Design) |
| Pickfile: | Model Graph |
| VelSurveyfile: | Interactive velocity graph |

With reference now to FIG. 33, an example of viewing files in the output subdirectory demo3 appears if demo3 had been selected as the output directory 233 of the RIOTS Settings window 223 of FIG. 28. Clicking ‘OK’ 243 loads the selected files and the main display window 220 of FIG. 27 appears on screen.

Once a file has been selected for viewing through the pull down menu 239 as shown in FIGS. 34, clicking the ‘Go/Stop’ button 247 displays the desired output view for the selected file. First, however, a dialog box appears if SeisOpt@2D cannot find the selected file.

The following list explains the zoom controls common to all display types:

Zoom Box 248: Clicking this key allows the user to define a zoom region by using the mouse to draw a box by clicking and holding the left mouse button while dragging the mouse pointer over the desired region. The display will zoom to the boundaries of the box.

Zoom 1:1 249: Clicking this button restores the display to the default state of zoom, in which the entire file fits within the display window.

Zoom In 250: After clicking this button, left clicking on a region of the display zooms in on the region. Once this button has been clicked, its label changes to ‘Stop Zooming’. To continue zooming in, keep clicking on the display. To stop zooming in and return to the default display mode, click on ‘Stop Zooming’. Use ‘Zoom 1:1’ to return to the original display.

Zoom Out 251: Operates just like ‘Zoom In’ 249. Click on the button, then on the display, and the image will zoom out centered on the point that was clicked.

With reference now to FIG. 34, once a Velfile has been selected via the pull down menu 239 and ‘Go’ 247 has been clicked, the velocity model window appears as shown via example output in FIG. 34. As shown in FIG. 34, the velocity model is computed over a rectangular array of cells, but only the region constrained by the ray paths is displayed. Therefore, it is the geometry of the paths of the energy traveling from sources to receivers that determines the size and shape of the resulting velocity model.

(These Paths can be Viewed in the IVG View Associated with Hitfile.)

With reference to FIG. 34, the velocity model display includes the following features:

Mouse: Left clicking with the mouse anywhere on the velocity model displays the coordinates of that point in the physical units (offset from upper left corner of the model), and the velocity of that cell.

X-axis (horizontal) 252: The X-axis displays the length or offset of the survey in the physical units used in RIOTS settings (i.e. ft, m, km). 0 distance represents position of the first shot or receiver.

Y-axis (vertical) 253: The Y-axis corresponds to the relative elevation of the survey. The top of the axis is labeled with the true maximum elevation of the survey in the units specified in ‘RIOTS Settings’, the same units used in the X-axis. The bottom of the Y-axis is labeled with the distance below the top of the survey. The elevation of the bottom of the survey can therefore be determined by subtracting the lower Y-axis label value from the upper value.

Vertical exaggeration: The vertical exaggeration of the display varies from model to model, because it depends on the size of the model (number of cells in each dimension) relative to the size of the SeisOpt@2D display for Velfile 254. This SeisOpt@2D display 254 can be resized however, and by carefully examining and altering the x- and y-axes appropriately, a 1:1 display 254 can be achieved.

Amplitude scale bar 255: The scale bar 255, which is labeled velocity and plotted to the right of the velocity model window 254, shows the correspondence between the colors used in the velocity model plot within the window 254 and velocity. The velocity values are in the units specified, as shown in FIG. 28, in the units box 225, per second. Clicking the left mouse button anywhere on the scale bar 255 displays the exact velocity of that color. The default range of the scale bar is from 0 to the maximum value in the model. The color/velocity correspondence of the scale bar can be adjusted. In the blank spaces at the top 256 and bottom 257 of the scale bar, velocity values corresponding to the extrema of the color spectrum can be entered manually. For example, unless the lowest velocity in the model is 0, the full range of colors is not used in the default display. By entering the actual minimum velocity of the model (look in the ‘riotsmsg’ file) in the space at the low end 257 of the scale bar, the full range of colors will be used in the display. By entering velocity values within the range present in the model, the color display can be ‘clipped’ and thus made more reflective of the colors in the velocity model display 254.

Layer Density 258: The layer density 258 refers to the number of colors used in the velocity model display. The default setting is “Maximum”. In general SeisOpt@2D avoids the limitations imposed by assuming layered structures in velocity models, but this is a common feature of traditional velocity modeling programs. To cause to velocity model display to more closely resemble a simple layered structure, the number of colors (or layers) used to represent the velocities can be reduced. FIG. 35 shows the activated layer density pull-down menu 258. The numbers in this menu 258 effectively refer to the number of colors that will be used in the velocity model plot. The user can scroll down the menu 258 to select the lowest layer density, 3, if desired.

With reference back to FIG. 31 and 34, if the user selects a Hitfile from the pull down menu 239 and clicks ‘Stop/Go’ 247 when toggled to ‘Go,’ a display of the Hitfile pops up, as shown by the example of FIG. 36. A Hitfile contains information about the how the subsurface was sampled by the seismic survey, based on the optimized velocity model provided by running RIOTS. RIOTS computes the raypaths for each source/receiver pair, and then determines the number of times each cell in the model is crossed (‘hit’) by a raypath. The Hitfile view of FIG. 36 displays the results of these computations. The location of these raypaths determines the particular region of the optimized velocity model to be constrained and therefore displayed. Note that the example Hitfile display 259 in FIG. 36 contains white cells, e.g., 260, within the plot. These white cell areas have no hits, and they therefore the corresponding areas in the velocity model are not well constrained. The Hitfiles display 259 uses the same ‘Interactive Velocity Graph’ display mode as Vefiles, so the essential features of the display are similar and as follows:

Mouse: Click on any cell, e.g., 261, within the Hitfile display 259 to see the coordinates and number of hits for that cell 261.

X 262 & Y 263 axes: Same as velocity model display described above.

Amplitude scale bar: The scale bar 265 shows the correspondence between the number of hits and color. Left clicking on the scale bar 265 displays the hit value for specific colors. For example, light purple=1 hit; white=0 hits.

Layer Density 258: This controls the number of colors that are used in the display. While useful for viewing Velfiles, this feature is not useful for Hitfiles.

<<266 & >>267: Use these buttons to cycle the display 259 between the raypaths for different sources. When a Hitfile is initially loaded, all the sources are displayed. Use ‘<<’ to remove one source at a time from the display. Use ‘<<’ to cumulatively add sources to the display 259.

With reference to FIG. 34, once a Pickfile has been selected for viewing in the pull down menu 239, click ‘Go’ 247 to display, as shown by example in FIG. 37, the Pickfile view 268. Pickfiles contain the arrival time pick data used as input in the RIOTS velocity optimization and the first arrival times calculated from optimized velocity model. The discrepancy between these two sets of times is what SeisOpt@2D minimizes during the optimization. The Pickfiles view 268 is used to visually inspect these two sets of times. One blue line and one black line are plotted for each source, corresponding to the observed 270 and calculated first breaks 269. The black squares 271 represent the observed (picked) first arrival times, and the blue triangles 272 represent the calculated times, for each receiver. FIG. 37 shows the times for a sample source number 1, and FIG. 38 times for all sources of the example data shown in FIGS. 8 and 10.

With reference to FIGS. 37 and 38, the features of the Pickfile display 268 are as follows:

Mouse: Left clicking the mouse on any point (square, e.g., 271, or triangle, e.g., 272), displays the physical coordinates of that receiver, and the travel time to that receiver for the associated source.

X-axis (horizontal) 273: Offset in physical units, the same as the Velfile/Hitfile display x-axis.

Y-axis (vertical) 274: First arrival time in seconds.

View all picks check box 275: This check box controls whether sources are displayed singly or all together. The default setting for this feature is off (i.e., when not checked), and only the first source is shown when the file is first displayed. Clicking in this box 275 with the left mouse button causes the times for all sources to be displayed as shown by example in FIG. 38.

<<276 & >>277: When viewing one source at a time, these buttons 276, 277 allow the user to cycle through the different sources. The current source number is shown at the bottom of the viewing window, e.g. 278 in FIG. 37.

With reference back to FIG. 34, if the users selects a Surveyfile in the pull down menu 239 and clicks ‘Go’ 247, a Surveyfile display, for the Surveyfile corresponding to the selected file, appears such as shown by example in FIG. 39. A Surveyfiles contains the same subsurface sampling information as a Hitfile, but a Surveyfile also includes the seismic array geometry. Thus, a Surveyfile is used to provide a display of changes in subsurface raypath coverage when the array geometry is altered. Sources and receivers can be manually moved, added, or deleted in ‘Interactive’ mode in the view such as that provided in FIG. 39; or alternatively sources and receivers can be arranged automatically in ‘Auto’ mode to improve ray coverage in a specified area. Whenever the array has been changed, the subsurface raypath coverage can be recomputed automatically to reflect and display the array changes.

With regard to the Surveyfile view 276 such as in FIG. 39, the Mouse, X-axis, Y-axis, Scale Bar, and Layer Density features are the same as described above for the Hitfile display such as shown in FIG. 36. Additional features of the Surveyfile view include:

Sources and Receivers: Sources and receivers are plotted along the top 277 of the raypath coverage image, connected by a line representing the approximate elevation profile. Sources are shown as 6-pointed stars, e.g., 278, and receivers are represented by downward triangles, e.g., 279.

Associations 280: This button is used to display and alter the receivers associated with (recording) a given source. After clicking on this button, left-clicking with the mouse on any source, e.g., 278. That source and all the receivers currently associated with it turn black. Any receivers not associated with that source remain gray. Next, clicking on any receiver, e.g., 279, to toggle between associated and not associated.

Associate All Recs. 281: This button is used to associate every receiver with a given source. It is most useful when adding new sources. After clicking on this button, left-clicking on any source, and all receivers will be associated with it.

Move 282: The move button allows sources and/or receivers to be moved using the mouse. Clicking on the ‘Move’ button and clicking and holding down the left mouse button on the source/receiver allows the user to dragging the source/receiver to the new position on the display 276.

Add Source 283: This button is clicked to add a source. Clicking ‘Add Source’ and then on any location on the coverage display 276 adds a source at that location. After adding a source, receivers must be associated with the added source. Use the ‘Associations’ 280 or ‘Associate All Recs’ 281 buttons to make the desired association.

Del Source 284: Use this button to delete sources. Clicking on this button and then on a source deletes the clicked source.

Add Receiver 285: Use this button to add receivers. Clicking on this button and then on a display location 276 adds a new receiver at that location. Added new receivers must be associated with sources. Use the ‘Associations’ 280 or ‘Associate All Recs’ 281 buttons to make the desired association.

Del Receiver 286: Use this button to delete receivers. Clicking on this button and then on a receiver deletes that receiver.

Undo 287: Clicking this button undoes the most recent change to the array.

Redo 288: Restore the last undo action.

Info 289: Clicking this button enables mouse clicks on the model 290 to display coordinate and hit information.

Interactive 291: This button recalculates the ray coverage. Clicking it after making changes to the array geometry (such as moving sources/receivers, deleting/adding sources/receivers) causes, as shown in FIG. 40, a progress window 292 to open while SeisOpt®@2D RIOTS calculates the new raypaths. Once the calculation is finished, the word ‘Done’ 293 appears. The name of the file with the new ray paths 294 also appears in the progress window 292. This new file 294 is derived from the new number of sources and receivers. In the displayed example of FIG. 40, the filename shown is ‘Surveyfile-5s120r’, meaning there are 5 sources and 120 total receivers (5 sources recording into 24 receivers each). The use may return to the main window such as shown in FIG. 27 and select this new Surveyfile for viewing using the Settings button 299. To terminate the Surveyfile recalculation, the user clicks the ‘End/Terminate process’ button 295 on the progress window 292 to close it.

Make Box 296: Use this feature in conjunction with the ‘Auto’ button 297 to automatically rearrange the array geometry to optimize ray coverage in a certain area. After clicking ‘Make Box’ 296, then user then clicks and holds down the left mouse button on the ray coverage display. While holding down the left mouse button, drag the mouse to draw a box over the area of the model where an increase in coverage is desired. Then clicking ‘Auto’ 297 causes RISD to adjust the positions of sources and/or receivers in an attempt to maximize the coverage within the box drawn with ‘Make Box’ 296.

Auto 297: This button automatically rearranges the array geometry and computes the new subsurface ray coverage. The user can employ this feature after drawing a box using the ‘Make Box’ button (explained above) to draw a box around a region of the subsurface where an increase in coverage is desired. If ‘Auto’ has been clicked, a progress window 300, as shown for example in FIG. 41, automatically opens to track the progress of the calculation of the new array geometry and ray path coverage. Once the calculation is complete, the user may select, by clicking on the Settings button 299 in the main window 220 such as shown in FIG. 27, the new Surveyfile name shown in the auto calculation progress window 300. The file name in the example of FIG. 41 is ‘Surveyfile-5s120r’ 301. The extension appended to Surveyfile 301 is derived from the number of sources and total number receivers (or picks).

The RISD module performs the above functions shown above in connection with FIGS. 27-41 using, as a default, the velocity model most recently created using RIOTS. If the user desires to perform these functions with a previously created velocity model, the user may manually copy over the ‘v.final_[ext]’ file and ‘Risdinput_[ext]’ files from the prior run to the SeisOpt directory and re-name them ‘V.final’ and Risdinput’ respectively.

After each RISD run (interactive or automatic) a ‘Plotinput_survey’ file is automatically created in the SeisOpt directory. Each Plotinput_survey file can then be used by the MakeEPS module to create EPS image output files. To do so, the user must manually rename the desired ‘Plotinput_survey’ as ‘Plotinput,’ and then return to the main view 220 such as shown in FIG. 27 use the ‘MakeEPS’ button 302 in the Velfile display

The simplest way to output optimization images such as those shown as examples in FIGS. 34, 36, 37, 38 and 39 is for the user to send the then current display, e.g., FIG. 39, directly to a printer using the ‘Print’ button 304 present on the SeisOpt@2D interface for all such displays. The graph image, e.g., 305 in FIG. 34, then prints in ‘landscape’ orientation and should be so set up in advance in the Windows™‘printer setup’ menu.

In order to create an Encapsulated PostScript file that can be edited subsequently, the user presses the MakeEPS™ button 306 shown for example in FIGS. 36 and 34. The Encapsulated PostScript output files then can be read into and printed by readily available third-party programs such as Adobe Illustrator and Corel Draw. This format is useful because, unlike other graphics formats, text and other elements of the image are preserved as discrete objects (e.g., text is stored as ASCII text, not a rasterized image of text, in the output files), which are easy to subsequently edit and customize.

To begin such an EPS file creation, the user clicks the ‘MakeEPS’ button 306 (FIG. 34 and 36). This action brings up the MakeEPS Settings window 307 such as shown as an example in FIG. 42. This window 307 reads in the ‘Plotinput’ file present in the SeisOpt directory. The Plotinput file is created by RIOTS or after running the RISD module to perform an automatic or interactive survey design. The actual example settings shown in FIG. 42 correspond to the file created after the RIOTS run shown in FIG. 34. The MakeEPS Settings window 307 provides the following features:.

Plot sources/recievers 310: Clicking this check box causes sources and receivers to appear in the file, as they appear in the associated Surveyfile display, e.g., 276 in FIG. 39.

Plot elev profile 311: Clicking this check box causes the approximate elevation profile to appear in the file, as it does in the Surveyfile display 276.

Input file 312: In this box, the user enters the path and filename of the file to be used to generate a corresponding EPS file, or the user may click ‘Browse . . . ’ to find the file. These files can be Velplot, Hitplot, or Surveyplot files. In addition to the entered Velplot, Hitplot, or Surveyplot file, the MakeEPS module also requires a ‘Plotinput’ file. Since the RIOTS optimization process and the RISD interactive survey design process both generate this file, it is normally always present. However, when making EPS plots of data generated during previous SeisOpt®@2D sessions, it may be necessary for the user to copy the appropriate ‘Plotinput’ file from the corresponding output directory (it so saved with the extension used for the optimization) into the SeisOpt@2D directory. For the MakeEPS Settings window 307 to read such a file, the file must be relabeled ‘Plotinput’.

The following four fields allow the user to select a subregion of the total image for inclusion in the EPS output file to be generated by Make EPS function provided by the window 307:

X minimum 313: Minimum value of x-coordinate (horizontal distance in physical units−ft, m, km) from which to start plotting the desired image. The default setting is the smallest possible x-coordinate value. It should only be increased if desired.

X maximum 314: Maximum value of the x-coordinate to be plotted from the desired image. This number must always be greater than X minimum. Note also that the default setting for this value is slightly greater than the actual total length of the array and is the largest possible value. If changed by the user, it should only be changed to a smaller value.

Y minimum 315: Minimum value of the y-coordinate (elevation in physical units) from which to plot the desired image. It should only be changed to a greater value, if needed.

Y maximum 316: Maximum value of the y-coordinate (elevation) to be plotted from the desired image. Any change should be to a smaller value.

Scale Label 317: Enter the label to use for the scale bar to be plotted (e.g., velocity, km/s).

X-axis label 318: Label for the x (horizontal) axis to be plotted. (e.g., distance, km).

Y-axis label 319: Label for the y (vertical) axis to be plotted (e.g., distance, km).

Title 320: In this box, the user enters the title that will appear on the plot.

Aspect ratio 321: This box sets the aspect ratio of the model as it will appear in the plotted EPS output file. The default number corresponds to no vertical exaggeration and is based on nz/nx (number of cells in z direction/number of cells in x direction shown in the ‘riotsmsg’ file in the output directory). To change the vertical exaggeration to 2 for example, the user should enter the value of the default aspect ratio multiplied by 2.

Use Color 322: The user checks this box to create a color EPS output file.

Number of colors 323: The user enters the number of colors to provide in the color EPS output file.

Auto scale 324: The user checks this box to use the default scale bar limits. (0 to max value in the model.) The user un-checks this box to manually set the scale bar limits using the two fields below, ‘maximum’ 324 and ‘minimum’ 325.

Maximum 325: When ‘Auto scale’ is not checked, the user enters a value for the scale bar maximum.

Minimum 326: When ‘Auto scale’ is not checked, the user enters a value for the scale bar minimum

Once all such fields 310-326 have been set, clicking ‘OK’ 327 to create the desired EPS output file. With reference to FIG. 43, a progress window 328 then automatically opens, indicating when the file creation is complete 329. Additionally, the name of the EPS output file 329 appears in this window 328. Clicking ‘End/Terminate process’ 330 at the bottom of the progress window closes the progress window 328 and terminates the EPS output generation function (by the MakeEPS module) if still in process.

The output EPS file, e.g., 329, is always written by MakeEPS to the directory from which the input file was read in. Also, if the ‘Plot sources/receivers’ option 310 has been checked, the output EPS file will have a ‘_c.eps’ extension instead of an ‘.eps’ extension.

SeisOpt®@2D will not run without a valid license, and separate licenses are required for each computer on which SeisOpt®@2D runs. If a valid license is not present, a message saying ‘program not authorized’ appears when SeisOpt®@2D is started. Configuring the license involves requires that the system provider provide to the user an appropriate ‘Site Code’ and a ‘Site Key’ to be entered by the user on start-up of the SeisOpt system.

In order to run, RIOTS requires four files: the parameter file ‘Riotsinput’, and the three data files such as those shown as an example in FIG. 28. A message in the RIOTS Progress window, e.g., 227 in FIG. 29, appears if RIOTS cannot find any one of the four required input files.

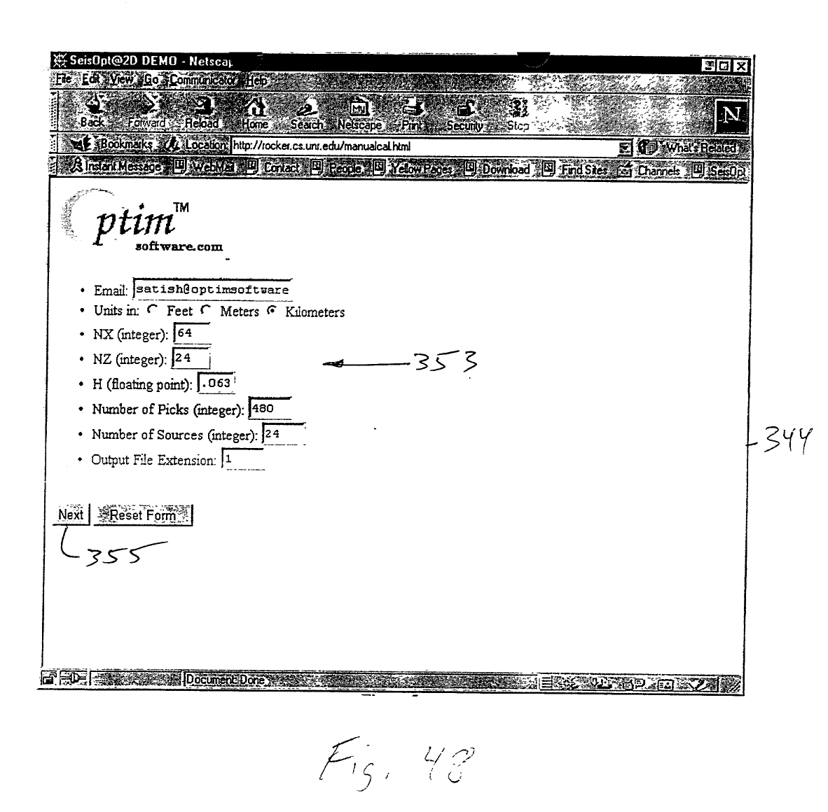

Referring now to FIG. 44, the main user interface 330 of the applicants' alternative net-based optimization system is accessed via the Internet with the user's conventional web browser, and this web-site interface 330 contains instructions 331 to the user for use of the interface 330 and system. The main user interface 330 includes help page link 332, a demo data set link 333, resolution settings links 335, and an input file conversion program link 334. The main user interface 330 also includes radio buttons 336 at the bottom (see FIG. 45) enabling the user to start an optimization using the default or manual resolution settings links (339 and 340, respectively) in the lower portion 338, shown in FIG. 45, of the same browser window 330 shown in FIG. 44, view the progress of a submitted job 341 (FIG. 45), view the output of a completed job 342 (FIG. 45), or download the output of a submitted job 343 (FIG. 45).

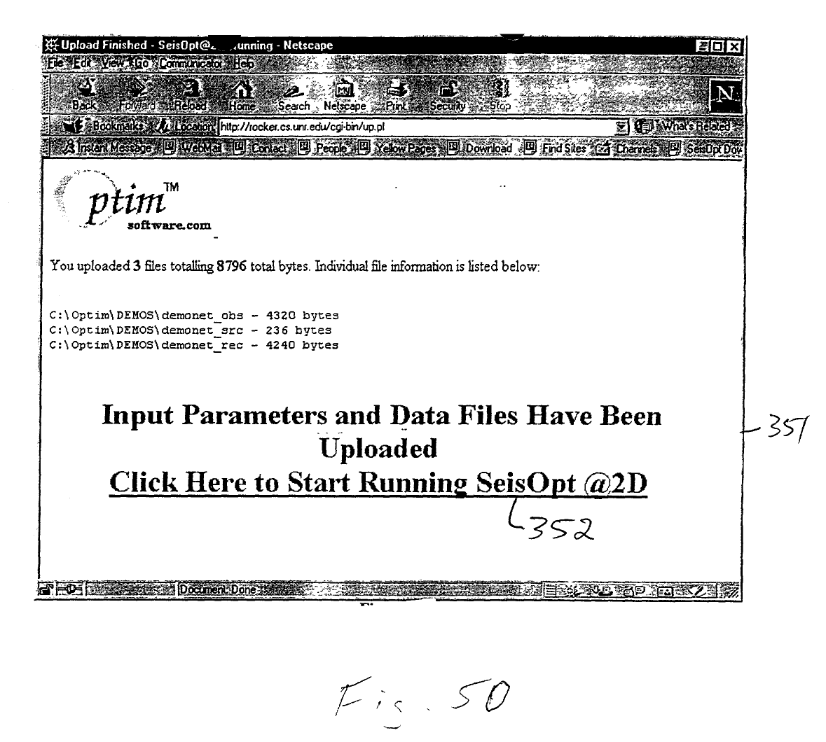

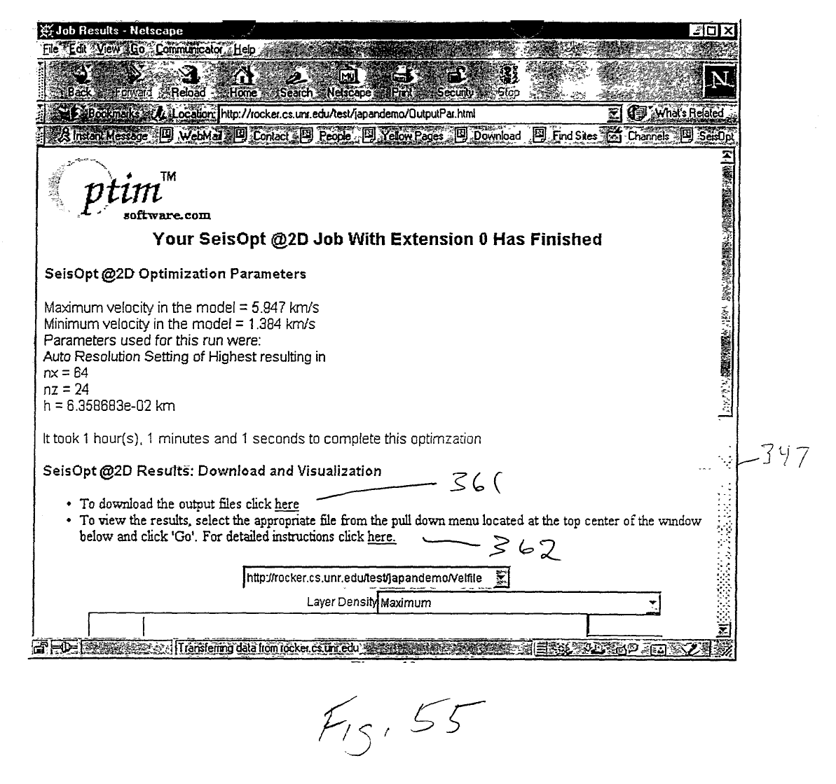

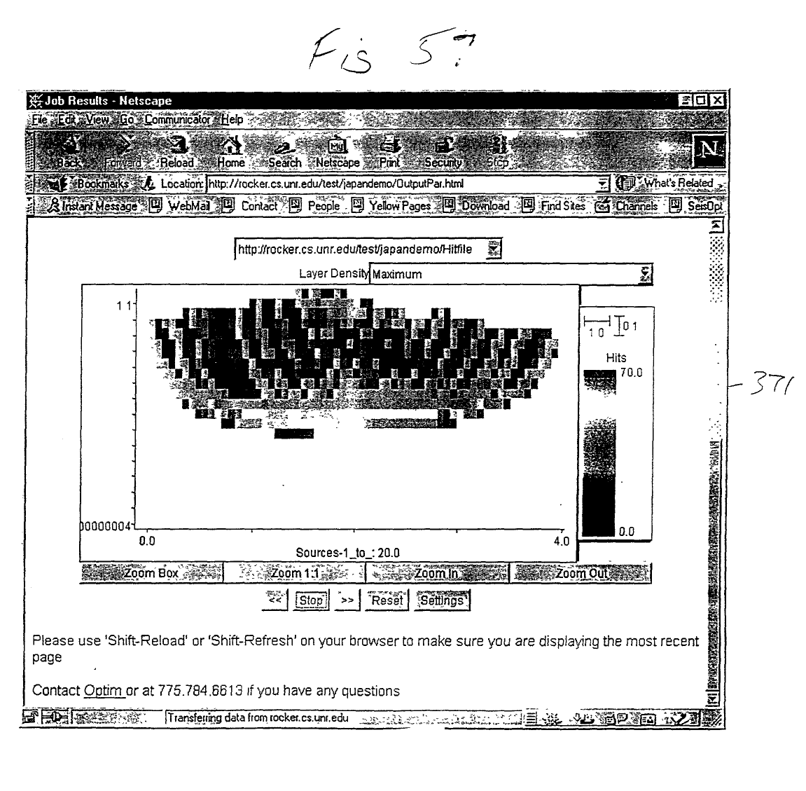

The above radio buttons provide the user with the choices of (i) processing data with default resolution settings 339 (which brings up a dialog window 345 such as shown as an example in FIG. 47) or with user provided, manually chosen settings 340 (which the also brings up the dialog window 344 such as shown as an example in FIG. 48); (ii) checking the progress of a previously submitted optimization job for the user 341 (which brings up a dialog window 358 such as shown in FIG. 52); (iii) viewing output of a completed job for the user 342 (which also brings up a dialog window 347 such as shown in FIG. 55); and (iv) downloading output files from a completed job for the user 343 (which also brings up the dialog window 501 of FIG. 55).

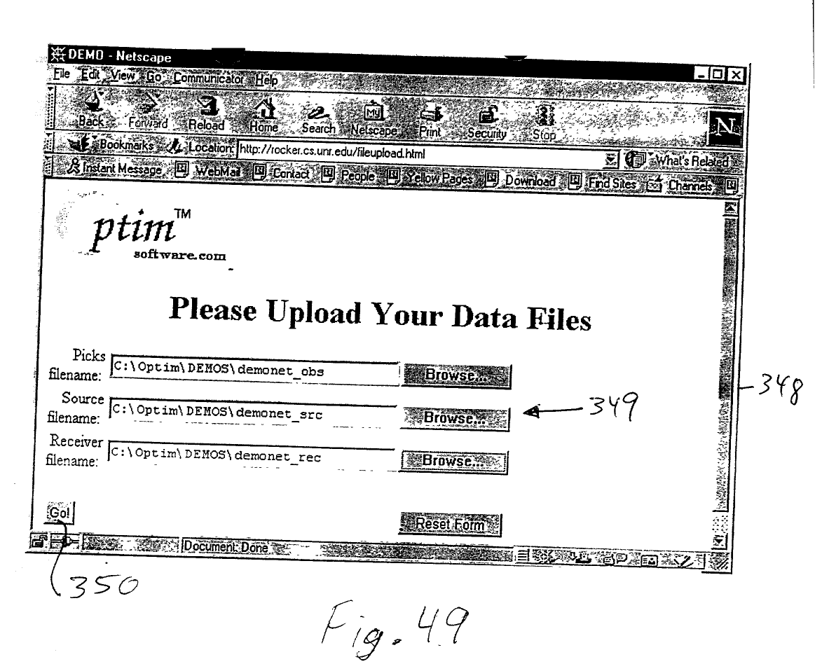

When the user clicks the “Next” button 500 (FIG. 45) on the main user interface page 330, 338, a log-in dialog window 337 such as shown in FIG. 46 appears. The user must first enter a valid username and password into this window 337 in order to proceed.

With reference now to FIG. 47, if prior to the log-in step the user has selected the default resolution settings option 330 in window 338 of FIG. 45, the user is next presented with a default settings screen 345 such as shown as an example in FIG. 47. The user may proceed to upload files to the optimization server system by clicking the next button 354 on this screen 345.

If, on the other hand, the user has selected the manual settings option 340 in window 330 of FIG. 45, the user is next presented with the confirmation window 344 such as shown as an example in FIG. 48. The user may enter desired changes in the desired data entry boxes 353 in this window 344. The user may then proceed to upload data input files to the optimization server system by clicking the next button 355 on this screen 344.

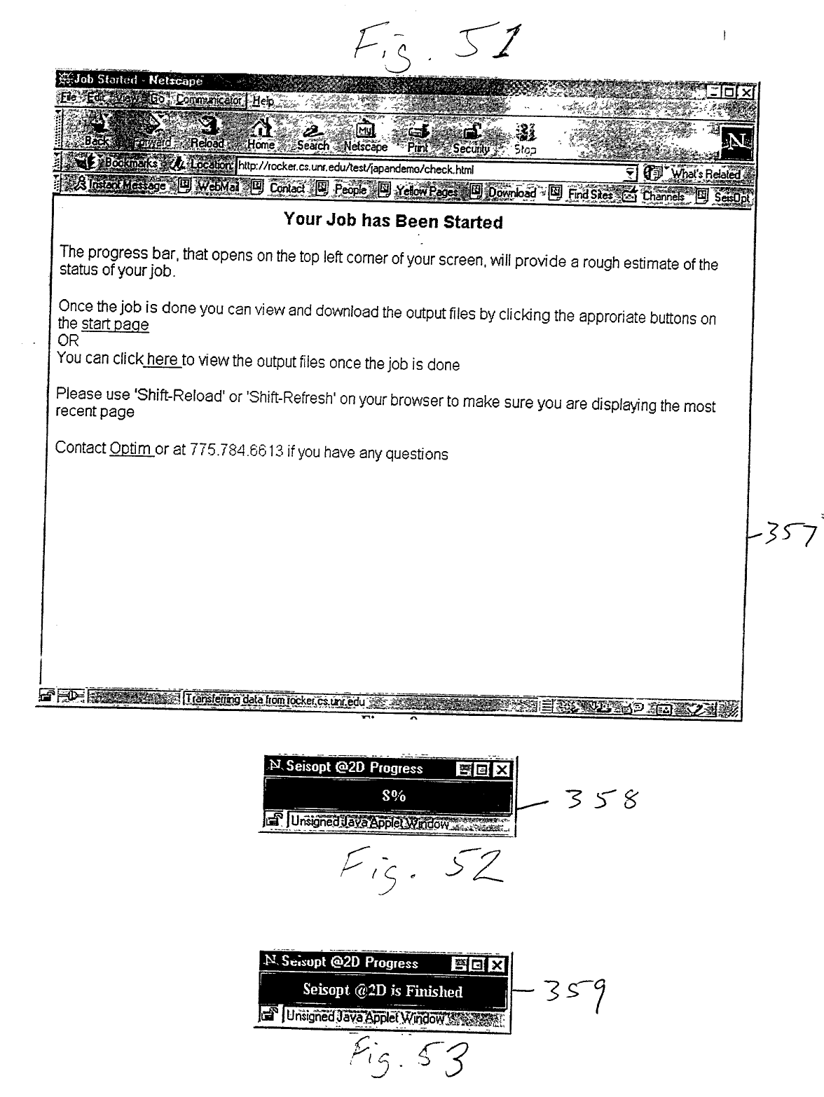

With reference to FIG. 49, the user next uploads the required three data input files 349 through the upload window 348 in order to run an optimization (RIOTS) with the data input files 349. The file upload process commences when the user clicks the GO button 350.

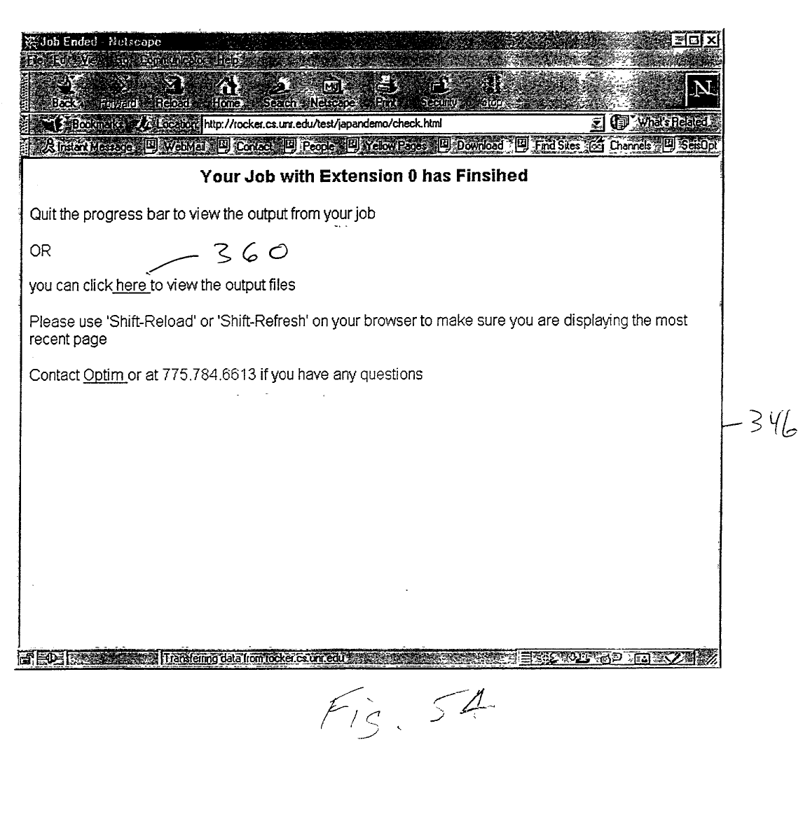

When the file is completed, a file upload completion window 351 appears on the user's screen such as shown as an example in FIG. 50. The user may then commence optimization with the uploaded files 349 (identified through the page 348 FIG. 49) on the optimization server computing system by clicking on the optimization start link 352. A status page 357 such as shown in FIG. 51 then opens up, and a status bar 358, provided by a java applet, such as shown in FIG. 52 pops up.

The user can leave and return to this page 357 later while the central optimization server system runs the RIOTS module to generate optimization model output files identical to those described above for the non-net based system of FIGS. 27-43. The user returns to this page 357 through selection of the progress checking option 341 shown in FIG. 45.

The central server system issues a notice of completion of the user's optimization job to the user either via e-mail if the user's browser is connected to the server at the time of completion or, if the user's browser is do connected, by a job completion message 359 (shown in FIG. 53) provided by the java applet in cooperation with the central server system.

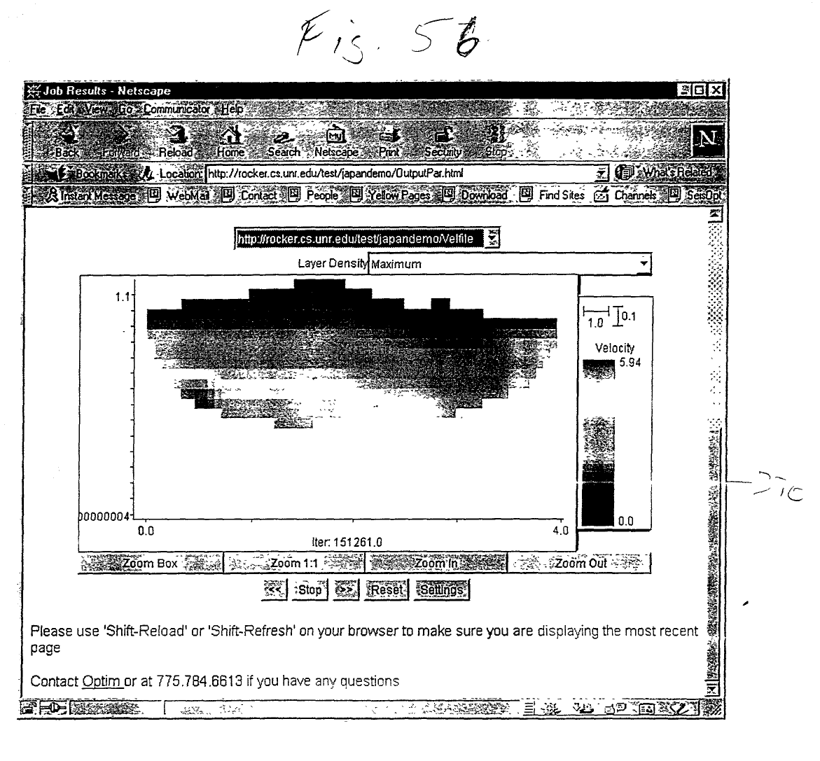

If the user had quit the status page 357 while the user's job was running and later returned to the status page 357 after the user's job has completed running, the user is presented with the job finished page 346 of FIG. 54. If the user then clicks on the output viewing option 360 on the page 346, the user is presented with output report page 347 such as shown as an example in FIG. 55. This page 347 presents the user with option of downloading the output files 361 or viewing the optimization results 362 through the browser interface while connected to the central web site server.

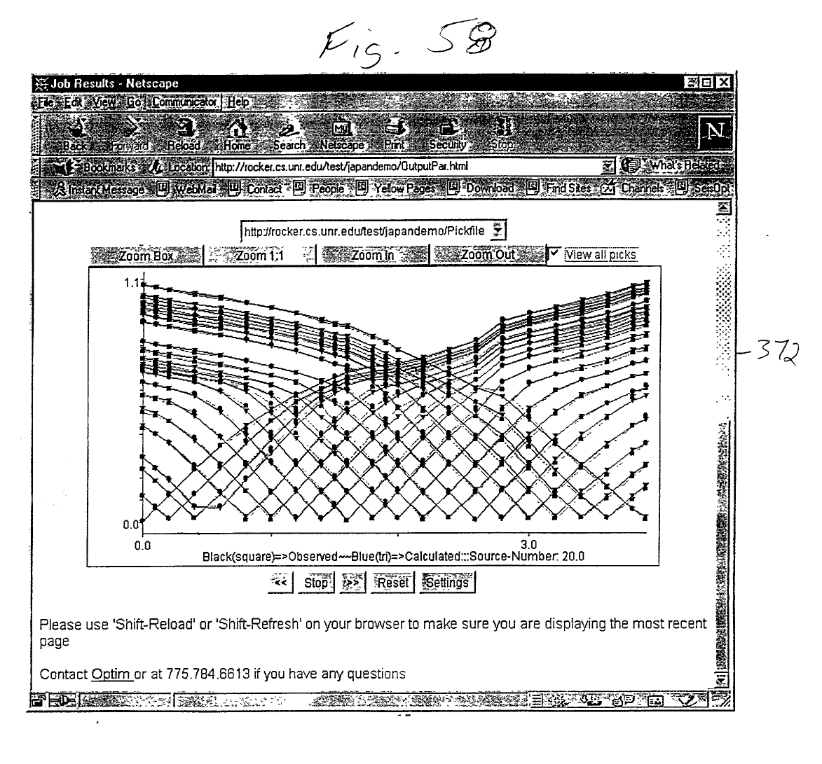

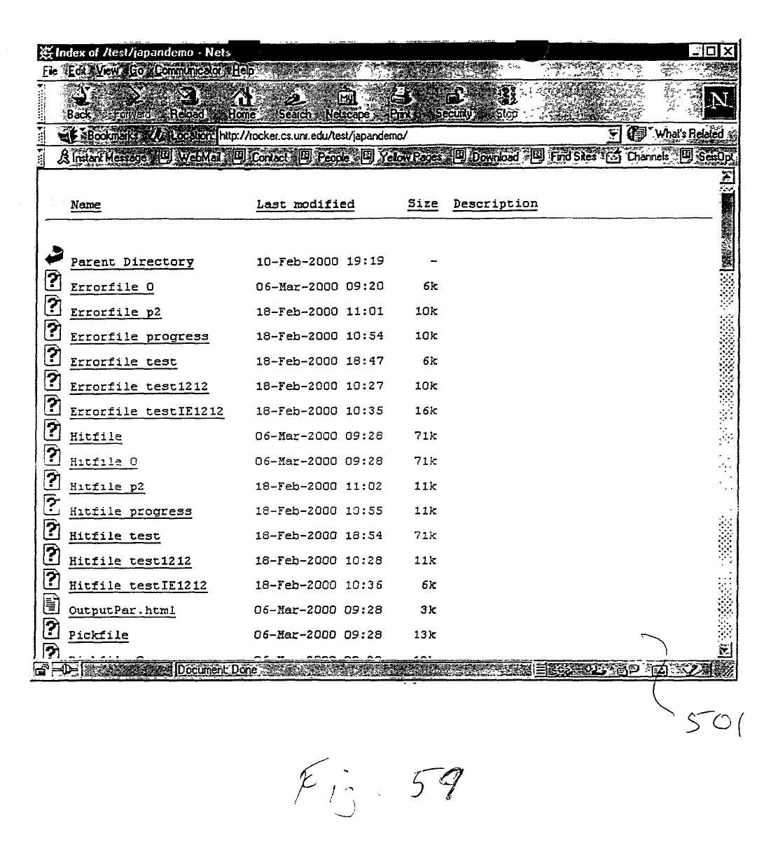

If the user then clicks on the viewing option 362, the user is presented with a browser based image viewer page similar to the RAVISH GUI screens described above for the non-net based system of FIGS. 27-43. Through this page, the user thus procures the user's job Velfile image, e.g., 370 in FIG. 56, Hitfile image, e.g., 371 in FIG. 57, and Pickfile image, e.g., 372 in FIG. 58.

If the user downloads the output files by selecting the download option 361 shown on FIG. 55, the user is presented with the download page 501, from which the user can click on and thereby download files to the user's local computing apparatus. The user can then run a local version of the RAVISH GUI described above and view the images provided by the RAVISH GUI and described in connection with FIGS. 27, 34, and 36-39. This localized version of the RAVISH GUI may have the RIOTS module disabled or deleted since the entire RIOTS optimization subsystem and function can be provided remotely from the user's local apparatus by the central optimization server system.

It can thus be seen that the applicant's preferred apparatus, systems, and methods disclosed herein provide numerous substantial advantages and features, including among others noted in this specification or otherwise flowing from one or more preferred embodiments:

1. automatic prediction of the subsurface velocity structure using no a priori data other than the seismic data and array geometry. Arrays can be either placed on the surface, or down-hole, or a combination of both;

2. the ability to both interactively and automatically design seismic data acquisition arrays based on predicted velocity structure;

3. effective automated visualization of subsurface velocity structure;

4. automated visualization of the array geometry relative to subsurface velocity structure in any direction;

5. automated visualization and determine the density at which seismic waves have sampled the subsurface;

6. visually and interactively add and remove seismic sources;

7. the ability to predict and visualize the affect of adding and removing seismic sources on subsurface sampling based on the orientation of subsurface velocity structure;

8. visually and interactively move seismic sources;

9. the ability to predict and visualize the affect of moving seismic sources based on the orientation of and subsurface velocity structure;

10. visually and interactively add and remove seismic sensors;

11. the ability to predict and visualize the affect of adding and removing sensors on sampling density based on the orientation of subsurface velocity structure;

12. visually, interactively, and automatically determine the array configuration that will optimally sample a desired area within the subsurface based on the orientation of subsurface velocity structure;

13. interactively zoom in, zoom out, and draw a “zoom box” about specific points in the subsurface;

14. quantitatively compare travel-times derived from the users synthetic velocity model with actual travel times recorded with the seismic array;

15. interactively and automatically create output files and visualizations of all the features heretofore described;

16. interactively and automatically scale the amplitude, or value, of the visualizations produced by the technology;

17. “mouse click” on the visualizations produced by the technology to obtain velocity, seismic sampling, and other information at specific points within the subsurface;

18. manually change velocity models produced by the technology to see effect on calculated verses observed travel-time data fits;

19. drawing a box around a specified area of the velocity model and then entering the desired velocity;

20. the ability to change velocity values or gradients within a specified area of the velocity model;

21. the ability to change the velocity model by selecting a velocity layer within the velocity models produced by the technology and then moving it or changing its velocity;

22. the ability to introduce constraints on optimized velocity model and monitor the affect;

23. providing a GUI that unites all of these features, in a cross-platform and net-portable architecture for economical, flexible, and easy remote access, data transfer, and operation;

24. providing the ability to process seismic data via the Internet, satellite, terrestrial, cell phone, or other remote data transfer procedures though one button click;

25. flexibly and economically increasing the speed of and access to seismic data processing by creating optimizers that can run on parallel processors, cluster computers, and network PC's/computers cluster;

26. providing highly automated while flexible and powerful seismic data processing;

27. providing a plug-in slot for GA, SA and hybrid optimization technology;

28. providing integrated optimization components under one GUI complete with pull-down menus for displaying different views of optimized data, and one button click or action for performing remote processing via central processing center;

29. elimination of need for DOS window or command line control or input;

30. providing automatically time stamping to avoid over-writing of files, and providing additional file maintenance features;

31. providing optimization looping that automatically “optimizes the optimized” model (O₃ optimization);

32. providing run time estimates for more efficient planning and processing of large data sets;

33. providing the ability to view all fits between observed, or control, data sets and optimized solution simultaneously;

34. providing averaging of optimization averages models to obtain a more robust solution;

35. providing a new and profitable business model based on providing these types of optimization services and systems, including remote user access to centralized computing power and the optimization algorithm software;

36. providing the ability for the user to export the data fits to a format that can be imported into spread-sheet programs for plotting and editing purposes;

37. the ability to merely click on an amplitude scale to see the value corresponding to the color of the image displayed in RAVISH;

38. the ability to fine tune the optimized model for better fits to the data and create new initial models for a constrained optimization run;

39. the ability to constrain an optimization and procure better and quicker results if the user has prior knowledge of the problem being investigated;

40. providing access to these types of powerful and flexible optimization techniques without the need for the individual user to expend substantial capital on the computing hardware and software required to run the optimization algorithm; providing a new business opportunity and business model that provides fee-for-service based optimization processing, and also user hardware, software, and related services, preferably on a long term basis to, and to a wider potential base of, optimization users; and

41. provide improved (faster and more accurate) ray tracing, including over the ray racing available in, for example, the applicant's prior art Optim 1.0 system. In this latter regard, first arrival “ray” is defined as the path perpendicular to the wavefront that first arrives at the seismic recorder. Optim 1.0 utilized and outcome of Fermat's principle which states that the first arrival ray is the minimum time path through the subsurface velocity structure. Thus, the ray path from a source to the receiver (recorder) was the same as the ray path from the receiver to the source. Optim 1.0 invoked this principle for computing ray paths. The disadvantage was that this require 2 travel time calculations for each ray path, one from the source on the source and the other from the receiver. After the travel time calculate for each pair, the time are summed and a search for the minimum time is done, starting from the source, to determine the ray path. Due to numerical errors in the travel time calculation, the path thus obtained may not be accurate. The present method, described in the specification above, is faster and more accurate by computing the ray path as per its definition. That is, the present method computes the perpendicular to the wavefront, by following the time gradient, starting from the source. Thus, only one travel time computation is needed for each source, making the present ray tracing method twice as fast as the method Optim 1.0. Also, by following the perpendicular path to the wavefront, the resulting ray paths more accurate than the one determined by the old method.

It is to be understood that the foregoing is a detailed description of preferred embodiments. The scope of the present invention is, however, to be determined according to the claims.

What we claim is:

1. An automated optimization computing system of the type for optimization of models based on input data input into the system, the optimization computing system comprising in combination:
A. a main user interface system having at least one input data entry screen, an optimized model viewing screen, a data exporting facility, and a data importing facility; and
B. a separate optimizing subsystem in communication with the main interface system to accept said input data from the data exporter of the main module, run an optimization algorithm utilizing the accepted input data, and provide optimized model data to the main user interface system;
whereby the main module system may optionally run on a first computer, the optimizing system may optionally run on a second computer distal from the first computer, and thereby: (i) the main user interface system optionally may remotely provide said input data to the optimizing subsystem, (ii) the optimizing subsystem optionally may remotely generate optimized model data utilizing said input data, and (iii) the main user interface system may remotely display an optimized model based on said optimized model data provided by the optimizing subsystem.

2. The automated optimization system of claim 1 also including a viewable optimization processing status indicator on a screen, whereby the user may view the status indicator on the screen.

3. The automated optimization system of claim 1 also including a model data file exporter, whereby the optimization computing system stores model data in a file with a unique name and preferably does not overwrite other model data files.

4. The automated optimization system of claim 1 wherein the main module system includes a graphical user interface providing a plurality of differing views of data including a graphical optimized model screen.

5. The automated optimization system of claim 1 wherein the main user interface system includes (i) a presenting screen, whereby the user may selectively alter optimized model data; and (ii) a re-optimization selector in communication with the optimizing subsystem, whereby the altered and confined optimized model data may be provided to the optimizing subsystem for re-optimization subject to the constraints in the altered optimized model data.

6. The automated optimization system of claim 3 wherein the main user interface system includes (i) a presenting screen, whereby the user may selectively alter optimized model data; and (ii) a re-optimization selector in communication with the optimizing subsystem, whereby the altered optimized model data may be provided to the optimizing subsystem for re-optimization subject to the constraints in the altered and confined optimized model data.

7. The automated optimization system of claim 4 wherein the main user interface system includes (i) a presenting screen, whereby the user may selectively alter said input data; and (ii) a re-optimization selector in communication with the optimizing subsystem, whereby the altered input data may be provided to the optimizing subsystem for re-optimization subject to the altered input data.

8. The automated optimization system of claim 1 also including an optimization run-time estimator display, whereby an estimate of the run-time for an optimization of said input data by said optimizing subsystem can be displayed.

9. The automated optimization system of claim 1 also including a sampling plot display, whereby the effectiveness of the sampling technique for procuring said input data can be displayed.

10. The automated optimization system of claim 1 wherein the said optimization subsystem includes a parallelizable optimizing algorithm, whereby the optimizing algorithm may run in parallel on multiple computer processors.

11. The automated optimization system of claim 2 wherein the said optimization subsystem includes a parallelizable optimizing algorithm, whereby the optimizing algorithm may run in parallel on multiple computer processors.

12. The automated optimization system of claim 3 wherein the said optimization subsystem includes a parallelizable optimizing algorithm, whereby the optimizing algorithm may run in parallel on multiple computer processors.

13. The automated optimization system of claim 4 wherein the said optimization subsystem includes a parallelizable optimizing algorithm, whereby the optimizing algorithm may run in parallel on multiple computer processors.

14. The automated optimization system of claim 5 wherein the said optimization subsystem includes a parallelizable optimizing algorithm, whereby the optimizing algorithm may run in parallel on multiple computer processors.

15. The automated optimization system of claim 6 wherein the said optimization subsystem includes a parallelizable optimizing algorithm, whereby the optimizing algorithm may run in parallel on multiple computer processors.

16. The automated optimization system of claim 7 wherein the said optimization subsystem includes a parallelizable optimizing algorithm, whereby the optimizing algorithm may run in parallel on multiple computer processors.

17. The automated optimization system of claim 8 wherein the said optimization subsystem includes a parallelizable optimizing algorithm, whereby the optimizing algorithm may run in parallel on multiple computer processors.

18. The automated optimization system of claim 9 wherein the said optimization subsystem includes a parallelizable optimizing algorithm, whereby the optimizing algorithm may run in parallel on multiple computer processors.

19. The automated optimization system of claim 1 wherein the input data is seismic data and the optimized model data is seismic optimized model data.

20. The automated optimization system of claim 4 wherein the input data is seismic data and the optimized model data is seismic optimized model data.

21. The automated optimization system of claim 5 wherein the input data is seismic data and the optimized model data is seismic optimized model data.

22. The automated optimization system of claim 9 wherein the input data is seismic data and the optimized model data is seismic optimized model data.

23. The automated optimization system of claim 10 wherein the input data is seismic data and the optimized model data is seismic optimized model data.

24. The automated optimization system of claim 15 wherein the input data is seismic data and the optimized model data is seismic optimized model data.

25. The automated optimization system of claim 8 wherein the said optimization subsystem includes a parallelizable optimizing algorithm, whereby the optimizing algorithm may run in parallel on multiple computer processors.

26. An automated optimization computing system of the type for optimization of models based on input data input into the system, the optimization computing system comprising in combination:
A. a first computing system including a main interface system having at least one input data entry screen, an optimized model viewing screen, a data exporting facility, and a data importing facility; and
B. a second computing system distal from and selectably connected to said first computing system, said second computing system including a separate optimizing subsystem in communication with the main interface system to accept said input data from the data exporter of the main module, run an optimization algorithm utilizing the accepted input data, and provide optimized model data to the main interface system;
whereby the main interface system may optionally run on a first computer, the optimizing system may optionally run on a second computer distal from the first computer, and thereby: (i) the main module optionally may remotely provide said input data to the optimizing subsystem, (ii) the optimizing subsystem optionally may remotely generate optimized model data utilizing said input data, and (iii) the main interface system may remotely display an optimized model based on said optimized model data provided by the optimizing subsystem.

27. The automated optimization computing system of claim 22 wherein the selectable connection between the first computing system and the second computing system includes an Internet link.

28. The automated computing system of claim 22 wherein the selectable connection between the first computing system and the second computing system includes a wireless link.

29. The automated computing system of claim 22 wherein the selectable connection between the first computing system and the second computing system includes an intranet link.

30. The automated computing system of claim 22 wherein the second computing system includes a plurality of separate computers interconnected on a local area network and wherein the or another algorithm may run in parallel on said plurality of separate computers.

31. The automated computing system of claim 22 wherein the input data comprises seismic data and the optimized model data comprises optimized seismic model data.

32. The automated computing system of claim 23 wherein the input data comprises seismic data and the optimized model data comprises optimized seismic model data.

33. The automated computing system of claim 24 wherein the input data comprises seismic data and the optimized model data comprises optimized seismic model data.

34. The automated computing system of claim 25 wherein the input data comprises seismic data and the optimized model data comprises optimized seismic model data.

35. The automated computing system of claim 26 wherein the input data comprises seismic data and the optimized model data comprises optimized seismic model data.

36. An automated method of utilizing at least one computer to automatically generate an optimized outcome based on input data, said method comprising the steps of:
A. accessing said input data, providing the input data as input to at least one optimization algorithm, and running said at least one optimization algorithm on said at least one computer to provide a plurality of optimized model outcomes from the said input data;
B. automatically applying at least a second algorithm on said at least one computer and thereby automatically choosing one among the optimized outcomes according to predetermined criteria applied by said at least second algorithm; and
C. displaying the chosen one optimized outcome on a viewing screen.

37. The automated optimization method of claim 32 wherein the second algorithm comprises choosing the one among the optimized outcomes that presents the most globally optimized result.

38. The automated optimization method of claim 32 wherein said at least one algorithm comprises a parallizable algorithm, whereby said parallelizable algorithm may run on a plurality of computer processors in parallel.

39. The automated optimization method of claim 33 wherein said at least one algorithm comprises a genetic optimization algorithm.

40. The automated optimization method of claim 34 wherein said at least one algorithm comprises a genetic optimization algorithm.

41. The automated optimization method of claim 32 wherein: step A includes running said at least one optimization algorithm on at least a first computer; and step C includes transmitting at least a substantial portion of said optimized outcome to a second computer distal from and in communication with said first computer to thereby display said substantial portion of said optimized outcome on a screen associated with said second computer.

42. The automated optimization method of claim 33 wherein: step A includes running said at least one optimization algorithm on at least a first computer; and step C includes transmitting at least a substantial portion of said optimized outcome to a second computer distal from said first computer to thereby display said substantial portion of said optimized outcome on a screen associated with said second computer.

43. The automated optimization method of claim 34 wherein: step A includes running said at least one optimization algorithm on at least a first computer; and step C includes transmitting at least a substantial portion of said optimized outcome to a second computer distal from and in communication with said first computer to thereby display said substantial portion of said optimized outcome on a screen associated with said second computer.

44. The automated optimization method of claim 35 wherein: step A includes running said at least one optimization algorithm on at least a first computer; and step C includes transmitting at least a substantial portion of said optimized outcome to a second computer distal from said first computer to thereby display said substantial portion of said optimized outcome on a screen associated with said second computer.

45. The automated optimization method of claim 36 wherein: step A includes running said at least one optimization algorithm on at least a first computer; and step C includes transmitting at least a substantial portion of said optimized outcome to a second computer distal from and in communication with said first computer to thereby display said substantial portion of said optimized outcome on a screen associated with said second computer.

46. An automated method of utilizing at least two computing systems to automatically generate an optimized outcome based on input data, said method comprising the steps of:
A. accessing said input data, providing the input data as input to at least one optimization algorithm, and running said at least one optimization algorithm on a first computing system to provide a plurality of optimized model outcomes from the said input data;
B. automatically running at least a second algorithm on said first computing system and thereby automatically choosing one among the optimized outcomes according to predetermined criteria applied by said at least second algorithm; and
C. displaying the chosen one optimized outcome on a viewing screen on a second computing system distal from and selectably connected to said first computing system.

47. The automated method of claim 42 wherein at least the one optimizing algorithm is a parallelizable algorithm, whereby the one algorithm may run simultaneously on independent computer processors.

48. The automated method of claim 42 wherein the first computing system is connected to the second computing system by an Internet link.

49. The automated method of claim 42 wherein the first computing system is connected to the second computing system by a wireless link.

50. The automated method of claim 42 wherein the first computing system is connected to the second computing system by a intranet link.

51. The automated method of claim 44 wherein the second computing system includes a plurality of computers interconnected on a local area network and wherein the or another algorithm may run in parallel on said plurality of computers.

52. The automated method of claim 42 wherein the input data comprises seismic input data and the optimized outcomes comprise optimized seismic models

53. The automated method of claim 43 wherein the input data comprises seismic input data and the optimized outcomes comprise optimized seismic models

54. The automated method of claim 44 wherein the input data comprises seismic input data and the optimized outcomes comprise optimized seismic models

55. The automated method of claim 45 wherein the input data comprises seismic input data and the optimized outcomes comprise optimized seismic models

56. The automated method of claim 46 wherein the input data comprises seismic input data and the optimized outcomes comprise optimized seismic models

57. The automated method of claim 47 wherein the input data comprises seismic input data and the optimized outcomes comprise optimized seismic models

58. A method of generating an optimized model of a physical system based on empirical input data, the method comprising the steps of:
A. acquiring the empirical input data by recording physical characteristics of the physical system in the field;
B. recording the empirical input data in a computer memory;
C. utilizing the empirical input data as input to an optimization algorithm running on a computer and thereby generating the optimized model of the physical system;
D. displaying the optimized model on a viewing screen;
E. altering aspects of the optimized model on said viewing screen; and
F. providing the altered elements as constraint input to the or another optimization algorithm and thereby generating a constrained optimized model of the physical system; and
G. displaying the constrained optimized model on the or another viewing screen.

59. The method of generating an optimized model of claim 54 wherein the or another optimizing algorithm is a parallelizable algorithm, whereby the or another algorithm may run simultaneously on independent computer processors.

60. The method of generating an optimized model of claim 54 wherein at least one among the data recording step B, the data displaying steps D and G, and the data altering steps substantially occur on a first computing system distal but in communication with a second computing system distal from said first computing system, with said utilizing step C and providing step F substantially occurring on said second computing system.

61. The method of generating an optimized model of claim 56 wherein the first computing system is connected to the second computing system by an Internet link.

62. The method of generating an optimized model of claim 56 wherein the first computing system is connected to the second computing system by a wireless link.

63. The method of generating an optimized model of claim 56 wherein the first computing system is connected to the second computing system by an intranet link.

64. The method of generating an optimized model of claim 57 wherein the second computing system includes a plurality of computers interconnected on a local area network and wherein the or another algorithm may run in parallel on said plurality of computers.

65. An automated method of utilizing at least one computer to automatically generate an optimized outcome based on input data, said method comprising the steps of:
A. accessing said input data, providing the input data as input to at least one optimization algorithm, and running said at least one optimization algorithm on said at least one computer to provide a plurality of optimized model outcomes from the said input data;
B. averaging the plurality of optimized model outcomes to provide an averaged optimized model outcome; and
C. displaying the averaged optimized model outcome on a viewing screen.

66. The automated method of claim 61 wherein the number of optimized outcomes to be averaged is determined automatically based on the number of iterations run by the optimization algorithm to generate a single optimized model outcome among the plurality of outcomes.

67. The automated method of claim 61 wherein (i) the method also includes the steps of re-running said at least one optimization algorithm and re-averaging the plurality of model outcomes to generate a plurality of averaged optimized model outcomes, and then applying a second algorithm to select the one among the plurality of averaged optimized model outcomes that presents the most globally optimized result; and (ii) the displaying step displays the most globally optimized result on said viewing screen.

68. The automated method of claim 61 wherein said at least one optimization algorithm comprises a parallizable algorithm, whereby said parallelizable algorithm may run on a plurality of computer processors in parallel.

69. The automated method of claim 61 wherein said at least one optimization algorithm comprises a genetic optimization algorithm.

70. The automated method of claim 64 wherein said at least one optimization algorithm comprises a genetic optimization algorithm.

71. The automated method of claim 61 wherein: step A includes running said at least one optimization algorithm on at least a first computer; and step C includes transmitting at least a substantial portion of said averaged optimized model outcome to a second computer distal from and in communication with said first computer to thereby display said substantial portion of said averaged optimized model outcome on a screen associated with said second computer.

72. The automated method of claim 62 wherein: step A includes running said at least one optimization algorithm on at least a first computer; and step C includes transmitting at least a substantial portion of said averaged optimized model outcome to a second computer distal from said first computer to thereby display said substantial portion of said averaged optimized model outcome on a screen associated with said second computer.

73. The automated method of claim 63 wherein: step A includes running said at least one optimization algorithm on at least a first computer; and step C includes transmitting at least a substantial portion of said globally optimized result to a second computer distal from and in communication with said first computer to thereby display said substantial portion of said globally optimized result on a screen associated with said second computer.

74. The automated method of claim 64 wherein: step A includes running said at least one optimization algorithm on at least a first computer; and step C includes transmitting at least a substantial portion of said averaged optimized model outcome to a second computer distal from said first computer to thereby display said substantial portion of said averaged optimized model outcome on a screen associated with said second computer.

75. The automated method of claim 65 wherein: step A includes running said at least one optimization algorithm on at least a first computer; and step C includes transmitting at least a substantial portion of said averaged optimized model outcome to a second computer distal from and in communication with said first computer to thereby display said substantial portion of said averaged optimized model outcome on a screen associated with said second computer.

76. The automated method of claim 61 wherein the input data comprises seismic data acquired from empirical testing in a geographical region and each optimized model outcome comprises an optimized model of seismic characteristics of said region.

77. The automated method of claim 62 wherein the input data comprises seismic data acquired from empirical testing in a geographical region and each optimized model outcome comprises an optimized model of seismic characteristics of said region.

78. The automated method of claim 63 wherein the input data comprises seismic data acquired from empirical testing in a geographical region and each optimized model outcome comprises an optimized model of seismic characteristics of said region.

79. The automated method of claim 64 wherein the input data comprises seismic data acquired from empirical testing in a geographical region and each optimized model outcome comprises an optimized model of seismic characteristics of said region.

80. The automated method of claim 65 wherein the input data comprises seismic data acquired from empirical testing in a geographical region and each optimized model outcome comprises an optimized model of seismic characteristics of said region.

81. The automated method of claim 66 wherein the input data comprises seismic data acquired from empirical testing in a geographical region and each optimized model outcome comprises an optimized model of seismic characteristics of said region.

82. The automated method of claim 67 wherein the input data comprises seismic data acquired from empirical testing in a geographical region and each optimized model outcome comprises an optimized model of seismic characteristics of said region.

83. The automated method of claim 68 wherein the input data comprises seismic data acquired from empirical testing in a geographical region and each optimized model outcome comprises an optimized model of seismic characteristics of said region.

84. The automated method of claim 69 wherein the input data comprises seismic data acquired from empirical testing in a geographical region and each optimized model outcome comprises an optimized model of seismic characteristics of said region.

85. The automated method of claim 70 wherein the input data comprises seismic data acquired from empirical testing in a geographical region and each optimized model outcome comprises an optimized model of seismic characteristics of said region.

86. The automated method of claim 71 wherein the input data comprises seismic data acquired from empirical testing in a geographical region and each optimized model outcome comprises an optimized model of seismic characteristics of said region.

87. An automated optimization computing system of the type for optimization of models based on input data input into the system, the optimization computing system comprising in combination:
A. an optimizing system loadable onto a first computing system having an optimization algorithm providing optimized model data based on input data provided to the optimizing system;
B. an automatic data transfer system loadable on a second computer distal from the optimizing system and in communication with the optimizing system;
whereby: (i) the automatic data transfer system remotely provides said input data to the optimizing system, (ii) the optimizing system remotely generates optimized model data utilizing said input data, and (iii) the automatic data transfer system may remotely display an optimized model based on said optimized model data provided by the optimizing system.

88. The automated optimization computing system of claim 83 wherein the automatic data transfer system includes a Internet web browser compatible interface.

89. The automated optimization computing system of claim 84 wherein the communication between the automatic data transfer system and the optimizing system is provided by a link through the Internet.

90. A method of generating an optimized model of a seismic field based on empirical seismic data collected from a geophone array in the seismic field, the method comprising the steps of:
A. recording the empirical input data in a computer memory;
B. utilizing the empirical input data as input to an optimization algorithm running on an optimizing computer and thereby generating the optimized model of the physical system;
C. displaying the optimized model on a viewing screen;
D. altering aspects of the optimized model on said viewing screen; and
E. providing the altered elements as constraint input to the or another optimization algorithm and thereby generating a constrained optimized model of the physical system; and
F. displaying the constrained optimized model on the or another viewing screen.

91. The method of claim 86 wherein recording step also includes accessing the optimizing computer remotely and automatically transferring the recorded empirical input data to the optimizing computer.

92. A method of providing optimization services to a remote user having a remote computing system, the method including the steps of:
A. providing an optimization computing system having an optimizing system including an optimization algorithm;
B. providing the remote user with remote access to the optimization computing system;
C. accepting input data from the remote user at the optimization computing system through a communication link between the remote user and optimization computing system;
D. utilizing the input data and generating an optimized model with the optimizing system on the optimization computing system; and
E. providing the remote user with access to information regarding the optimized model.

93. The optimization service method of claim 88 wherein the method also includes the step of charging the user a fee for services or one or more systems provided to the user in connection with performing the method.

94. The optimization service method of claim 88 wherein the communication link includes the Internet and the remote user transfers input data to the optimization computing system through at least a portion of a web browser running on a remote user computing system.
